(19) United States
(12) Patent Application Publication
(10) Pub. No.: US 2007/0067297 A1
(43) Pub. Date: Mar. 22, 2007

(54) System and methods for a micropayment-enabled marketplace with permission-based, self-service, precision-targeted delivery of advertising, entertainment and informational content and relationship marketing to anonymous internet users

(76) Inventor: Peter Joseph Kublickis, Middletown, NJ (US)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/118,998

(22) Filed: Apr. 28, 2005

Related U.S. Application Data
(60) Provisional application No. 60/566,715, filed on Apr. 30, 2004.
(60) Provisional application No. 60/600,140, filed on Aug. 9, 2004.

(51) Int. Cl. G06F 17/30

(52) U.S. Cl. 707/9

(57) ABSTRACT

A method of enabling anonymous Internet users to publish and manage extensive, non-identifying personal data, including demographic, psychographic, needs, wants, interests, propensities, means to purchase, credibility and other data which in turn, enables a marketplace wherein such users, advertisers, websites, and other third-parties can mutually benefit from the commercial exploitation of such data. Advertisers can directly use the data to segregate the users into highly differentiated anonymous audiences for the purposes of targeting them with individualized marketing campaigns and then monitor user responses in near real-time. Websites can individualize their content to the profiles of visiting users. Users can share surface and deep web links with other users having similar profiles. Consumers participating in good faith are proportionately rewarded via revenue sharing, which they may withdraw from the marketplace or use to purchase and rent digital content offered in the marketplace's micropayment-enabled storefronts by other users and third-party content providers.

### PRIORITY REFERENCE TO PRIOR APPLICATIONS

This application claims benefit and incorporates by reference provisional patent application Ser. No. 60/566,715, entitled “A Method for Self-Service Precision-Targeted Advertising and Relationship Marketing to Anonymous Consumers”, filed on Apr. 30, 2004, by inventor Peter J. Kublickis; and claims benefit and incorporates by reference provisional patent application Ser. No. 60/600,140, entitled “System and Method for Self-Service Precision-Targeted Advertising and Relationship Marketing to Anonymous Consumers” filed on Aug. 9, 2004, by inventor Peter J. Kublickis.

### BACKGROUND

1. Technical Field

The present invention relates generally to the precision targeting and delivery of Internet-based content to anonymous users of the Internet and more specifically to a system and methods which enable the ongoing collection and analyses of extensive demographic, psychographic, content-consumption and advertising-response data from anonymous users of the Internet and to the use of said data to enable the permission-based self-service, precision-targeted delivery of content, including free and fee-based content, and advertising and relationship marketing content, to an anonymous public via the Internet.

2. Description of the Prior Art

Prior art relevant to the present invention includes a) methods by which the general Internet-using public discovers new web content, b) methods by which the Internet-using public views and interacts with web content and purchases premium digital web content, and c) methods by which advertisers target and deliver advertising content to the consumer public. Accordingly, this section addresses each in turn.

a) Content Discovery by Internet Users

Since its inception, the Internet has evolved from a limited U.S. Department of Defense research project for a self-healing interoperable network of networks, into a global information superhighway—a dynamic, global infrastructure of networks, servers, routers and content whose sheer size and scope have grown beyond accurate measurement. The Internet has become the largest infrastructure in history to concurrently serve commercial, private, educational, entertainment and scientific interests through the exchange of information and the remote execution of transactions. Google, the largest Internet search engine, claims on its homepage to have indexed over 8 billion web pages as of Jan. 1, 2005. It is primarily through search engines that the general public discovers and accesses the content available on the Internet. The search engine industry consists of several dozen major and minor companies which index the web primarily through the use of automated methods called spiders or crawlers, and to a lesser extent, through the use of human editors. That portion of the web which has been indexed and is directly accessible to the online public through one or more search engines has been termed the surface web. That portion of the web that is accessible to the general public through other means, but is beyond the indexing capability of mainstream search engines, has been termed the invisible or deep web, as described later in this section.

As cited by the Pew Internet and American Life Project: Daily Internet Activities, 30 percent of online Americans used a search engine each day to find information according to a May-June 2004 survey. SearchEngineWatch.com, in its most recently published statistics Searches Per Day, February 2003, claims that total searches conducted worldwide using just 8 search engines (Google, Overture, Inktomi, LookSmart, FindWhat, Ask Jeeves, AltaVista, and FAST) exceeded 625 million per day, with 319 million searches per day in the United States alone. As cited by the Regents of the University of California in an Oct. 27, 2003 report, How Much Information 2003, those 319 million searches translated into approximately 102 million minutes of search time per day. The typical search query can return hundreds or thousands of results, generally presented as a series of web page links listed on one or more results pages, and ordered by their “popularity” as determined by methods described later in this section.

General search engines such as those cited above expose less than 1% of the accessible web to users, due to a number of factors:
The rate of new content introduction to the web significantly exceeds the rate at which current automated indexing technology or manual indexing methods can catalog it. As cited by Google on their website, ‘We add new sites to our index each time we crawl, and invite you to submit your URL. We do not add all submitted URLs to our index, and can't make any predictions or guarantees about when or if they will appear.’ Websites that have not yet been indexed are part of the deep web.
Many websites offer content captured in file formats such as images, Adobe Acrobat (PDF) documents, Macromedia Shockwave and Flash (SWF, DIR) animations, and other encapsulating or compiled formats, whose internal content is beyond the automated identification, analyses and indexing of any existing search engine technology. Encapsulated or compiled content is part of the deep web.
Most web pages are generated dynamically in response to each user visit, using content retrieved from databases. The web pages do not persist on the website for any longer than it takes to create and send them to a user, after which they cease to exist. Unlike static web pages, dynamic pages cannot be indexed by current spider or crawler technology. Moreover, regenerating dynamic pages on demand usually requires the use of cookies (transient data files) which search engines, by design, cannot accept. Dynamic content is part of the deep web.

The deep web has been quantified in its size and relevancy in a study by BrightPlanet. In its white paper The Deep Web: Surfacing Hidden Value, the following findings are cited:
Public information on the deep Web is currently 400 to 550 times larger than the commonly defined World Wide Web (surface web)
The deep Web contains 7,500 terabytes of information compared to 19 terabytes of information in the surface Web
Sixty of the largest deep Web sites collectively contain about 750 terabytes of information—sufficient by themselves to exceed the size of the surface Web forty times
On average, deep Web sites receive fifty percent greater monthly traffic than surface sites and are more highly linked to than surface sites; however, the typical (median) deep Web site is not well known to the Internet-searching public
The deep Web is the largest growing category of new information on the Internet
Deep Web sites tend to be narrower, with deeper content, than conventional surface sites
Deep Web content is highly relevant to every information need, market, and domain
A full ninety-five percent of the deep Web is publicly accessible information—not subject to fees or subscriptions

As further cited by the BrightPlanet white paper, “To put these findings in perspective, a study at the NEC Research Institute published in Nature, estimated that the search engines with the largest number of Web pages indexed (such as Google or Northern Light), each index no more than sixteen percent of the surface Web. Since they are missing the deep Web when they use such search engines, Internet searchers are therefore searching only 0.03%—or one in 3,000—of the pages available to them today.”

Users can access the deep web and almost all users do without knowing it. Deep web discoveries generally result from affinity-based referrals—such as mentions in magazines which cater to particular interest groups, recommendations from friends or colleagues who share similar interests, or through a succession of referring links across websites whose focus eventually narrows to the specific shared interests of like-minded web surfers. Once found, links to websites in the deep web can be saved by the user to their web browser's ‘bookmarks’ or ‘favorites’ list. As long as a link to a particular web page in the deep web has an associated cookie (if required) stored on the user's computer, the page can usually be regenerated and displayed on demand by the user.

If popular search engines eventually overcome the logistical and technical hurdles of indexing the deep web—keeping pace with the expanding surface web, indexing encapsulated content, and indexing dynamic content—they will still retain existing weaknesses which compromise their potential value to users:
As additional content is indexed, search engine results may grow larger, but not necessarily more useful. As cited by iProspect.com, iProspect Survey Confirms Internet Users Ignore Web Sites Without Top Search Engine Rankings: Nearly 80 Percent of Web Users Abandon Their Queries After Three Pages of Search Engine Results, “a recent survey indicated that 48 percent of search engine users expect to find the answer to their query on the first page of search matches and that a vast majority, 78 percent of Web users, will abandon their query if the first three (3) pages of results do not yield an answer to their question. Another 28 percent reported they do not scroll past even the second page of search results. Furthermore, novice search engine users make a selection after viewing just a few listings on the first page of matches. Consequently, Web sites that have not attained top search engine rankings are effectively invisible to target online audiences. This follows iProspect survey results that revealed that the majority (77%) of Internet users employ search engines more frequently than any other online media—surpassing banner ads, Web links, e-mail links, and other forms of offline media as the leading vehicle for discovering Web sites . . . one of the most surprising findings is that many search engine users believe that top listings equal top brands.”
Based on this survey and on similar studies, the majority of the websites exposed by search engines is ignored by the general online public. By focusing on the first few pages of search results, users are demonstrating a behavioral tendency to reduce their search cost—that is, the amount of time spent searching for content, relative to the amount of time spent actually consuming the content once they find it. Successfully indexing the content of the deep web may dramatically increase the quantity of matches found, but if users typically view only the first three pages of search results, then the number of subsequent pages, whether it is 10 or 10,000, may be of limited or of no value to the typical user.
The page ranking algorithms used by most search engines favor more popular web pages, promoting those with higher traffic and more inbound links over newer, less linked pages. This method of ranking web pages is described by an NEC Research Institute research paper Winners don't take all: Characterizing the competition for links on the web as a case of “the rich getting richer” or “preferential attachment, wherein new links on the web are more likely to go to sites that already have many links.” Search engines tend to expose and promote those websites that are already better known to the Internet-using public. Because search engines display their results as a series of website links ordered by rank, regardless of the ranking formula used, all exhibit zero-sum behavior—that is, the promotion of any one link to a higher ranking necessarily demotes all links following it. More popular websites generally receive preferential ranking which promotes their continued growth at the expense of newer and potentially more valuable websites which are marginalized ‘beyond the third page’. In effect, search engine rankings may drive web site popularity more than they independently reflect it.
The page ranking algorithms used by most search engines are frequently tricked into generating inaccurate results through tools used by website operators to monitor the activity of their site links on search engines. As cited by SEOChat.com in Search Engine Keyword Analysis Pitfalls, “the popularity numbers from Overture and Google can also be skewed by rank checkers and bid management tools that generate artificial popularity.”
Automated ranking algorithms, inherently incapable of making a qualitative judgment of web page value, must necessarily rely on methods that enable a quantitative calculation of web page value. Such calculations require the use of quantifiable web page attributes, many of which are not visible or of direct value to users, such as:
   the age of the provider's website
   the quantity, popularity and age of inbound and outbound links
   keywords and keyword count
   meta-tag content
   the number of competing websites for a given topic
   the level of traffic and activity of undifferentiated users
Any correlation between a web page's value as calculated by machines and its actual qualitative value as subjectively experienced by users has never been established, but it can be stated with certainty that it must vary dramatically among individual users.
The use of these attributes, and the algorithms that derive page ranking from them, can be manipulated by a skilled webmaster or search engine optimization (SEO) service to improve its search engine ranking. The skills needed are not trivial, and with costs cited by SEOToday.com in Behind the Scenes at the SEO Industry's First Buying Guide, at “$500 to $5000 per month”, SEQ services are beyond the economic means of most website operators. A savvy website operator with deeper pockets can promote their page rankings at the expense of less sophisticated and budget-constrained operators, regardless of the actual relative value of the pages as subjectively experienced by users.
Search engines using human editors to rank websites may provide arguably better results than machine-calculated methods, but the costs and logistical challenges of indexing and ranking websites using paid human labor has effectively marginalized this approach.
The elements of search engine page ranking algorithms that consider website traffic are based on collaborative filtering, a method whereby new content is suggested to users based on their previous likings and on the opinions of other like-minded users. A significant body of research suggests that the value of collaborative filtering to any one user is primarily a function of how well their previous likings are known, the size of the group of like-minded users, and the depth and breadth of the filtering algorithm's knowledge of the groups providing the opinions. In the case of search engine page ranking, the group size may be extremely large, but knowledge of the individual user, which is limited to their query, and of the groups offering ‘opinions’ by clicking on search engine links, is so broad and inferential as to be nearly meaningless. Search engines deliver thousands of results to most queries because they must—with so little knowledge of each individual user, weak collaborative filtering necessarily yields results characterized by quantity rather than quality.
Search engine results, while heavily influenced by factors controlled by content providers, are largely blind to the specific needs of the individual user. An entire industry built around search engine optimization has emerged over the past decade to exploit the weaknesses inherent in machine-ranked content, and as cited by SEMPO.com in a December 2004 Report, The State of Search Engine Marketing 2004, the SEQ industry closed out the year with revenues of $380 million. In contrast, nothing is known or considered about the actual users of search engines—other than the query they enter, and how the query is phrased. Do they want to be informed or entertained? Do they want to buy something? Do they prefer facts and specifications or are they more visually inclined? Is the user a scientist with a Ph.D. or a sales clerk with a G.E.D.? With an absolute lack of information about its users, searches engines have necessarily adopted a ‘one-size-fits-all’ strategy reminiscent of mass media advertising—search results are the same for any query regardless of who enters it or what the intent of their search is.

Because search engines have no user context in which to place their query, the burden to specify relevant content is placed on users based on their skills in articulating their own unique needs and interests. Search engines are fairly sensitive to the phrasing of queries. Spelling, the addition of qualifying nouns or adjectives to a query and the order in which they appear within the query, can all generate a wide range of results having dramatically different relevance and value to each user.

In summary, search engines are the primary means by which the online public discovers Internet content. Presently, search engines cannot index or provide direct access to the overwhelming majority of the web. After the first three pages of search results, beyond which typical users rarely look, the value to users of the fraction of the web which search engines do index, analyze and rank, drops precipitously. Search engines use page ranking algorithms that are easily corrupted by search engine optimization techniques and services, and are based on models which generate search results for the mass consumption of undifferentiated users. While search engines are improving, they do not appear to be getting any smarter about their individual users—whether they are using a search engine for the first time, or the 10,000^{th} time, each user remains an undifferentiated stranger to their favorite content discovery tool.

b) Content Display and Interaction, and Digital Content Purchases

Web browsers have emerged as the most frequently used computer application in history. Web content, including online advertising, is accessed and displayed almost exclusively through web browsers—programs that reside on the user's computer and which connect to the Internet via a dial-up or broadband connection. A number of different browsers are available to the public, but excepting minor differences in their ‘bells and whistles’, all provide the following basic functionality:
A method of navigating the web through:
   web page addresses (URLs) manually entered by the user
   the user clicking on a link listed on a search engine results page
   the user clicking on a hyperlink appearing on a displayed web page
   the user selecting a web page link from a list of bookmarks or favorites that they have previously saved with the intent of revisiting
A method of displaying web page content, including text and graphics
A method of managing security, including the management of cookies (small text files used by websites to overcome the stateless nature of the web's HyperText Transfer Protocol for the purposes of providing context across web pages within a website and thus enabling multi-page transactions, and for “recognizing” returning users)
A method of incorporating content-specific applets, also known as “plug-ins” which enables users to view and interact with newer and proprietary content formats such as: Macromedia Flash, RealAudio and Microsoft Media Players, and Adobe Acrobat documents.
A method of enabling browser-based programmatic control over a user's interaction with the content of a web page, primarily through the use of scripting languages such as JavaScript and VBScript, programming languages such as Java, and embedded or compiled technologies such as Microsoft's ActiveX and Macromedia Shockwave.
A method of enabling the user to bookmark or save links to favorite websites which they intend to revisit

Most web browsers enable users to author their own individualized organization, or taxonomy, for their bookmarks. As an example:
Three users, A, B, and C all have a similar interest in high-performance automobiles. Over time, each user has discovered and saved links to websites that cover this topic—some of the websites residing in the surface web and found through different search engines, and others residing in the deep web and found through citations in niche magazines, hyperlinks on other websites, or referrals from friends. There is some overlap across the three user's favorites, but each has found some websites not yet discovered by the others and has bookmarked the links using taxonomies of their own design.
   User A has bookmarked their links under ‘Cars: High Performance’
   User B has bookmarked their links under ‘Automobiles: Exotic’
   User C has bookmarked their links under ‘Financial Goals: Dream Car’
      Since each user's link organization and taxonomy is unique, there is no way to effectively automate the sharing of links among them—to enable each user to benefit from the time and energy invested by like-minded users in their own searches for similar content, frequently hidden in the deep web.

Several ‘social bookmarking’ services have recently emerged that allow Internet users to centrally archive and optionally publish their bookmarks to share with other users. As an example, del.icio.us, enables users to save their bookmarks, still using their own unique taxonomies, which the service calls ‘tags’, to the de.licio.us website where other registered users can search for bookmarks by first browsing the growing dictionary of user-contributed tags. Each published bookmark is associated with the name of the user who submitted it. Users may view lists of the most commonly used tags which have the highest number of published bookmarks. If a user discovers another user's bookmark which they like, they may view and subscribe to all bookmarks published by that user, or only to those which that user submits under a specific tag. A similar service from furl.net, developed by the search engine LookSmart.com, provides bookmark recommendations to each member using a system of collaborative filtering, based on a model which uses ratings and ‘neighbors’. Each member rates the bookmarks they ‘furl’, and then their ratings are used to identify their neighbors—other members who have given those same bookmarks identical or similar ratings. Recommendations are then exchanged among neighbors, and are ranked by how close their ratings agree.

Web browsers are examples of Internet-enabled programs, meaning they execute as client applications on the user's computer. Through the use of standardized protocols such as TCP/IP and HTTP, and page description languages such as HTML, web browsers manage the exchange of control messages, user data, and content between themselves—the clients, and websites—the servers, via the Internet, using a fairly simple client-server architecture. The architecture and web protocols were originally made simple by design, for several key reasons:
To promote rapid adoption of the Internet. HTTP, HTML and the first widely used web browser—Mosaic, were originally designed in the early 1990s when connection speeds to the Internet were extremely slow (1.44 or 2.88 kilobytes per second) and the average home computer had relatively limited processing and storage resources. Broad acceptance of the World Wide Web by the general public could therefore be better assured through the use of a simple architecture and protocols which could deliver light-weight content and functionality quickly over low bandwidth connections, and which would not tax users' computer resources.
To provide a universal application-hosting environment, similar in concept to the ‘dumb terminals’ or ‘green screens’ used by business for decades. In the dumb terminal, or thin client paradigm, only user interfaces and content are downloaded to the terminals, while the applications themselves are executed centrally on mainframe or mini-computers. Web browsers are essentially software programs which emulate dumb terminal behavior, with enhanced graphics and navigation, and which act as hosts to thin-client web pages which they download and render.
To avoid the overhead required to maintain a persistent logical connection and a known state (state referring to the web server's knowledge of each client's current and historical session activity and status) between the server and many simultaneously active clients. As the popularity and number of users of any website grows, the server resources needed to maintain persistent connections and state with hundreds or thousands of concurrent client sessions would dramatically degrade performance and drive up website infrastructure costs. Instead, cookies are distributed by each website as needed to each visiting user's computer to preserve state data across each website page visited, and between each user's visits to the website.

The original Mosaic web browser model remains the basic blueprint for current web browser design—Microsoft's Internet Explorer, Mozilla's Firefox, and the Opera browser, as examples, still function as simple host containers for downloaded web content and browser-based applets. A wide selection of browser helper objects, also known as browser toolbars, are available which users may download to supplement their web browser's basic functionality and to keep pace with a rapidly evolving World Wide Web.

Many websites contain content that users can tailor for relevance or preference by providing the website with certain personal information. As an example, Accuweather.com and Yahoo Movies both ask their visiting users to enter a zip code in order to provide relevant content—local weather and neighborhood movie schedules, respectively. As another example, many car manufacturers have websites which enable consumers to design and price a vehicle, but first request a zip code to account for availability, pricing and incentives that may vary by geography. As another example, many websites ask users to specify their product preferences or their budgets which the websites then use to narrow down a large product choice set, and thus assist the user in the purchase of everything from videos to insurance policies. Information entered by the user is frequently not ‘remembered’ by the website on subsequent visits and the consumer must enter it again. The user must also enter the same information for each website which requests it when they visit. Accuweather.com, as an example, cannot share the zip code data it has learned from the user with Yahoo Movies, or vice-versa. The inability to share user data across websites is a result of several factors:
Websites do not share a standard or normalized format for inputting personal data. As an example, some websites request a five digit zip code while others may request the nine digit ‘zip+’ value. As another example, date-related information such as date-of-birth must often be entered using a variety of formats: ‘Dec. 29, 1952’, ‘12-29-52’, and ‘29 Dec. 1952’ all specify the same date but are not interchangeable across websites. Further, websites tend to abstract or cluster the range of possible consumer responses to each question differently to best serve their own specific business needs. Alcoholic beverage websites, as an example, require only two age categories, specifically whether the user is under or over the legal drinking age, while insurance company websites require an exact date-of-birth which they can map to their actuarial tables to enable the calculation of individualized policy premium quotes.
Websites do not share a standard or normalized lexicon for requesting personal data that would enable an automated process to recognize what data is being requested and how to respond. As an example, ‘Please enter your date of birth’ and ‘When were you born?’ are easily read and understood by human users to be the same request, but automating that recognition requires sophisticated algorithms and complex semantic dictionaries. Given the range of possible data that might be requested and the possible ways each request could be phrased, the algorithms and dictionaries would be difficult to implement using a fat-client model and nearly impossible to implement using the thin client model which characterizes the web currently.
There is no central clearinghouse to which a user may securely post their personal data and from which websites may automatically retrieve it as needed when the user visits the website. The widespread and highly publicized abuse of personal data, ranging from its use in triggering spam to facilitating identity theft has made the Internet-using public wary of any such service, despite the conveniences it may offer.

Websites often use cookies to record user data or session context between visits. Cookies are fairly primitive and limited in the amount of data they can capture in each user's visits. Further, users can, and often do, clear out their web browser cache and their inventory of cookies to reclaim disk space, improve browser performance, and with increasing frequency, out of concern for their privacy. As a result, excepting those websites for which users have established an account, or have otherwise registered as members, the Internet resembles a global bazaar of content providers with whom users remain perpetual strangers. Like Google.com the vast majority of websites know nothing more about a user on their 10,000^{th} visit than they did on their first.

The increasing penetration of broadband into the home through DSL and cable modem technologies has spurred some content providers to move beyond the limitations of the thin-client web browser model to fat-client models which provide far greater user-centric and content-specific functionality. Apple, Inc., for example, has chosen to implement iTunes, their online music store, as a downloadable, web-enabled application that provides all functionality through a program executing directly on the user's computer and which uses the Internet only to populate the store with content and pricing and for the exchange of transaction data with Apple's iTunes web server. To date, over 12 million users have downloaded the 10-plus megabyte iTunes application. Skype.com, another example, offers a downloadable application that delivers Voice-Over-IP (VoIP) telephony. All telephone functionality, including phone book and user profile management is provided by the application executing directly on the user's computer, and the Internet is used only to exchange account information and to route and carry voice traffic. To date, over 40 millions users have downloaded the Skype application, also larger than 10 megabytes in size.

These dedicated, fat-client applications are used in lieu of web browsers whenever users access Apple's music store or Skype's Internet telephone exchange, respectively. Each application, by virtue of its dedicated installation on user's computers, effectively accumulates and exploits each individual's usage over time to offer more personalized service.

In addition to being the primary tool through which the public accesses and interacts with the Internet, browsers may also host point-of-sale terminal functionality which enables Internet-based commerce or ‘e-commerce’. The development of secure financial transaction protocols and gateways to Internet-enabled financial intermediaries such as credit card institutions, banks and Internet-specific services such as Paypal, offer buyers and sellers a reliable means to conduct business at a distance through Internet-hosted electronic storefronts. In lieu of physically visiting a local store or ordering from a printed catalog of merchandise, consumers may explore the online catalogs of seller's merchandise, purchase desired goods, and then tender payment entirely through a self-service check-out. In a fashion similar to mail-order catalog shopping, either the seller or the buyer, or both, must absorb the transaction processing fees assessed by the third-party financial intermediaries.

In addition to traditional physical goods, the Internet is also as the world's largest repository of digital content (i.e. news, information, music, video, images, and software). A significant portion of the wares available for purchase through the Internet can thus be ‘shipped’ electronically through the Internet directly to the purchaser's computer. The dependency on traditional financial instruments such as credit cards (and PayPal-type services which generally involve credit cards in one or both ends of the transaction chain) to conduct online transactions has effectively thwarted growth in sales of a substantial category of online merchandise, namely those digital content items for which the purchase price is so low that the transaction fee exceeds the value of the transaction itself. Such transactions, commonly referred to as ‘micro-payment’ transactions, are unattractive to both buyer and seller—neither party is willing to absorb the disproportionate transaction fee. Examples of micro-payment wares include single digitized songs, video rentals, software rentals, and premium news, information and entertainment content offered on a per-item basis. Sellers have been forced to adopt an ‘aggregation’ strategy whereby many micro-payment transactions for each customer are aggregated into one larger transaction, driving the value of the total transaction to an acceptable multiple of the transaction processing cost. This approach requires each online buyer to establish a prepaid account with the seller, which their subsequent micro-payment purchases draw down over time. When the buyer's balance is exhausted, they must “recharge” their accounts to enable future purchases.

As an example, Advertising Age maintains a library of premium reports, surveys and research papers, which they offer for electronic purchase as digital content. At their website, adage.com, users must establish an account and pre-purchase a minimal number of ‘credits’, the legal tender of Advertising Age's online storefront, using a major credit card. As the user purchases individual micropayment-priced digital content, the credits are depleted and more must be purchased. Advertising Age's aggregation model inconveniences the buyer—their money is spent in advance of value received, and they must commit to future purchases to which they otherwise might not be inclined.

As another example, Apple Computer offers the ‘iTunes Music Store Card’ which they physically distribute to consumer electronics retailers where they may be purchased by consumers. The card aggregates 15 one dollar micro-payment song purchases into one $15 transaction. Once activated, the consumer may download songs from Apple's online music store until the value ‘stored’ in the card is exhausted. Again, the consumer suffers the inconvenience of prepayment before they even decide what they are going to purchase. In the case of the iTunes Music Store Card, Apple also absorbs a financial inconvenience—bearing the costs of manufacture and distribution of a physical payment mechanism to enable an otherwise purely digital business—the ‘manufacture’, sale and distribution of digitized music.

Other micro-payment aggregation strategies include content subscription models whereby consumers pre-pay a sum which covers the purchase and electronic delivery of pre-scheduled and known content over a period of months. Examples include subscriptions to game-highlight videos offered on the websites of major sports organizations, and subscriptions to the daily, weekly or monthly editions of online newspapers and magazines. To date, however, no payment mechanism exists which enables consumers to purchase single game highlights, one song, one magazine or newspaper article, or other such low cost item of digital content without paying a disproportionate transaction processing fee or committing to additional future purchases.

In summary, the Internet has grown to become the richest content library and marketing channel in history, but with few exceptions, remains an impersonal mass medium. The discovery of relevant content, goods and services websites remains each user's personal challenge and burden. Once discovered, users often visit their favorite content websites and online retailers as undifferentiated strangers, largely due to the constraints placed on websites by a primitive and outdated, but firmly entrenched web browser model.

c) Advertising

Advertising is a critical lubricant of capitalism, the means by which sellers communicate with buyers and commerce is enabled. It provides a vital service and offers potential value to both sellers and buyers. For sellers, advertising provides a means of broadcasting who they are, where they can be found, what product or services they offer and at what prices, and what value and benefits their products and services may confer to the buyer. For buyers, advertising enables them to dramatically lower their search costs for products and services. Without advertising, consumers would be required to invest unreasonable time and energy to discover what's new, what's available, what's worth buying and where to buy it.

Advertising is a significant business—almost one trillion dollars were spent globally on advertising in 2004. Advertising encompasses a rich variety of media and formats, has millions of potential venues, and serves many diverse marketing objectives. Media include print, radio, television and the Internet. Formats include text, graphics, audio, computer animation, video, and with the advent of the Internet, interactive versions of the aforementioned formats. Venues include thousands of magazines and newspapers, tens of millions of consumer mailboxes, thousands of radio stations, hundreds of television channels, and tens of millions of websites. Marketing objectives include building brand, creating an awareness of a new product or service category, creating an awareness of need, selling the advantages of one product over another, promoting specials, and driving sales. Whatever the medium, format or venue, and whatever the focus of an ad campaign may be—a product, a service, a candidate or an idea—all advertising shares the same ultimate objective: to sell something to somebody.

The efficacy of any ad campaign ultimately depends on the degree to which its message finds and resonates with its intended audience—that is, how well it relates to the wants, the needs and the dreams of prospective customers, and then motivates them to act in some desired way. The business of advertising, simply put, is primarily concerned with identifying and understanding potential customers—the audience, creating a message which exploits that knowledge to achieve a desired result—the ad, and then choosing the best delivery medium to target and engage the audience—the venue. This was as true a century ago as it is today, but over that interval, the business of advertising has changed dramatically into a highly complex and risky endeavor.

In the early 1900s, most advertising was local, appeared in print, was for local products and services, and was distributed across a limited number of venues—pamphlets, flyers, billboards, and the town newspaper. Audiences were relatively small and homogeneous. Advertisers could be confident that nearly every resident of a town was exposed to their ads. Targeting was straightforward—if a consumer lived in the town and was literate, they were an audience member. The few national brands that existed were advertised in the handful of magazines which by that time had achieved a national circulation—Harper's Weekly, Vanity Fair, Ladies Home Journal, and Life Magazine to name a few.

Over the following seventy-five years, national magazine titles and circulation grew, and consumers embraced the technologies of radio and television which were undergoing consolidation into regional and national networks. For the first time in human history, truly massive audiences could be assembled and mass marketing emerged to serve as both the messenger and the enabler of national brands. Mass marketing refers to the practice of broadcasting homogeneous ads to large, relatively undifferentiated consumer audiences through a mass medium, such as television, radio, magazines, newspapers, billboards, Yellow Pages™ directories, junk mail (including spam), and on the Internet when embedded within the web pages of third-party content providers and search engines. Audience differentiation is often superficial and highly assumptive.

Reach and frequency are the defining parameters of mass advertising—how many consumers does a mass marketing medium reach and how frequently does it expose them to its repetitive messages. In the 1960s, advertisers could be confident that an ad frequently repeated over the three major TV networks—ABC, CBS, and NBC, would reach a majority of the American public and effectively accomplish their marketing objectives. Targeting was fairly straightforward—if a consumer was within earshot of a mass medium, they were an audience member.

Frequency is critical to mass advertising for two main reasons. First, advertisers need to increase the odds that prospective customers are receiving their messages—if a consumer is not ‘tuned-in’ to the venue used by the advertiser while their ad is showing, perhaps they'll see it one of the many times it is subsequently aired. Second, advertisers have long recognized that repeated exposure to their message is required grab consumer attention, and then progressively move them down the path of purchase consideration to eventual purchase. Even an exceptionally well executed ad for an exciting product at a great price can rarely move a consumer to purchase after only one exposure.

Between the 1950s and 1980s, mass marketing grew to become the largest component of annual ad spending by American advertisers. During this period, the widespread business adoption of computer technology and data processing added a new venue to mass marketing—the consumer mailbox. First generation mail advertising used simple telephone directory listings to carpet-bomb consumers by zip code. Subsequent generations used data aggregated from credit card companies, magazine subscription lists and catalog purchasing histories, enabling direct mail service providers to offer advertisers selective access to consumers targeted by zip code, gender, age, and by inferred income, buying patterns and interests. The initial success of targeted marketing using database-driven direct mail was short lived—the progressively lower costs enabled by newer technologies led to such widespread and indiscriminate abuse that database marketing eventually came to be perceived by consumers as simply unsolicited and irrelevant junk mail.

Mass marketing continued to grow because it worked, and because the economics made sense. As long as mass audiences remained aggregated around a limited number of venues, advertisers could economically exploit those venues to carpet-bomb everyone with ads, just to hit those audience members with whom their messages resonated. The profits from the responsive consumers underwrote the costs of carpet-bombing those consumers on whom the message was wasted—consumers who did not have, nor were likely to ever develop, a propensity to purchase the goods or services being advertised, and on those consumers who may have already purchased the product and, as a result, were no longer in the market to buy.

Over the past three decades, a convergence of events has progressively changed the calculus of mass marketing and eroded its effectiveness as a selling medium:
As consumer product and services companies spent ever increasing dollars on advertising to gain or protect their share of markets from competitors, the volume of advertising increased dramatically. By 1990, various studies cited by articles appearing in The New York Times, Business Week and The Economist claimed that consumers were being bombarded with upwards of 3,000 commercial messages per day, and as a result, were growing indifferent and inattentive to advertising.
While the number of American consumers was growing linearly, the number of advertisers and ads was growing exponentially. New technologies lowered the barriers to admission into many industries and enabled hundreds of thousands of new competitors to enter the untapped niches of incumbent's marketspaces. Globalization brought a rising flood of foreign products and their advertising dollars into domestic markets. As an example, by 2003, ads from General Motors, Ford, Chrysler, and Volkswagen were joined by those of over 30 new competitors. Incumbents responded aggressively with larger ad campaigns, and with brand extensions, each of which needed their own distinct advertising campaigns. As an example, new product categories including ethnic and convenience foods, and the rapid growth of product line extensions, grew the number of SKUs (stock keeping units) in the consumer's food shopping experience from 5,000 in 1960 to over 30,000 by the year 2000. In the shampoo subcategory alone, Procter &Gamble offered 30 varieties of Head & Shoulders by 1996. As another example, in 1960 the Coca Cola™ Company primarily advertised in competition against Pepsi Cola™, and a small number of distant second-tier beverages. In 2004, they had to market Coca Cola against a field of hundreds of new beverage categories and products including soft drinks, energy drinks, sports drinks, new age drinks, and bottled and flavored waters. Classic Coke advertising now competes against Coca Cola's own extensions as well—Diet Coke, Vanilla Coke, Cherry Coke, Caffeine-Free Coke, and Coke II—for the limited attention of thirsty consumers overwhelmed by beverage ads.
The emergence of new technologies and the disruptive economics which they enabled have effectively cannibalized once aggregated mass media audiences and scattered them across hundreds of thousands of newer and smaller destinations where they have proven difficult for advertisers to find and target. Widespread cable adoption has increased the number of available television channels more than tenfold. Advances in computerized printing has driven down production costs and enabled the emergence of hundreds of new low-circulation niche magazines, currently numbering more than 1,200. The public's enthusiastic embrace of the Internet has resulted in an almost limitless choice in new information and entertainment website destinations.

By the end of the millennium, in just three decades, the number of ads and venues each increased more than one hundred-fold. As a result, ad campaigns have necessarily grown more complex—simple campaigns of repeating the same ad on the three major television networks to reach the majority of the buying public are no longer possible—excepting events like the Super Bowl and the Academy Awards, a majority of the buying public can no longer be found aggregated in any one venue. Ad campaigns have necessarily grown more numerous, as each product and service company, domestic and foreign, fights to protect or gain marketshare. Advertisers no longer feel confident that their messages are reaching their intended audiences and even less confident that their intended audiences are being engaged.

As cited in Advertising Age, Jan. 21, 2002; From Net to TiVo, Marketers Need to Use New Technology, “After years of denial, seasoned marketing executives are recoiling from the waste they see in mass advertising. Magazine ad pages fell 11.7% last year, the steepest plunge in nearly a quarter century. Merrill Lynch projects a 4% drop in TV spending this year, after a similar fall last year.”

As cited by Steven J. Heyer, president of Coca Cola in Business Week, Mar. 1, 2004, Coke: Wooing the TiVo Generation, “The days of mass, homogeneous advertising are behind us.”

As cited by MediaPost.com, MediaPost.com, Sep. 19, 2003, Top Ad Factor: Fragmentation, Not Consolidation, ROI, New Media, “The proliferation of media options and its impact on audience fragmentation, not the consolidation of industry players, the emergence of new media technologies or the push for advertising accountability has been the greatest factor influencing the ad business over the past five years and will likely be so over the next five years . . . ”.

As cited in Fortune magazine, Aug. 11, 2003, Volume 148, No. 3, Brand Killers, “ . . . a study by Willard Bishop Consulting found that in 1995 it took three TV commercials to reach 80% of 18- to 49-year old women. In 2000, just five years later, it took 97 ads to reach the same group”.

As cited by MarketingProfs.com, “the enormity of the industry that is marketing is dwarfed only by the consistency of declines in the industry's effectiveness. Last year this industry of approximately 220 billion dollars experienced a measly 3% conversion rate on dollars spent. Similarly, 270 billion coupons were delivered to consumers in the United States last year. The redemption rate on these coupons was three percent at best. Firms in the United States spent $42 billion on junk-mail campaigns last year, burying the average American household under 543 solicitations; shelled out $67 billion for telemarketing phone calls and $14 billion on Spam.”

As cited in MediaWeek, MediaWeek.com, Sep. 22, 2003, DirecTV Study Finds TV Still Integral in U.S. Homes, “ . . . in a survey of adults over age 21 . . . An alarming fact for advertisers: 52 percent say the leave the room for commercials . . . . The report also found that many people multi-task while watching TV, such as using the phone (23 percent), paying bills (12 percent), using the computer (6 percent) and eating (53 percent).”

The decline in mass marketing effectiveness demonstrates the criticality of audience targeting in advertising—the degree to which desirable audiences having known needs, wants and dreams can be differentiated from the general consumer public, and then selectively targeted and engaged with ad campaigns created accordingly. When consumers are instead conditioned to believe that most ads are irrelevant to their own particular needs, wants and dreams, they eventually become unwilling to invest the time and attention needed to discover which ads might actually pertain to them.

In the early 1990s, as the public began to embrace the Internet, industry analysts were quick to predict its commercial potential as the first true one-to-one marketing venue and the just-in-time successor to mass media marketing. In theory, the Internet could track consumer behavior in real-time, could precisely target prospective customers with individualized dialogues and ad content, could accommodate any multimedia format used in other advertising venues, and finally, unlike any other advertising medium, could actually execute transactions and close sales. The Internet was widely heralded as the medium that would reconnect advertisers with their scattered audiences, and re-engage consumers with relevant and compelling multimedia ad messages.

The exploitation of the Internet as a precision-targeting marketing channel never materialized as predicted. By all accounts, its evolution as a marketing channel over the past decade appears to have been an accelerated replay of the past five decades of traditional offline mass marketing.

As cited by Editor & Publisher journal, Masses Still Tuned in to Mass Media Advertising, Oct. 27, 2003, “A new study from MediaVest USA and Knowledge Networks found that people report that they pay more attention to traditional media ads and less so to online ones. Online ads were able to beat out only advertising appearing in public restrooms.”

The first advertising on the Internet was in the form of banner ads appearing on any website willing to display them. As portals—general interest gateways to the Internet, such as AOL, Yahoo, and MSN—emerged they became the dominant Internet destinations and the primary aggregators of ‘consumer eyeballs’, amassing the greatest share of the ad banner business. Portals evolved into the online equivalent of network television. Both serve up general interest programming and relatively undifferentiated ads to a mass of undifferentiated viewers. Both rely on third-party services—Neilson for network television, and MediaMetrix and Neilson Interactive online—to measure eyeballs and popularity, to justify the fees they charge advertisers. Like network television, portals are experiencing declines in the rates they can command as advertisers insist on pay-for-performance models, rather than ad exposure-based pricing, and as advertisers spread their marketing dollars to more promising venues.

As special interest websites emerged, they became the online equivalent of niche cable TV channels, serving up more focused content and ads to consumers having an affinity for the topics covered. ESPN.com, MLB.com (Major League Baseball) and NFL.com, for example, all serve ads for sports-related products and events comparable to those shown on the Golf Channel, OLN (Outdoor Living Network) and ESPN cable channels. A new form of special interest website, the blog, has recently become another such venue for affinity-based advertising.

As consumers embraced email, it was quickly exploited as the online equivalent of direct mail marketing. Permission-based e-mail, for example, targets consumers using data learned about them as they make a purchase at a website. When the consumer completes a purchase, the website asks for permission to send periodic e-mails about products similar or complimentary to the merchandise purchased. After an impressive early success, permission-based email marketing suffered a fate similar to its direct mail counterpart, but on a far larger scale. Unlike direct mail marketing where every piece mailed has associated printing and postage costs, the cost of electronically reproducing and sending email ads is so low as to be largely insensitive to volume. The near-zero incremental cost of e-mail advertising, and the relative ease of selling customer lists online, gave rise to spam—an extremely high volume e-mail marketing method with little or no consumer targeting, but with such an attractive cost structure that response rates of less than 1/100^{th} of one percent are acceptable to advertisers. Like its offline counterpart, consumers' email inboxes have become so cluttered with spam that permission-based marketing has become synonymous with junk mail. As cited in Business Week, Feb. 7, 2005, The Lid on Spam is Still Loose, “a study by Nucleus Research indicates that 75% of email traffic in 2004 was spam.”

Consumer mailboxes, and on the Internet, consumer email inboxes, are the two venues which offer advertisers a direct, individually addressable channel through which they can target consumers. Further, unlike every other venue which depends on consumers ‘tuning-in’—watching a television channel or visiting a portal, reading a niche magazine or visiting a niche website, reading a newspaper or using a search engine—mail arrives reliably to an unchanging customer touch-point which most consumers access at least once a day. Ironically, by indiscriminately polluting both with junk mail, marketers may have squandered an opportunity to exploit mail's potential as the ideal one-to-one marketing venue.

Search-engine marketing has emerged as the most popular and fastest-growing venue for Internet-based advertising, and is an online equivalent to newspapers. With newspapers, users search out the sections and topics of interest whose pages also include related ads, as determined by the editorial staffs and by the fees advertisers are willing to pay. With search engines, users search out information by entering a query which generates lists of relevant content websites and related ads, as determined by the presence of keywords within user queries. Advertisers purchase, rent, or bid for keywords which, when present in the user's query, trigger the inclusion of their ad on the search engine results page. Search engines such as Google allow marketplace forces to determine the fee charged for keywords—advertisers bid against one another for higher ranking associated with each keyword. The highest bidding advertisers, all other factors being equal, will have their ads displayed before lower bidding advertisers. Google uses a pay-for-performance model and charges each advertiser their bid amount only when a user clicks on their ad.

The growing success of search engine marketing may be temporary—like permission-based email marketing, it may become a victim of its own success. Search engine's pay-per-click model is increasingly exposing advertisers to the growing risk of click-fraud, whereby ads are intentionally and maliciously clicked by competitors, by disgruntled employees, and by click-bots—programs run by illegal services which automatically and repeatedly click keywords with the intent of interfering with the normal performance of search engine marketing and artificially driving up advertiser costs. As search engine marketing gained popularity, the increased bidding competition for keywords has driven average click costs high enough to imperil the pay-per-click model.

As cited in The Register, Botnets strangle Google Adwords Campaigns, Feb. 2, 2005, ‘“By disabling targeted keywords across many advertisers' campaigns simultaneously by artificially inflating the number of times an ad is displayed, an attacker can secure a higher ad position,” explains Clickrisk.com chief exec Adam Sculthorpe. The attack—dubbed keyword hijacking—is difficult to prevent because it takes advantage of a design feature of Google Adwords rather than a flaw, he added. Clickrisk came across the attack in investigating why the click-through rates of one of its clients—which had been running at a steady rate—dropped to zero for no apparent reason. Subsequent monitoring and forensic testing revealed that a botnet made up of open proxies in China was responsible for the attack.’

As cited in CNN/Money, Google CFO: Fraud a Big Threat, Dec. 2, 2004, ‘A top Google official said that growing abuse of the company's lucrative sponsored ad-search model jeopardizes the popular Internet search engine's business. “I think something has to be done about this really, really quickly, because I think, potentially, it threatens our business model,” Google Chief Financial Officer George Reyes said Wednesday. Reyes, speaking at an investor conference sponsored by Credit Suisse First Boston, was referring to an illegal practice known as “click fraud” that occurs when individuals click on ad links that appear next to search results in order to force advertisers to pay for the clicks. In cost-per-click advertising, marketers pay a search engine, like Google, Yahoo! or FindWhat.com, when users click on links to the advertisers' Web sites. Google and others also generate revenue by posting sponsored ad links on other Web sites and splitting the fees generated by user clicks. The paid-search model is now the fastest-growing form of Internet advertising, according to the Interactive Advertising Bureau. But analysts, fraud experts and now Google are openly fretting about the rise of click fraud. The main perpetrators appear to be competitors of advertisers and also scam sites set up for the sole purpose of hosting ad links provided by Google, through its AdSense unit, or Yahoo!, through its Overture service. Humans or specially designed software then click on those ad links in order to “steal” revenue from advertisers. Estimates of how prevalent click fraud has become since it appeared four years ago are all over the map.’

As cited by The Associated Press, Click Fraud a Threat to Search Engine Ads, Feb. 11, 2005, ‘Like thousands of other merchants, Tammy Harrison thought she had struck gold when hordes visited her Web site by clicking on the small Internet ads she purchased from the world's most popular online search engines. It cost Harrison as much as $20 for each click, but the potential new business seemed to justify the expense. Harrison's delight dimmed, though, when she realized the people clicking on her ads weren't really interested in her products. She was being victimized by “click fraud,” a scam that threatens to squelch the online advertising boom that has been enriching Google Inc., Yahoo Inc. and their many business partners. The incentives for click fraud have increased along with the money devoted to search engine advertising—a concept that didn't exist until Overture Services introduced it in the late 1990s. By 2008, industry research firm eMarketer expects $7.4 billion to be spent on search engine advertising, up from just $108.5 million in 2000. The success of search engine advertising has substantially raised prices, too. In mid-1999, advertisers paid Overture an average commission of 11 cents per click. By the end of last year, advertisers were paying an industry-wide average of $1.70 for the hundreds of keywords tracked by Fathom Online. The cost of prized search terms runs much higher. For instance, the top price for mesothelioma, a cancer that spurred scores of lawsuits linking the illness to asbestos exposure, recently stood at $51 per click, Fathom said.”

As click fraud becomes more prevalent, search engine marketing as an advertising venue becomes increasingly risky for small businesses. Malicious ad clicking can rapidly and unexpectedly drive up campaign costs and cripple a small businesses' cash flow. The ability to abuse and thus subsequently disable ad key words enables any business to effectively neutralize their competitors' ad campaigns without spending any ad dollars of their own.

Google recently revealed a new online advertising model in a pilot of their email service, ‘GMail’. In exchange for enhanced email service and virtually unlimited message storage, subscribers give permission to Google to electronically archive their inbound and outbound email in perpetuity, including user-deleted email, and then scan the email to search for keywords which Google can then use to target their client's ads. As an example, if a user sent or received an email which included the word “car” in the body of the message, a car ad might be embedded in a future email and displayed when the user opens it. The theory behind GMail is that analyses of each subscriber's archived correspondence may, over time, build a reliable profile of their needs and interests. Presently, GMail has not credibly automated the analyses of keyword contexts—a GMail message in which the user complains about their aging car, and a GMail message in which a user brags about their new car, each having dramatically different marketing implications, will both display the same embedded car ad in emails subsequently received by the user.

Privacy advocates have reacted strongly to GMail, which potentially exposes its users to a loss of privacy. As cited by the Chairman of the Electronic Frontier Foundation in Privacy Subtleties of GMail, “GMail created a surprising storm for a product that hasn't yet been released. A coalition of privacy groups asked Google to hold back on releasing it. A California state senator proposed a law to ban the advertising function . . . . One key risk is that because GMail gets your consent to be more than an e-mail delivery service—offering searching, storage and shopping—your mail there may not get the legal protection the ECPA gives you on E-mail.” Passed in the 1980s, the Electronic Communications Privacy Act (ECPA) declared that e-mail is a private means of communication, that police need a wiretap warrant to read your e-mails, and that e-mail company employees cannot disclose any e-mail contents to other parties. The ECPA additionally stipulates that e-mail which has been archived for more than 180 days loses much of its privacy protection. The citation continues, “without the ECPA protection, your e-mail (now just a database) can be seized with an ordinary subpoena (vastly less involved than a warrant or wiretap) or in the discovery phase of a lawsuit.”

Users of GMail are not the only parties that are thus affected—users of other mail services sending email to GMail users share the same exposure, and while non-GMail users can avoid sending email directly to GMail subscribers, they have no such knowledge or control over whether other recipients of their email might in turn forward their messages to GMail subscribers.

Their growing awareness of privacy loss and identity theft is making consumers increasingly reluctant to disclose their personal information, and has given rise to a new ad targeting technology—spyware—a technology that gathers information about a person without their knowledge. On the Internet, spyware is programming that is placed in someone's computer to secretly gather information about the user and relay it to advertisers or other interested parties. Spyware can get in a computer as a software virus, as the result of installing a new program, as a “drive-by download”, or as the result of clicking some option in a deceptive pop-up window. Spyware is usually triggered in response to the user implying an interest to purchase when visiting a commercial website. If the company which installed the spyware has an advertising client with a competing product or service, the spyware generates a pre-emptive pop-up window containing the competitor's ad.

Spyware has been used by many reputable companies. As cited by Common Sense Technology, Monday, Nov. 15, 2004, National brand name companies use spyware and adware, “So who uses Spyware? How about Intel, Gateway, Nokia, Microsoft, Sears, AOL . . . they all do. Even the Internal Revenue Service!”

Consumer and industry response to spyware has been dramatic. A popular new category of software application has recently emerged which detects and eliminates spyware from users' computers. More than a dozen websites now exist, dedicated to helping users identify spyware and the best tools for eliminating or quarantining spyware programs. Major Internet service providers, such as AOL, and security products companies such as McAfee and Symantec have recently added spyware detection and management features to their services.

In addition to violating consumer privacy, spyware has been identified as a primary culprit in the degradation of computer performance and a significant cause of computer instability. As cited by CRN.com in Tiny, Evil Things, “Microsoft estimates spyware is responsible for half of all PC crashes. Dell says 12 percent of its tech-support calls involve spyware, a problem that has increased substantially in recent months. Scans of one million Internet-connected PCs, conducted last quarter by Internet service-provider EarthLink and desktop-privacy and -security vendor Webroot Software, found an average of 28 spyware applications running on each PC and more than 300,000 programs at large that can steal data and give hackers access to computers.”

In summary, companies generally view advertising as an increasingly risky investment with growing uncertainty and costs, and shrinking accountability. The majority of Internet-based advertising is based on traditional mass marketing models whereby advertisers publish relatively undifferentiated ads in venues which solicit the attention of relatively undifferentiated consumers using content as a draw. Internet-based advertising effectiveness, as measured by consumer response rates, is frequently lower than that of other mass marketing venues. Internet-based advertising differs from traditional mass marketing primarily through its ability to measure and use consumer mouse-clicks to support a pay-for-performance cost structure, and through the dramatically lower costs associated with digital replication and distribution of ad content to consumers. The vastly superior economics of Internet advertising have, in effect, provided a life-support system which has prolonged advertiser dependency on an obsolete mass marketing model. The potential of the Internet to re-aggregate consumers, re-gain consumer attention, and re-engage consumer interest is largely unfulfilled.

### BRIEF SUMMARY

An embodiment of the invention provides a method whereby anonymous Internet users can create rich, precisely articulated personal information profiles (hereinafter referred to as “profiles”) having significant commercial value, which include extensive declared demographic, psychographic, product and service purchasing histories, propensities, brand affinities, and other non-identifying personal data including their wants, their needs and their interests.

Another embodiment provides a marketplace into which anonymous Internet users can publish their profiles and share their profile information with interested parties for the purposes of exploiting its commercial value and enabling other marketplace users (hereinafter called “members”) to deliver more relevant content and a more personalized web experience. Internet users joining the marketplace and publishing their profiles are hereinafter referred to as “anonymous consumer members” or “consumers”.

Another embodiment enables consumers to serve as active agents in the stewardship of their profiles and their anonymity, such stewardship which includes maintaining the completeness, the accuracy and the currency of their profiles, control over access to their profiles by interested parties, oversight and protection of their anonymity, and control over the nature and duration of the relationships they may elect to initiate with third-parties.

Another embodiment enables the monitoring and analyzing of ongoing consumer behavior within the marketplace for the purposes of collecting supplemental profile data, including data which infers their credibility as stewards, and which measures their good-faith participation in the commercial exploitation of their profiles.

Another embodiment enables anonymous consumers to share links to websites which they have discovered, including those websites residing in the “deep web” and thus not reachable through popular search engines, with other consumers having similar profiles and interests.

Another embodiment provides services to the marketplace which enable advertisers and ad agencies to self-service filter and segregate consumers into desirable, highly differentiated and discrete audiences (hereinafter referred to as “well-defined audiences” or “audiences”) of one or more consumers, based on profile data which they believe may indicate purchase potential, and on profile data which they believe may qualify their credibility, for the purposes of conducting precision-targeted advertising and individualized marketing campaigns tailored to the character of the audiences so defined.

Still another embodiment enables advertisers to conduct ad campaigns using ad media of the highest quality, including HDTV-quality video and CD-quality audio, which the Internet-browsing devices of their well-defined audiences are capable of rendering, with no audience-experienced delay or download waiting time. Ad media is additionally displayed on the devices of audience members in a manner which does not compete with other web content for the attention of audience members, or for the screen display area of their browsing devices.

Another embodiment enables advertisers to target and engage consumers indirectly, through other anonymous consumers who may be potential influencers of their purchasing decisions, such as spouses and other household members.

Still another embodiment enables each consumer to extend invitations to advertisers to enter into ongoing relationships, and to subsequently share control over the nature and duration of such relationships with each advertiser, for the purposes of progressively learning sufficient information to make a purchase decision with confidence.

Another embodiment enables advertisers invited by consumers into ongoing relationships to dynamically publish rich and functionally interactive ads into such consumers' individualized Yellow Pages™-type directories, at a frequency of their choosing, and such ads including media formats and playback immediacy as described in paragraph 71.

Another embodiment enables advertisers to monitor—in near real-time—detailed audience responses to their ad campaigns, and to subsequently and selectively target specific audience members in follow-up ad campaigns based on their individual campaign response histories.

Yet another embodiment enables advertisers to monitor the ad campaign activities of all other advertisers, including direct and indirect competitors, who are using the marketplace to target the same well-defined audience members.

Another embodiment enables advertisers to discover the media preferences—newspapers, magazines, television and radio channels, and Internet websites—where their well-defined audience members seek news, entertainment, sports and financial information, for the purposes of better targeting said audience members—and by extrapolation, similar consumers who are not marketplace members—through ad campaigns placed in such venues identified accordingly.

Another embodiment enables anonymous consumers to provide selective access to the data within their profiles to each website which they visit, including search engines, for the purposes of enabling each such website to deliver more relevant and personalized content, including the selection of ads which a website may choose to embed within the web pages thence downloaded to each anonymous consumer.

Another embodiment enables the marketplace to continuously reward consumers directly—through revenue sharing, and indirectly—through prepaid gameslips to marketplace operated games-of-chance, in proportion to their good-faith participation in the marketplace.

Another embodiment enables consumers to use their earned awards to anonymously purchase or rent micropayment-priced digital content, including but not limited to individual text articles, images, songs, videos, web applets, software applications, games, and subscriptions to blogs, from third-party content providers and from other consumer members, such micropayment transactions between consumers and third-party content providers being substantially free of transaction processing fees to all parties, and such transactions among consumer members being entirely free of transaction processing fees.

Another embodiment enables consumers to offer their own micropayment-priced digital content, including but not limited to original written works (i.e. amateur and/or independent authors operating without a publisher), original music (i.e. amateur or independent bands operating without a record label), original videos (i.e. amateur or independent film producers operating without a studio), and original video games and programs (i.e. independent programmers), for sale or rent to other members.

Another embodiment enables the reliable and secure tracking of rented digital content usage by consumers and the automated collection and payment to digital content providers or all such rental fees accrued by each consumer renting content on a pay-per-use or pay-per-unit-time basis.

Another embodiment enables anonymous consumers to share profile information relating to their affinities and sympathies for various causes—including but not limited to environmental, social, education, children's rights, animal rights, political, human rights, open source software, freeware, shareware and other such movements—with organizations whose activities promote and advance such causes, for the purposes of enabling such organizations to solicit them for donations from rewards which they earn for their participation in the marketplace, and to earn consumer members additional credibility as good faith participants in the marketplace.

Another embodiment enables consumers to access and withdraw monetary rewards they earn from revenue sharing, winnings from marketplace operated games-of-chance, and from the sale or rental of digital content, from the marketplace in a manner which does not compromise their anonymity within the marketplace, and which is compliant with applicable federal and state income tax and gambling regulations.

### BRIEF DESCRIPTION OF THE DRAWINGS

FIG. 1 shows a marketplace network and supporting elements in accordance with an embodiment of the present invention.

FIG. 2 is a block diagram illustrating details of the marketplace servers of FIG. 1.

FIG. 3 is a block diagram illustrating the marketplace tools of the consumer node 105 of FIG. 1.

FIG. 4 is a block diagram illustrating the marketplace tools of the advertiser 110, ad agency 115 and worthy cause 120 nodes of FIG. 1.

FIG. 5A is a flowchart and example illustrating the method of creating an anonymous consumer member serial number in accordance with an embodiment of the present invention.

FIG. 5B is a flowchart illustrating the determination of a consumer member applicant's household members who are existing members of the marketplace of FIG. 1.

FIG. 5C is a block diagram illustrating details of consumer member data storage on the marketplace servers of FIG. 1.

FIG. 5D is a block diagram illustrating the method of identifying the household membership composition of any anonymous consumer member.

FIG. 6 is a block diagram and flowchart illustrating the method of anonymous consumer member logon to the marketplace in accordance with an embodiment of the present invention.

FIG. 7 illustrates an example of a standardized taxonomy for content in accordance with an embodiment of the present invention.

FIG. 8A is a flowchart with example illustrating the method of consumer members adding sharable website links in accordance with an embodiment of the present invention.

FIG. 8B is a flowchart and example illustrating the method of capturing and sending sharable link data for publication into the marketplace in accordance with an embodiment of the present invention.

FIG. 8C through 8G illustrate example database table structures of the content databases 225 of FIG. 2, which enable links to websites to be searched by consumer members sharing one or more demographic, psychographic or interest attributes in accordance with an embodiment of the present invention.

FIG. 9 is a flowchart illustrating the method of variable-focus website links search in accordance with an embodiment of the present invention.

FIG. 10A is a block diagram illustrating the profile data organization on the consumer node 105 of FIG. 1 in accordance with an embodiment of the present invention.

FIG. 10B illustrates an example of a standardized taxonomy for profile data in accordance with an embodiment of the present invention.

FIG. 10C is a block diagram illustrating an example of consumer profile data organization in the consumer databases 215 on the marketplace servers 125 of FIG. 2 using the standard taxonomy of FIG. 10B.

FIG. 10D illustrates an example of specific data points in the consumer member demographic profile.

FIG. 11A illustrates the elements of a profile data request from a third-party content provider which enables the method of intimate anonymity of consumers in accordance with an embodiment of the present invention.

FIG. 11B illustrates an example of an HTML exchange between third-party content providers and a consumer node which enables the method of intimate anonymity of consumers in accordance with an embodiment of the present invention.

FIG. 11C illustrates an example of an alert generated by a profile data request from a third-party content provider of type 130A of FIG. 1.

FIG. 11D illustrates an example of an alert generated by a profile data request from a third-party content provider of type 130B of FIG. 1.

FIG. 11E is a flowchart illustrating the process of creating and using profile data request permission templates to enable automated intimate anonymity with third-party content providers.

FIG. 12A is a block diagram illustrating the method of the audience explorer of FIG. 4 which enables the precise definition of target audiences by advertisers in accordance with an embodiment of the present invention.

FIG. 12B is a block diagram illustrating an example of a hierarchy of well-defined consumer audiences which advertisers may selectively target in accordance with an embodiment of the present invention.

FIG. 13A is a flowchart illustrating the process of the campaign builder 420 of FIG. 4 which enables advertisers to define ad campaigns in accordance with an embodiment of the present invention.

FIG. 13B illustrates probe campaign parameters which enable targeted ad campaigns to execute on the consumer nodes 105 of FIG. 1.

FIG. 13C is a flowchart illustrating the process of distributing defined ad campaigns to targeted consumer audiences in accordance with an embodiment of the present invention.

FIG. 13D is an example database table structure illustrating the method of tracking target consumer audience responses to an active ad campaign

FIG. 14A is a block diagram illustrating the elements of the consumer node 105 ad manager 325 of FIG. 3.

FIG. 15 is a block diagram illustrating the elements and example entries in the consumer's Living Pages 345 of FIG. 3 in accordance with an embodiment of the present invention.

### DETAILED DESCRIPTION

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

It is noted that all illustrations and examples herein which use values, variables, constants, code, pseudocode and process names or structures are expressed as such for purposes of clarity, and that their actual expression using standard syntax and formats, and using accepted design and implementation practices, will be readily apparent to those skilled in the art.

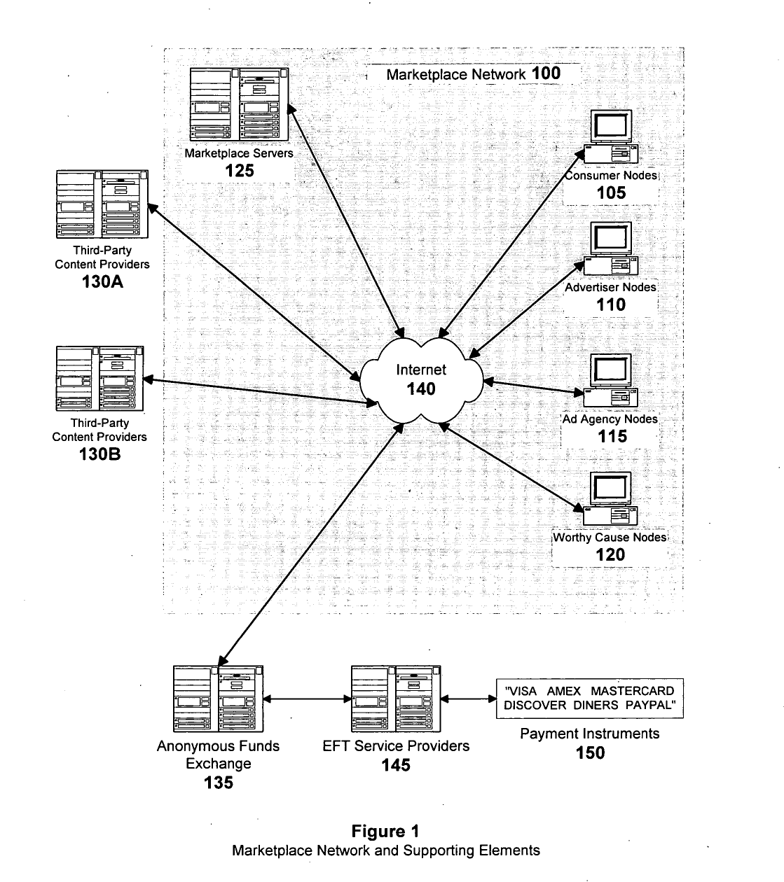

FIG. 1 illustrates a marketplace network 100 and supporting elements in accordance with an embodiment of the present invention. The marketplace network 100 includes consumer nodes 105, advertiser nodes 110, ad agency nodes 115, worthy cause organization nodes 120, and marketplace servers 125, each coupled together via a network 140 (e.g., wide-area network commonly referred to as the Internet). Supporting elements connected to the marketplace network 100 include an anonymous funds exchange 135, electronic funds transfer (EFT) service providers 145, and common payment instruments 150. Also illustrated is the population of all websites accessible to the general public, shown as third-party content providers 130A and 130B.

One skilled in the art will recognize that the marketplace nodes and networks may be connected physically or wirelessly to the Internet 140. Users of consumer nodes 105 (hereinafter referred to as “consumers”), advertiser nodes 110 (hereinafter referred to as “advertisers”), ad agency nodes 115 (hereinafter referred to as “agencies”) and worthy cause organization nodes 120 (hereinafter referred to as “worthy causes”) are hereinafter collectively referred to as “members” of the marketplace.

A node is defined to be any electronic programmable device which can run custom applications, which can support a graphical user interface (GUI) including an input device, is equipped with local mass data storage such as hard disk, flash RAM or other functional equivalent, which has the ability to support either a transient or persistent connection to the Internet, which has web browser functionality, and which is equipped with the appropriate applications as described herein which enable its participation in the marketplace. Potential nodes may include desktop computers, laptop computers, personal digital assistants (PDAs) and cellular telephones so equipped. Nodes are not necessarily dedicated to participation in the marketplace but may instead be more general purpose devices capable of serving multiple purposes, of which participation in the marketplace is one.

Marketplace servers 125 refers to one or more applications and one or more application-, web- and database-server devices which collectively control and monitor the marketplace network 100 and serve as the primary repository of aggregated marketplace data.

The exchange of security, control and transaction data within and across member nodes 105, 110, 115, 120, the marketplace servers 125, and the anonymous funds exchange 135 is accomplished through the use of formatted data messages and reliable message queues, familiar to those skilled in the art, whereby data-bearing messages are routed among message queues residing on each of the nodes, on the marketplace servers, and on the anonymous funds exchange respectively, and which are then processed by each as necessary to support their participation in, and the timely functioning of, the marketplace. Security, control and transaction data within each message may include a message type, routing data, processing priority and other such data as necessary to enable the timely sharing of data and the coordination of operations among the nodes and elements of the marketplace as described herein. The exchange of messages is denoted herein using the format MSG: ‘MessageType’, where specific ‘Message Type’ examples are offered for the purposes of clarity only. Other security, control and transaction data exchange embodiments are possible and are known to those skilled in the art.

The marketplace network 100 enables its members to interact in a virtual marketplace that is highly controlled and closely monitored by the marketplace servers 125. Consumers are completely anonymous within the marketplace network 100, their actual identity being unknown to all other members, and unknown to the marketplace servers 125 and its operators. Consumer IP addresses are not examined or captured by the marketplace servers and are not visible or otherwise available to any other members of the marketplace network. Further, the marketplace does not solicit or allow consumer members to supply an email addresses or any other information which may potentially reveal their actual identities or otherwise compromise their absolute anonymity.

The marketplace servers 125 provide intermediary services between consumer members—and advertiser, agency, and worthy cause members, and all other third-party content providers seeking to intimately know and precisely target anonymous consumer audiences. The marketplace provides an environment where the intimate anonymity of consumers can be commercially exploited to the mutual benefit of each of its members. The essence of the marketplace is that it:
Enables consumers to publish rich and precisely articulated, detailed, and non-identifying personal data anonymously
Enables advertisers and ad agencies to market their wares to anonymous consumers precisely targeted through such published and aggregated personal data
Enables worthy causes to market their causes and to solicit donations from sympathetic consumers precisely targeted through such published and aggregated personal data
Enables third-party content providers to automatically access select data points from the profiles of consumers who visit their websites
Enables consumers to materially profit from the publication of their anonymous data to the marketplace, and from their active, good-faith participation in the marketplace

Third-party content providers 130A and 130B refers to all existing websites on the World Wide Web that are accessible to the general public, including websites residing in the deep web as described in the ‘Description of the Prior Art’ section, and includes those websites offering content for free, content on a paid subscription basis, or content on a fee-per-item-viewed or fee-per-item-downloaded basis. Content is defined as any digital media which may be viewed or used, and/or downloaded for subsequent viewing or use through common web browser software with or without the assistance of plug-ins or helper applications, and includes but is not limited to standard HTML, text, graphic images, animations, videos, scripts, proprietary content formats—including but not limited to Adobe Acrobat (PDF), Macromedia Flash and Shockwave (DIR, SWF), Microsoft Office (DOC, XLS, PPT), Microsoft Reader Electronic Books (LIT), Zinio Electronic Magazine (ZNO)—and other commonly used and proprietary content formats including executable web applets and standalone software applications.

Consumer members are anonymous to all third-party content providers 130A, meaning that no information about a visiting member which discloses their actual identity is known by the third-party. Examples of third-party content providers 130A include google.com, cnn.com, imdb.com and other such websites accessible to the general Internet-using public, the use of which does not require disclosure of personally identifying information. At the discretion of each consumer member, they may be selectively known by identity in part to third-party content providers 130B, meaning that the third-party may recognize the visiting consumer as being associated with an account maintained by the third-party content provider on the member's behalf, and such account containing information which personally identifies the member. Examples of third-party content providers 130B include msn.com and aol.com, whereby access to the websites' premium content is granted by virtue of subscriptions paid for by members through identity-bearing instruments such as credit cards.

Some third-party content provider websites may be both 130A and 130B, as determined by the actions and visiting histories of each visiting user—each visitor to a website may be initially anonymous and the third-party content provider may thus be classified as type 130A for such visitors. If a visitor subsequently makes a purchase or otherwise establishes an account requiring the disclosure of personally identifiable information, then for that specific user, the third-party content provider becomes type 130B. Examples of such content providers include amazon.com, llbean.com, and ebay.com, each of which enables visitors to browse or shop anonymously, until such time as they elect to make a purchase or establish an account, each of which then requires the use of an identifying payment instrument.

The delivery of third-party content provider 130A and 130B content and functionality to consumer nodes 105, and the submission of data manually entered by consumer members specifically on any web pages of third-party content providers 130A and 130B is accomplished using traditional methods and protocols common to popular web browsers and are well known to those skilled in the art. The exchange of marketplace-specific security, control, and transaction data and consumer member profile data between the marketplace and third-party content providers 130A and 130B is described in paragraph [210].

The Anonymous Funds Exchange 135 refers to one or more applications and one or more application-, web-, communications- and database-server devices which collectively enable the transfer of funds out of the accounts of anonymous consumer members registered on the marketplace servers and into the accounts of common payment instruments 150, specifically credit or debit cards, Internet-based payment systems such as PayPal, or other such account-based payment instruments which are registered to individuals whose identities are known to the financial institutions (not shown) which administer the common payment instruments 150, using Electronic Funds Transfer (EFT) service providers 145 as intermediaries, the process for which is described in paragraph [328].

All prospective members use their pre-existing web browsers (not shown) to visit the marketplace website (not shown) which is hosted on the marketplace servers 125, where they may take a virtual tour of the marketplace service to discover the benefits of membership. The marketplace website homepage includes web page links to separate tours for consumer, advertiser, agency, and worthy cause members. Any prospective member type can take the tour specific to them and/or to other member types. Consumers 105, for example, in addition to taking the consumer tour, can take the advertiser tour to experience how consumers can be so precisely targeted despite being absolutely anonymous. Advertisers 110, as another example, in addition to taking the advertiser tour, can take the consumer tour to experience the techniques used to engage consumer interest, to promote consumer members' good-faith participation in the marketplace, and to see how consumer credibility is tracked and influenced by the marketplace.

The marketplace is thus transparent to all members, namely, the inner workings and mechanisms of the marketplace are made available for inspection by its members and prospective members, such transparency being a critical element in gaining the trust of consumers that their anonymity cannot be compromised, and in building the confidence of its advertiser, agency and worthy cause members that anonymous consumers can be credibly profiled and precisely targeted.

After viewing the marketplace tours, prospective consumer, advertiser, agency, and worthy cause members can sign up for the service and download the tools specific to their roles in the marketplace. Tools are defined as node-resident, Internet-enabled software applications or processes that enable participation in the marketplace. The tools for use by consumers may either augment or replace their existing web browsers, as described below. The tools for advertisers, agencies, and worthy cause organizations are self-contained Internet-enabled applications which do not use or require their existing browsers to enable their participation in the marketplace. It is noted that some advertiser, agency and worthy cause members may also be consumer members of the marketplace and that some nodes may therefore have more than one type of toolset installed. Web-based tours, member signup, and application download and installation are accomplished using processes and methods known to those skilled in the art.

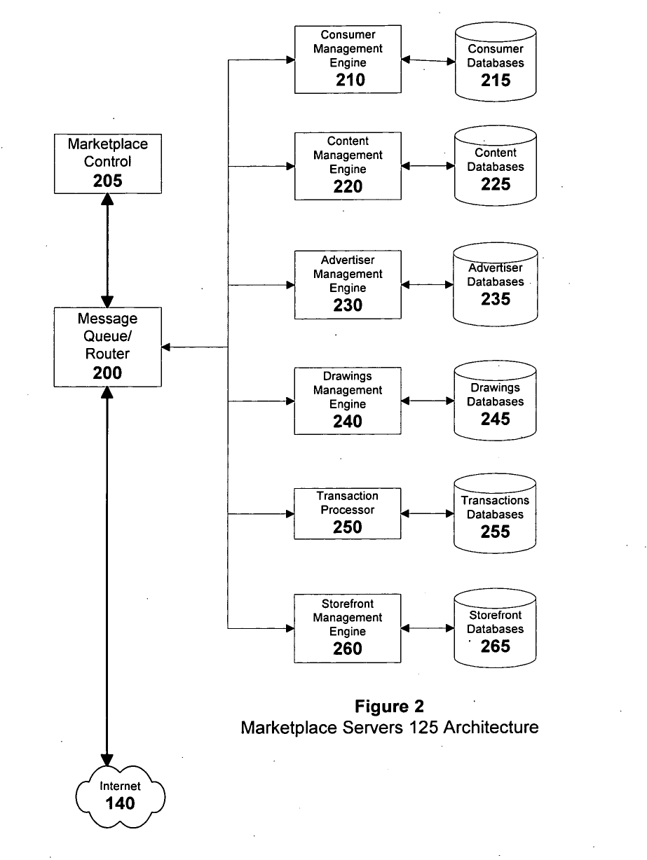

The Marketplace Servers 125, as illustrated in FIG. 2, connect to the marketplace network 100 via the Internet 140 and consist of one or more of logically integrated application, database, and control process elements which collectively support marketplace functionality. The message queue/router 200, routes data-bearing messages between the appropriate applications on the marketplace servers and the member nodes and supporting elements of the marketplace network. The consumer management engine 210 manages the centralized storage of aggregated consumer member data and controls the processing and movement of consumer data 215 within the marketplace network. The content management engine 220 controls the processing and movement of content data 225 within the marketplace network. The advertiser management engine 230 controls the processing and movement of data 235 specific to members using the marketplace for the purposes of conducting targeted advertising campaigns, more specifically, advertisers, ad agencies and worthy causes, and data related to third-party content providers 130A and 130B using the marketplace for purposes of gaining intimate knowledge of anonymous consumers, as described later in this section, within the marketplace network. The drawings management engine 240 controls the operations of drawings and other engaging games-of-chance conducted by the marketplace, and the processing and movement of game-related data 245 within the marketplace network needed to support such operations. The transaction processor 250 supports the management and recordkeeping of transaction data, including micro-payment transaction data, for all marketplace members and third-party content providers, and controls the processing and movement of transaction data 255 within the marketplace network and its nodes and supporting elements. The storefront management engine 260 supports the catalog and display functions for marketplace goods, (i.e. digital content) and controls the processing and movement of storefront-related data 265 within the marketplace network and its supporting elements. The marketplace control 205 provides overall control and coordination of the marketplace.

‘Engines’ refers to one or more applications or automated processes. ‘Data’ refers to one or more data stores and includes databases, data files and other persistent or transient electronic representations of data required to support marketplace functionality, as described herein. ‘Intimate knowledge of anonymous consumers’ and ‘intimate anonymity’, refers to the capability and practice afforded by the invention and its methods whereby advertisers, agencies, worthy causes and third-party content providers may access and exploit detailed and valuable demographic, psychographic and other personal, but non-identifying data points on one or more anonymous consumer members. Each of the elements of the marketplace servers delineated above is described later in this section as appropriate.

It is noted that as the intermediary among members of the marketplace, all marketplace-specific message and data traffic among members moves through the marketplace servers. Members of any type cannot contact, address, send, or solicit messages to or from other members of any type directly. Further, all messages and message content is controlled by automated processes on the marketplace servers and its member nodes. The transmission of messages is triggered directly by processes executing on the marketplace servers or member nodes, or indirectly by members, through actions they may take or through the occurrence of specific events which are monitored on each of the member type's respective nodes, as described herein.

Traffic between consumer nodes 105 and third-party content providers 130A and 130B may take place directly, with or without the participation of the marketplace servers 125 as described later in this section. The IP addresses of consumer nodes 105 visiting third-party content provider 130A and 130B websites are visible to those websites, and may or may not be examined or captured by those websites as they may be so inclined.

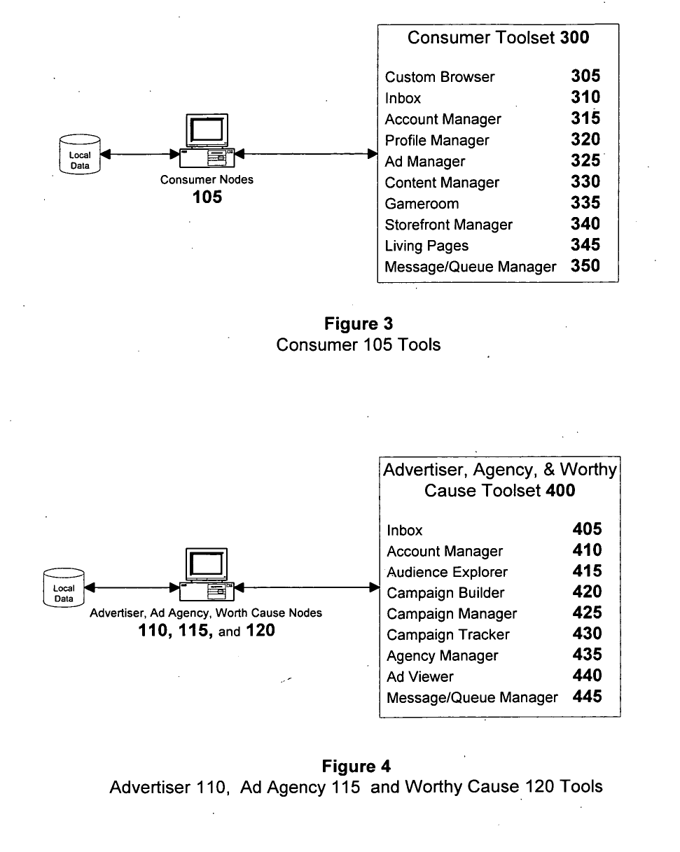

FIG. 3 illustrates an example of the toolset 300 downloaded from the marketplace servers to each consumer node 105. The toolset 300 enriches the consumer's existing web experience by providing the functionality needed to participate in the marketplace network 100, and to enjoy the benefits of anonymous consumer membership, including but not limited to:
Stewardship of their personal data profiles
Financial and material benefit from the publication of their non-identifying personal profile data into the marketplace where it is accessible to advertisers, agencies, and worthy cause members of the marketplace
The ability to exchange website links with other consumer members having similar interests, and demographic and psychographic attributes
The ability to anonymously solicit highly relevant ad content from advertisers and worthy causes, and from agencies which advertisers and worthy causes may engage to use the marketplace services on their behalf
The ability to control the nature and duration of their relationships with advertiser, worthy cause and agency members who actively target them with ad campaigns
The ability to earn rewards in proportion to their good-faith participation as consumer members in the marketplace
The ability to anonymously buy, rent and sell digital content, including micro-payment priced content, with little or no associated transaction processing fees
The ability to participate in games of chance operated by the marketplace

The toolset 300 further enables consumers to selectively grant automated access of specific personal data to any third-party content provider 130A or 130B they visit which uses a method of the invention to request it, and to realize financial and other benefits for doing so.

The custom browser 305 is a marketplace-enabled web browser. The inbox 310 is a closed-community email system which enables controlled communications among members of the marketplace. The account manager 315 tracks the earning and the spending of rewards and revenues by each consumer member, and enables consumers to transfer earnings out of the marketplace. The profile manager 320 captures, analyzes and manages access to declared, derived and observed consumer data. The ad manager 325 supports the display of targeted ads and captures data on the consumer's interaction with each ad campaign. The content manager 330 supports the cataloging, and tracks subsequent consumer access to, and use of, all digital content purchased or rented, and subsequently downloaded by the consumer from the marketplace to their node. The gameroom 335 manages consumer participation in marketplace-sponsored drawings and other games of chance in which participants may win cash. The storefront manager 340 manages one or more virtual stores where consumer members may purchase, rent, sell, or make available for rent, digital content. The Living Pages 345 manages a “Yellow Pages™”-type directory of individualized ad content from advertisers with whom a consumer member explicitly elects to engage in ongoing relationships. The message/queue manager 350 manages incoming and outgoing marketplace-specific message traffic between the consumer node 105 and the marketplace servers.

The message/queue manager 350 is a standalone application which automatically loads and executes on the consumer node as a background process whenever the node is powered on and booted up, and communicates with the other tools using methods know to those skilled in the art. The Living Pages 345 is a standalone application which the consumer member may run whenever the consumer node is powered on and booted up. Each of the other tools may be standalone applications, or they may be integrated into one or more consolidated applications.

Other embodiments of the consumer toolset 300 are possible. For example, certain of the tools could be implemented as a web browser tool bar, also known as a browser helper object, which installs itself into the consumer's pre-existing web browser. As appropriate to the proper functioning as a consumer node 105, the message/queue manager 350 and the Living Pages 345 would preferably remain standalone applications and which would communicate as necessary with the tool bar application using messages and shared data stored on the consumer node. The incorporation of supplemental browser helper objects into web browsers, the installation and configuration of applications which execute transparently as background tasks, and the programmatic coordination and communication between independent applications are common practices and are known to those skilled in the art.

Data created, downloaded or used by the tools 300 is stored locally on the consumer node 105, and/or sent to the marketplace servers for storage, analyses and other marketplace-enabling purposes, as described herein. Each of the tools in the consumer node 105 toolset is described in detail later in this section as appropriate.

It will be apparent to those skilled in the art that the structure and organization of consumer data files, and the sophistication of data management tools needed to manage it, may be different for the marketplace servers and the consumer nodes. The marketplace servers need to efficiently access consumer records and extract sorted clusters of consumer records from a potentially large consumer database, and therefore require powerful database engines and a highly optimized database schema to support marketplace operations in a timely manner. In contrast, each individual consumer node only needs to access the consumer profile data of the one consumer member who may be using it at any time. As an example, a simple, hierarchical data structure based on XML (extensible Markup Language) and using simple XML parsing techniques, known to those skilled in the art, can effectively support any local data management required of consumer nodes for their effective participation in the marketplace.

Consumer nodes may store considerably more data about each consumer member than is stored on the marketplace servers. A significant benefit of the embodiment as described herein, is the marketplaces ability to effectively ‘outsource’ the collection, abstraction and analyses of high volumes of very detailed data on individual consumer members and their behaviors to their respective consumer nodes. All detailed data is retained on the consumer nodes and only specific summary data is sent to the consumer databases on the marketplace servers.

Other embodiments of the invention are possible. One example is to use a traditional web architecture, whereby centralized applications and datastores reside on web servers and which in turn, service ‘thin client’ marketplace-specific web pages downloaded to standard web browsers. Such an embodiment, while eliminating the need for downloading the tool set of the preferred embodiment, would entail the significant burden of centrally storing and processing extremely high volumes of detailed data, or would require a compromise in the level of detail that can be practically captured, abstracted and analyzed. Other disadvantages of a traditional web architecture embodiment will become apparent to those skilled in the art throughout this section.

FIG. 4 illustrates an example of the toolset 400 downloaded from the marketplace servers to each advertiser node 110, ad agency node 115 and worthy cause node 120. The toolset collectively enables advertisers, agencies, and worthy causes to:
Filter the marketplace's general consumer membership into smaller, well-defined audiences using hundreds of precisely articulated demographic, psychographic, purchasing history, preference, propensity, brand-affinity, and consumer credibility data points
Conduct precision-targeted ad campaigns to audiences as defined above
Enter into and track ongoing relationships with audience members, and target follow-up ad campaigns to catalyze consumer member buying decisions accordingly
Conduct precision-targeted ad campaigns to the decision influencers of the audiences defined above
Monitor the performance of their ad campaigns in near real-time
Observe the campaigning activities of other marketplace advertisers, agencies and worthy causes who have targeted the same audience members, including direct and indirect competitors

The toolset 400 further enables worthy cause 120 members to solicit and receive donations from consumer members specifically targeted as described above, and enables advertiser 110 and worthy cause 120 members to collaborate with the agency 115 members they may engage to conduct ad campaigns using the services of the marketplace.

The inbox 405 is a closed-community email system which enables controlled communications among members of the marketplace. The account manager 410 tracks transaction data and the account balances of each respective advertiser, agency and worthy cause member as they engage in marketplace advertising activities. The audience explorer 415 enables the self-service filtering and sorting of the marketplace's general consumer membership into well-defined audiences using the marketplace's aggregated consumer profile data. The campaign builder 420 enables advertisers, agencies and worthy causes to define precision-targeted ad campaign templates through which they can match well-defined audiences with ads and other campaign parameters specifically optimized for those audiences. The campaign manager 425 enables advertisers, worthy causes and agencies to schedule the launching and duration of defined ad campaigns. The campaign tracker 430 provides each advertiser, ad agency, and worthy cause member with near real-time performance data on each of their active ad campaigns. The agency manager 435 manages the secure access, collaboration, coordination and exchange of ad content and campaign data between advertiser 110 and worthy cause 120 members, and the ad agency 115 members which they may engage to act on their behalf in the marketplace. The ad viewer 440 enables advertisers to experience, from the consumer perspective, their own ad campaigns and the campaigns of other marketplace members who are competing for the attention and business of the same audience members. The message/queue manager 445 manages incoming and outgoing marketplace-specific message traffic between each advertiser 110, agency 115 and worthy cause 120 member node—and the marketplace servers.

Each tool may be a standalone application, or the tools may be integrated into one or more consolidated applications. The message/queue manager 445, in either case, is a standalone application which automatically loads and executes as a background process whenever an advertiser, agency or worthy cause node is powered on and booted up. Data created, downloaded or used by the tools may be stored locally on the 110, 115, and 120 nodes respectively, and/or sent to the marketplace servers for storage, analyses and other marketplace-enabling purposes, as described herein. Each of the tools in the nodes 110, 115 and 120 toolset are described in detail later in this section as appropriate.

Starting with the consumer, signup requires each prospective consumer member, using their existing web browser (not shown, and hereinafter referred to as ‘pre-existing browser’), to specify their residential 5-digit zip code, gender, date of birth, and household income, into the consumer signup web page which resides on the marketplace server website. The entered zip code is validated as being an existing and currently assigned zip code using published US Postal Service data. Prospective members select their gender, date-of-birth values, and a household income range from predefined dropdown lists of valid values.

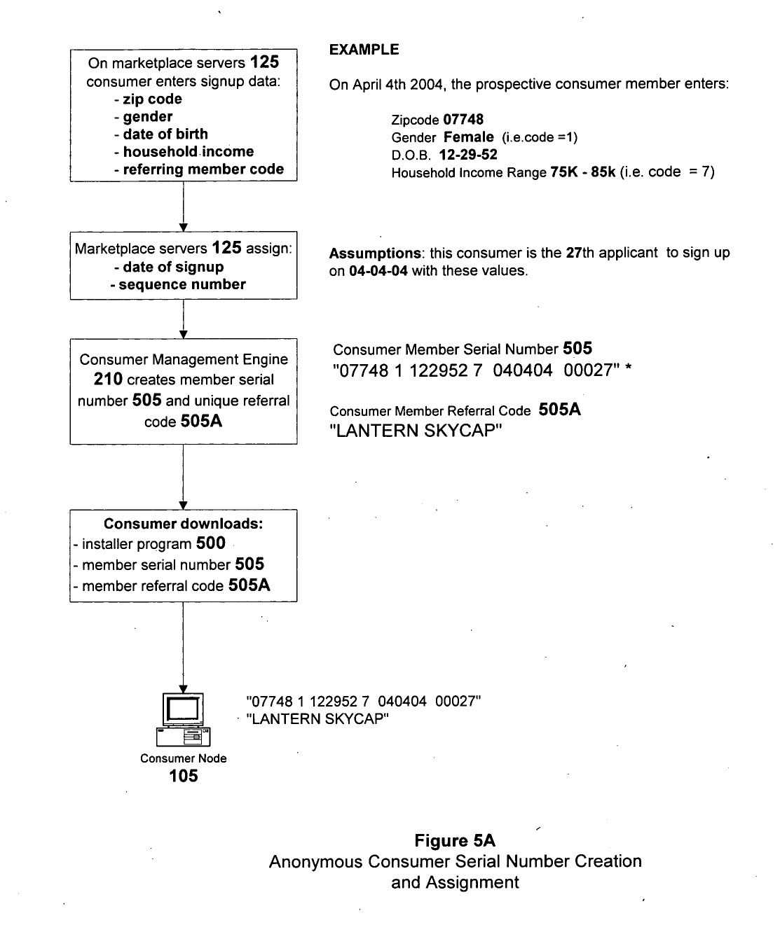

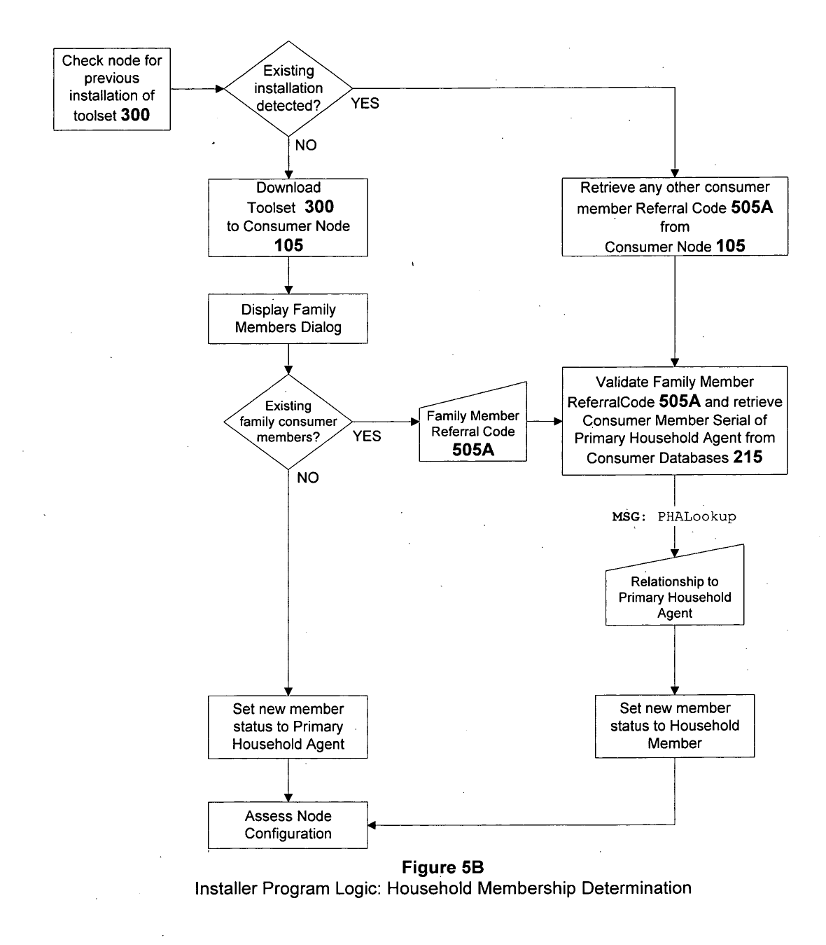

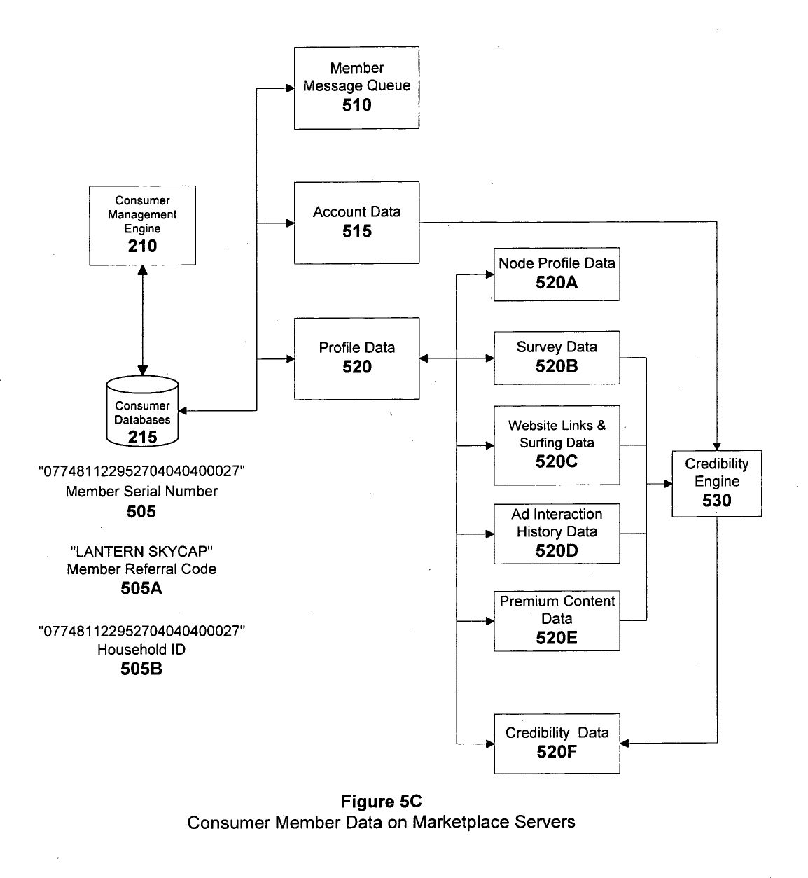

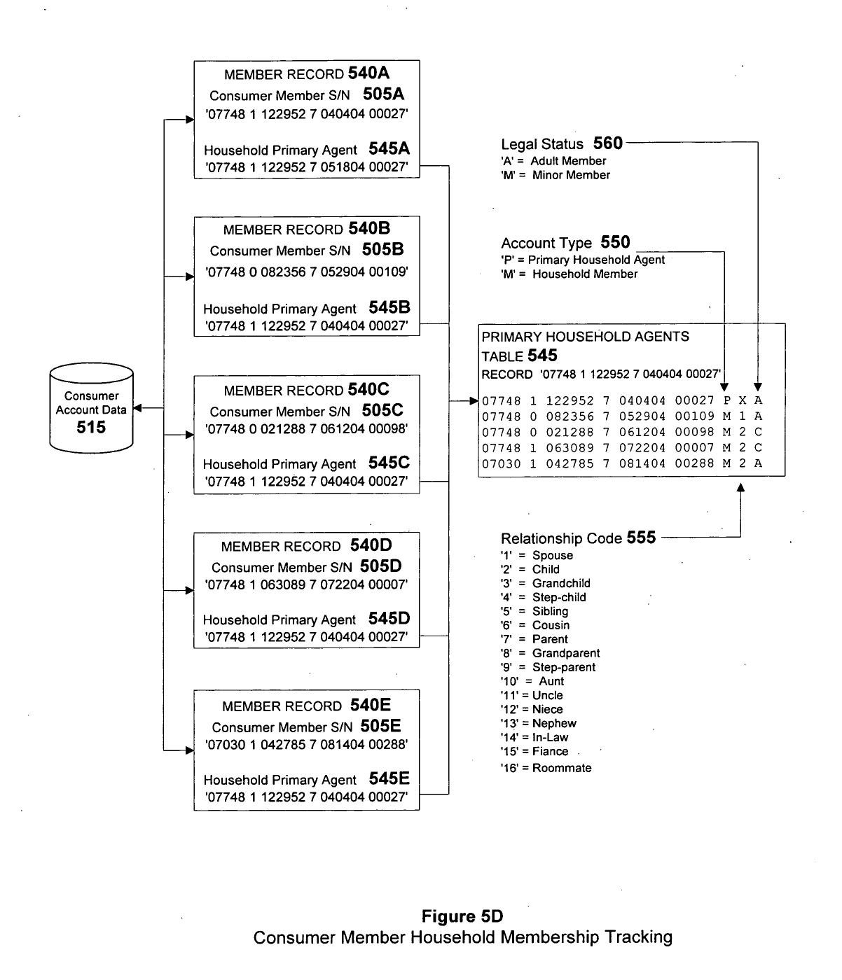

As illustrated in FIG. 5A, the user-specified zip code, a gender code, the date of birth, a household income range code, the date of signup; and a sequence number are programmatically concatenated to form the consumer's serial number 505. The sequence number is simply a running count of the number of consumers who sign up on a given day with identical zip code, gender, date of birth and income range values, and is reset to zero at the beginning of each day. In the example shown, a female consumer living in zip code 07748, born on Dec. 29, 1952 and whose household income is between $75,000 and $85,000, is the 27^{th} applicant to sign up on Apr. 4, 2004 having those four specific values. The consumer management engine 210 creates her member serial number 505 as “07748 1 122952 7 040404 00027” accordingly and assigns her the referral code 505A “LANTERN SKYCAP”, which it generates at random from a dictionary of candidate referral nouns, using techniques known to those skilled in the art.

The member serial number, which is guaranteed to be unique and encapsulates the four demographic attributes most commonly used in current database marketing practice, serves as the primary database key for each consumer's account and profile data stored on the marketplace servers. Member serial numbers are used only for internal marketplace purposes, and are not visible to any members of the marketplace. The member serial number additionally serves as a secure code which enables each consumer node to anonymously access and to participate in the marketplace.

It is noted that the serial number 505 as illustrated in FIG. 5A is for purposes of clarity and that other schemes which encode the signup data are possible which may enable more efficient primary database keys. As an example, instead of using a six character signup date, the signup date could be stored as a shorter, unsigned two-byte integer data type whose value would denote the number of days which have elapsed between member signup and the day the service became operational. As another example, the date of birth could similarly use a two-byte integer data type whose value would denote the number of days which have elapsed between a fixed date, such as Jan. 1, 1900 and the member's date of birth.

Other such encoding schemes using the embodiment described, which may enhance the performance or utility of the member serial number as a primary database key are possible, and will be apparent to those skilled in the art.

Other serial number embodiments are possible. One example would be to assign sequential serial numbers to each consumer as they complete their application for membership. This embodiment would simplify the initial creation and assignment of serial numbers to new consumer members, but lacks an important benefit of the embodiment described above. Sequential serial numbers convey no information about a consumer member other their relative order of sign up. Discovering any additional information about a consumer would require process-intensive database operations on the consumer database. In contrast, the preferred embodiment uses a serial number schema that incorporates useful consumer data and which enables highly efficient sorts of the marketplace's general consumer membership, using primary database keys alone, into smaller groups differentiated by the four most frequently used consumer-targeting attributes. Moreover, if a consumer elects to provide no additional declared data to enrich their profiles, they may still be sorted and subsequently targeted by advertisers using the four most frequently used consumer attributes. As described later in this section, the ability to rapidly reduce the marketplace's large, undifferentiated consumer membership into smaller, highly differentiated audiences is an important element of the inventions near real-time, self-service precision-targeting method.

As further illustrated in FIG. 5A, after the prospective consumer member enters the required sign up information, they request a download of the tool installer program 500. The marketplace servers respond by sending the installer program, the prospective member's serial number 505, and the prospective member's referral code 505A to the consumer node 105. As known to those skilled in the art, information contained in the HTTP Request Header (not shown) sent by web browsers to each website whose web pages they request, and which includes the browser type (Internet Explorer, Opera, Mozilla; etc.), the browser version, and the underlying platform (Windows XP, Linux, Mac OS X, etc.), enables the marketplace servers to determine which version of the installer program to download. The installer program then executes on the consumer node and performs several preliminary tasks.

First, the installer program checks the consumer node for the existence of a previous installation of the consumer toolset 300 and proceeds as illustrated in FIG. 5B:
If no previous toolset installation is detected, the installer program downloads the consumer toolset 300 and a toolset serial number (not shown) to the consumer node 105, again using information contained in the applicant's HTTP Request Header, to determine the appropriate version of the toolset to send. The toolset serial number is a unique number generated by the marketplace servers and assigned to each copy of the toolset 300, and is used in lieu of the node's IP address which may change between sessions, to identify each consumer node for purposes described in paragraph [337]. If a previous toolset installation is detected, it will be used for the prospective member and for all other consumer members using the node, and therefore no additional toolset 300 download will occur.
The installer program then ascertains whether or not the prospective member is the first member of their household to join the marketplace. The first member of each household to become a consumer member is designated as the ‘Primary Household Agent’ in the consumer databases on the marketplace servers, and as described in paragraph [136], can be discovered by knowing the consumer member serial number 505 or the referral code 505A of any other consumer member of the household.
If no previous toolset installation was found, the installer program assumes that there may still be other household members who are already consumer members, but that they are accessing the marketplace through a different consumer node. A dialog is displayed through which the prospective member indicates whether other consumer members exist in their household, and if so, to enter the referral code 505A of any one of them. If no other household members have joined the marketplace yet, the applicant is designated as the household's Primary Household Agent, with whom all future household members joining the marketplace, if any, will then be associated.
If a previous toolset installation was detected, the marketplace assumes that one or more household members are sharing the programmable electronic device, that one or more of them are existing consumer members of the marketplace, and that the programmable electronic device is already configured as an operational consumer node. Instead of soliciting the applicant for an existing household member's referral code 505A, it simply retrieves any of the existing member referral codes 505A already stored on the consumer node.
If other household members are indicated to already be members of the marketplace, as specified either by the applicant or by the detected existence of a previous toolset installation as described above, the installer program sends the specified or retrieved referral code 505A in a MSG: PHALookup message to the consumer management engine 210 which validates the referral code 505A, retrieves the member serial number 505 of the Primary Household Agent associated with the household from the consumer databases 215, and returns it to the consumer node in an MSG: PHAResponse message.

The date-of-birth and gender of the Primary Household Agent, extracted from their member serial number 505, are displayed to remind the prospective member who their Primary Household Agent is, along with a list of possible relationships which the prospective member may have with them. The table below illustrates an example of the possible household relationships so displayed:

| | |
|---|---|
| 1 | Spouse |
| 2 | Child |
| 3 | Grandchild |
| 4 | Step-child |
| 5 | Sibling |
| 6 | Cousin |
| 7 | Parent |
| 8 | Grandparent |
| 9 | Step-Parent |
| 10 | Aunt |
| 11 | Uncle |
| 12 | Niece |
| 13 | Nephew |
| 14 | In-Law |
| 15 | Fiancé |
| 16 | Roommate |

After the applicant selects the appropriate relationship they are designated as a Household Member of the Primary Household Agent's household.

Next, the installer program asks the applicant to enter the referral code 505A, if any, of an existing member through whom they learned of the marketplace. The installer program sends the entered referral code 505A in an MSG: ReferralLookUp message to the consumer management engine which validates it and returns the referring member's serial number 505 to the consumer node in a MSG: ReferralResponse message. A list of possible relationships which the prospective member may have with the referring member is then displayed as illustrated in the example table below:

| | |
|---|---|
| 1 | Spouse |
| 2 | Child |
| 3 | Grandchild |
| 4 | Step-child |
| 5 | Sibling |
| 6 | Cousin |
| 7 | Parent |
| 8 | Grandparent |
| 9 | Step-Parent |
| 10 | Aunt |
| 11 | Uncle |
| 12 | Niece |
| 13 | Nephew |
| 14 | In-Law |
| 15 | Fiancé |
| 16 | Roommate |
| 17 | Friend |
| 18 | Co-worker |
| 19 | Customer |
| 20 | Other |

After the applicant specifies the relationship type, the installer program next examines the consumer node and catalogs its configuration, including but not limited to the following:
The capacity of the mass storage device and the amount of free space available
The amount of random access memory
The video display device and associated drivers, and the node's maximum spatial and color video resolution setting
The audio device and associated drivers, and the node's highest potential audio quality setting
The node's pointing device (i.e. mouse, touch pad, etc) and associated driver
The node's microprocessor type and clock speed
The pre-existing web browser type and any pre-installed browser plug-in or helper applications for loading and viewing common web page content formats including but not limited to Adobe Acrobat, Macromedia Flash and Shockwave, Apple QuickTime, Microsoft Media Player, and other such formats
The speed of the consumer node's 105 connection to the Internet 140, and whether the connection is transient (i.e. a dial-up connection) or persistent (i.e. a network or broadband connection such as a cable modem)

The installer program then downloads and installs any required content plug-ins, saves the updated configuration data to the consumer node as its device profile, and directs the consumer to perform two setup tasks:
1. Select and enter a member ID and a password which enables their access to the toolset 300
2. Complete a simple personality temperament test

In the first setup task, the consumer may specify any ID and password they wish without concern for duplicates in the marketplace, unlike other online services which require security credentials to be unique among all service members. On AOL or MSN, for example, IDs like ‘Joe158’ or ‘Giants201’ are quite common since other users have already signed up and claimed the IDs ‘Joe’ through ‘Joe157’ and ‘Giants’ through Giants200’. When signing up for AOL or MSN, entering ‘Joe’ as a preferred ID will typically generate a message from the service to the effect of ‘That ID is taken. May we suggest Joe159? The marketplace architecture by contrast, and specifically the toolset architecture executing on the customer node 105, enables the consumer to use an ID and password which must be unique only among other consumer members using the same consumer node. Consumers use their specified ID and password to log onto their toolset, which in turn, uses their unique member serial numbers and their passwords to log onto the marketplace servers. The two-stage logon process using a local ID as described, thus enables the marketplace's general consumer membership to have any number of members using the same ID, ‘Joe’, for example, as long as they are the only such members on each consumer node using that ID.

The consumer node uses the local ID to encrypt the specified password which it then saves to the consumer node. Optionally, the consumer may also enter a pseudonym (not shown) or screen name by which other consumer members will ‘know’ them in marketplace-hosted chats, blogs, wikis, and content and product reviews, as described later in this section. The pseudonym, if entered, is also saved on the consumer node.

The second setup task requires each consumer member to complete a brief personality temperament test (not shown) which is based on the work of Karl Jung (“The Archetypes and the Collective Unconscious”), Isabel Myers and Kathryn Briggs (‘Myers-Briggs Personality Type Indicator’), and David Keirsey (“Please Understand Me”). The test presents a series of forced choice questions to new members in order to evaluate them along four psychological dimensions that collectively associate them with one of sixteen personality types, or archetypes. The four dimensions—Extraversion versus Introversion, Sensory versus Intuitive, Thinking versus Feeling, and Judging versus Perceiving, are elements of the consumer member's temperament and have high predictive value in determining the type and style of content, including advertising content, to which they may be most responsive. Based on their scores across the four dimensions, each consumer member is assigned one of the following sixteen archetypes:

| | |
|---|---|
| 1 | ESTP Artisan: Promoter |
| 2 | ISTP Artisan: Crafter |
| 3 | ESFP Artisan: Performer |
| 4 | ISFP Artisan: Composer |
| 5 | ENFJ Idealist: Teacher |
| 6 | INFJ Idealist: |
| | Counselor |
| 7 | ENFP Idealist: Champion |
| 8 | INFP Idealist: Healer |
| 9 | ESTJ Guardian: Supervisor |
| 10 | ISTJ Guardian: Inspector |
| 11 | ESFJ Guardian: Provider |
| 12 | ISFJ Guardian: Protector |
| 13 | ENTJ Rational: Fieldmarshal |
| 14 | INTJ Rational: Mastermind |
| 15 | ENTP Rational: Inventor |
| 16 | INTP Rational: Architect |

These archetypes and their designations are known in the behavioral sciences, and are utilized in the embodiment as a key psychographic data point in the identification of member style, preferences, and potential affinity for specific targeted informational, entertainment and commercial content. When the consumer completes the personality test, their temperament is evaluated and they are assigned the corresponding archetype, which is then stored on the consumer node 105.

Other embodiments, based on alternative or supplemental personality and temperament assessment tools, are possible and will be apparent to those skilled in the art. The personality temperament test, as described above, offers the advantage of simplicity—a considerable amount of information regarding the styles, preferences, and propensities of consumers and how they prefer to interact with other people, objects, tasks and information can be abstracted and subsequently inferred from a single value—from one to sixteen—each representing one of the archetypes. An additional advantage using this method is the ability to segregate and exploit one or more of the four dimensions within the archetype for the purposes of enabling more flexible consumer targeting. As an example, all consumers having an archetype designation that includes ‘I’ (‘Crafter’, Composer’, ‘Counselor’, ‘Healer’, ‘Inspector’, ‘Protector’, ‘Mastermind’, and ‘Architect’) can be easily segregated to identify an audience of introverts. As another example, all consumers having designations that include ‘NT’ (‘Fieldmarshal’, ‘Mastermind’, ‘Inventor’, and ‘Architect’) can be easily segregated to identify an audience of rationals. A significant body of relevant literature, known to those skilled in the art, offers sufficient and credible analyses of personality archetypes and enables advertisers to effectively exploit personality temperament in the design of their advertising strategies and campaigns to better engage those consumer audiences targeted accordingly.

On completion of the setup tasks described above, the installer program petitions the consumer management engine on the marketplace servers to create an account in the consumer databases for the applicant, who will hereinafter be recognized as a consumer member of the marketplace. In a MSG: ConsumerInitialize message, the installer program sends the data accumulated during the sign-up and setup processes to the consumer management engine 210, which then creates the new consumer member account, and initializes their profile data records. Data sent, includes but is not limited to the following:
Member serial number 505
Member referral code 505A
Member designation (i.e. Primary Household Agent or Family Member)
Primary Household Agent serial number
Relationship-to-Primary Household Agent code
Referring member's referral code
Relationship to referring member code
Consumer member password
Consumer member pseudonym (if entered)
Consumer node configuration data
Personality temperament archetype
Toolset serial number

As illustrated in FIG. 5C, the consumer management engine 210 creates entries on the consumer databases 215 for each new consumer member which include a member message queue 510, account data 515, and profile data 520 which includes node profile data 520A, survey data 520B, website links & surfing data 520C, ad interaction history data 520D, premium content data 520E, and member credibility data 520F. The member message queue 510 holds a list of all messages posted by various engines executing on the marketplace servers which are addressed to the consumer member's node. Each time a consumer member logs on to the marketplace, and at scheduled intervals while their node is online, the message/queue manager 350, as shown in FIG. 3, sends a MSG: QueueQuery message to the marketplace servers to check for such messages. The marketplace servers return a list of message IDs in a MSG: QueueStatus message to the consumer node for processing. The credibility engine 530 uses the collective profile data 520B through 520E and account data 515 of all consumer members of the marketplace to statistically derive baseline averages for various aspects of consumer member behavior in the marketplace, from which the credibility data 520F of each consumer member, in turn, is derived, as described in paragraph [335].

FIG. 5D illustrates an example of how consumer members associated with the same household are tracked by the consumer management engine on the consumer account database 515. The five consumer members 540A through 540E as shown each have a unique consumer member serial number 505A through 505E respectively, and each shares the same primary household agent serial number 545A through 545E respectively. The serial number for the primary household agent serves as an index to an entry in the primary household agents table 545 which, in turn, lists the serial numbers of all consumer members associated with their household. In the example shown, the primary household agent is a female adult with a male spouse and three children—two who are minors and living at home, and one an adult who has registered with a different zip code, possibly living away at college.

Each household member listed in table 545 includes their demographically descriptive serial number 505, their account type 550—primary household agent or household member, their relationship 555 to the primary household agent, their legal status 560—a minor or adult, as determined by the date of birth specified during signup, their unique referral code (not shown), and the serial number of the toolset they have been assigned (not shown). The member serial number, referral code, or toolset serial number of any consumer member can thus retrieve all consumer members who are also members of their household, using the primary household agent serial number as an index. Further, using data retrieved from table 545 and using techniques known to those skilled in the art, the serial number, referral code, or toolset serial number of any consumer member can be used to reconstruct their household and its marketplace membership, including the relationships among its members, and the respective age, gender and zip code of each of its members. Thus the method illustrated in FIG. 5D enables the clustering of anonymous consumer members into equally anonymous households.

Finally, the installer program creates the file structures on the consumer node in which a copy of all data related to the applicant's membership and their participation in the marketplace will be stored, and then initializes the consumer toolset.

Hereinafter, the marketplace server 125 will know each consumer's identification solely as a consumer member serial number 505 or referral code 505A, and its association with the serial number of the toolset 300 installed on their node 105. As described above, more than one consumer member may be associated with each consumer node, each such member having a unique member serial number 505, a unique referral code 505A, and shared primary household agent and toolset serial number.

At the conclusion of the signup, installation, and setup processes, each consumer member will be represented on the consumer database 215 under a unique consumer member serial number 505 which directly specifies or otherwise references:
The member's residential zip code, gender, date-of-birth, household income range and date of signup
The member's referral code
the member's node hardware and software configuration
the serial number of the toolset 300 to which they are assigned
other consumer members within their household and the relationships among those members
the member's personality temperament
The referral code of the member through whom they learned of the marketplace

It will be apparent to those skilled in the art that, provided the proper tools, advertiser, ad agency, and worthy cause members can access the above data to achieve a degree of intimacy with each consumer member, though each consumer's actual identity is unknown. Further, the consumer management engine 210, using common database techniques and methods known to those skilled in the art, can efficiently sort and selectively segregate the marketplace's general consumer membership into smaller groups of well-defined audiences by their zip code, gender, date-of-birth, household income, household membership and family composition, node configuration, and personality temperament, or by any combination thereof, for the purposes of precisely targeting ad campaigns and other content by such interested parties.

It will also be apparent to those skilled in the art that provided the proper tools and permissions, third-party content providers can access select data points directly from the profile data stored on the nodes of consumer members who visit their websites. The method by which third-party content providers can have intimate knowledge of anonymous consumers is described in paragraph [210].

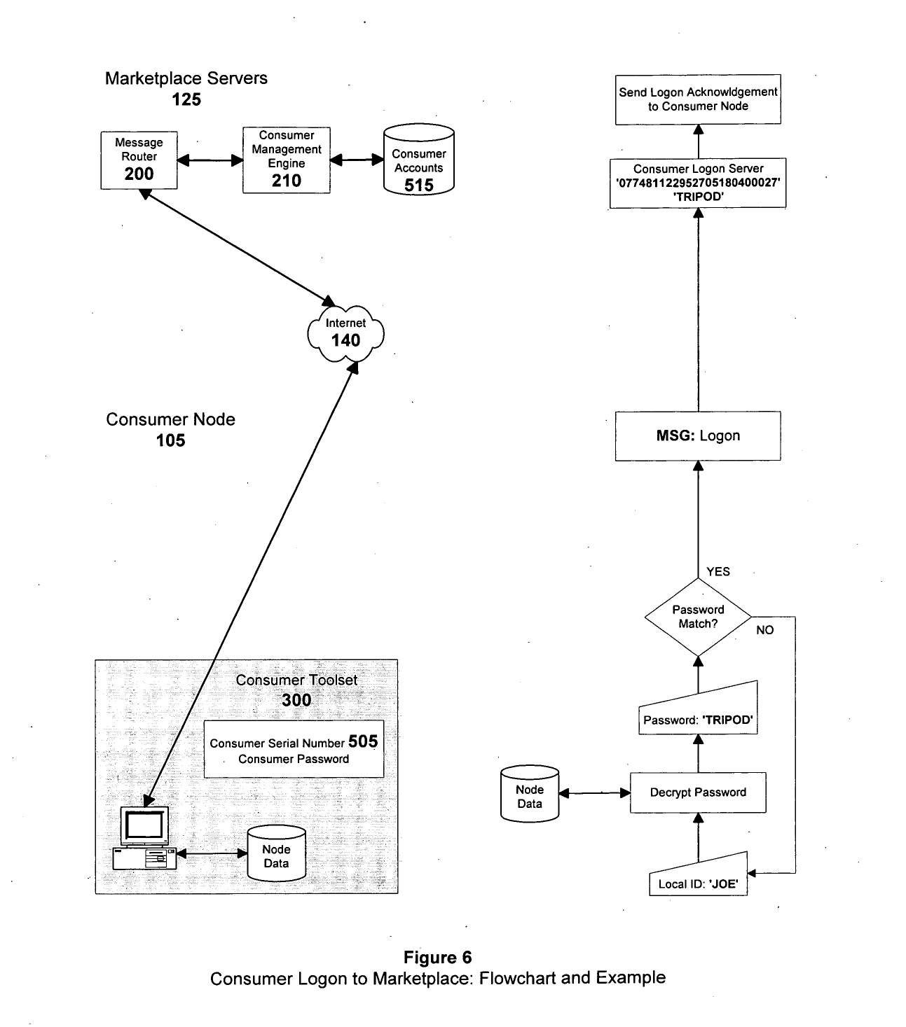

As illustrated in FIG. 6, the consumer logs on to their toolset 300 by entering their local ID and password. The local ID is used to decrypt and recover the stored and encrypted password which the toolset then uses to validate the password just entered. If the two passwords match, the consumer member's serial number 505 and password are sent in a MSG: Logon message to the marketplace servers 125 where the message router 200 directs it to the consumer management engine 210 for validation. If the node serial number 505 and password submitted by the node 105 correspond to an existing record on the consumer accounts database 515, the member's status on the table is set to ‘CONNECTED’ (not shown) and the consumer node receives an acknowledging MSG: Connected message from the marketplace servers. Although not shown, each MSG: Logon message also directs the consumer management engine 210 check the legal status 560 of the member, and if their status is ‘Minor Member’, to use the current date and the date-of-birth encoded with the consumer member serial number to recalculate the member's current age and adjust their legal status 560 if they have reached the age of majority.

The MSG: Connected message contains several session-specific data elements, including but not limited to:
The number of messages in the consumer member's message queue 510
A list of the message IDs in the consumer member's message queue 510 as enumerated above
The date and time as maintained by the marketplace, which is used to synchronize time-sensitive events among the marketplace servers and the nodes of all members

After logging on, a logical link exists between specific consumer member records on the consumer databases 215 and the corresponding anonymous consumer member associated with a unique member serial number residing on some consumer node 105. Over time, as the toolset 300 continues to gather, analyze and submit additional member-declared demographic and psychographic data, and observed and derived data to the marketplace servers, the marketplace acquires a growing encyclopedia of rich and precisely articulated data about a consumer whose actual identity remains unknown within the marketplace.

The first time a new consumer member logs onto the marketplace, the custom browser accesses their pre-existing collection of favorite links, (also referred to hereinafter as ‘bookmarks’ or ‘links’) and allows the consumer to selectively import them into the custom browser. The custom browser provides a superset of the standard functionality found in commonly used web browsers such as Microsoft Internet Explorer, Opera, or Mozilla FireFox, and is intended to replace the consumer's pre-existing browser as the default browser application for each member's future interaction with the World Wide Web. As described previously, if implemented as a browser tool bar installed into the consumer's pre-existing web browser, the supplemental functionality of the consumer toolset enables the consumer's pre-existing web browser to remain their default web browser as the functional equivalent of the custom browser.

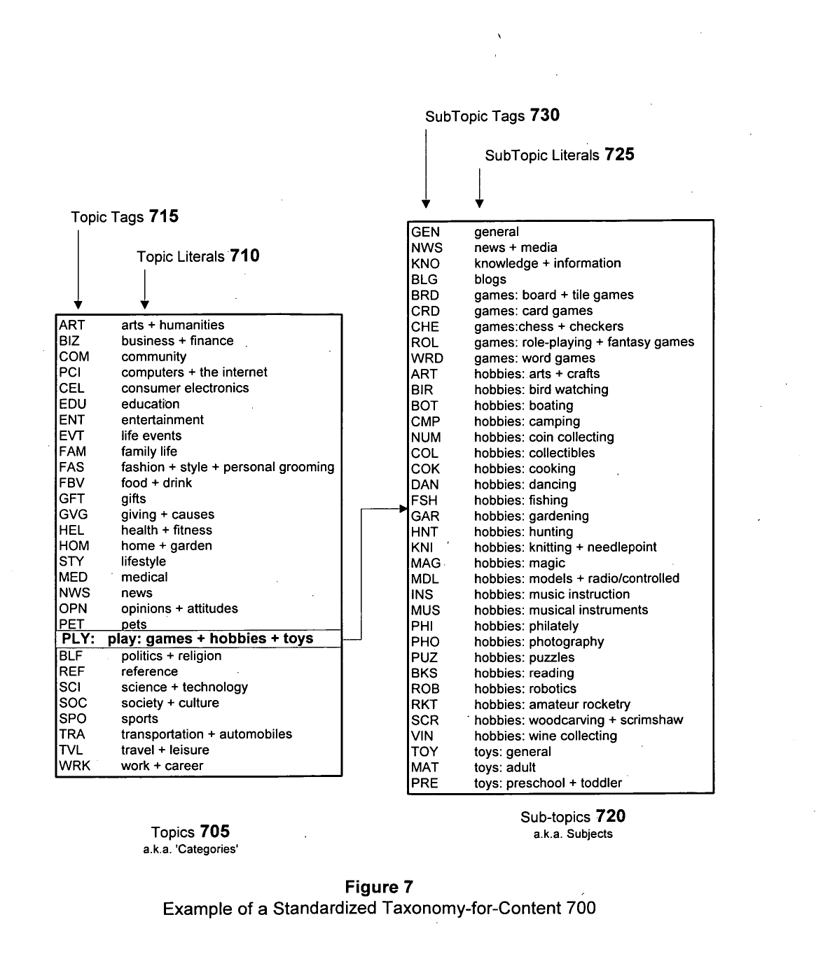

Incorporated into the custom browser is the marketplace's predefined taxonomy-for-content 700 which is organized as a hierarchy of topics (also referred to hereinafter as ‘Categories’) and subtopics (also referred to hereinafter as ‘Subjects’) an example of which is illustrated in FIG. 7. Each topic 705 has an associated description or literal 710, an associated code or tag 715, and a list of associated subtopics 720, each of which also has associated literals 725 and tags 730. Tags are visible only to the consumer tools, to the marketplace servers, and to developers of third-party content provider 130a and 130b websites, and are not seen by members. The taxonomy shown lists example topics, and a set of example subtopics that might be associated with the topic “PLY: play: games+hobbies+toys”. It is noted that the taxonomy-for-content shown in FIG. 7 is for illustrative purposes only and other structures and compositions are possible. The actual taxonomy used by the marketplace is important only in that it provides a hierarchy and organization that is both comprehensive and familiar to its members, and as such, can be based on the hierarchies and organizations used by popular portals—such as Yahoo and MSN—to organize their content.

The marketplace's taxonomy-for-content is used in the custom browser's ‘Links’ function, which replaces the ‘favorites’ or ‘bookmarks’ function along with any user-defined favorites organization in the consumer's pre-existing browser (see ‘Description of the Prior Art: Content Display and Interaction’). To import a pre-existing link, the consumer selects the “Links: Add Link” function, specifies ‘Import’, and then selects the link from a list which the custom browser populates with their pre-existing browser's bookmark entries. The custom browser attempts to load and display the selected link for several purposes:
To verify that the address associated with the selected link is still valid and that the website which it references is still active, to prevent the consumer from importing and subsequently saving or sharing, a dead link. The method of identifying dead links through the interpretation of return codes issued by the Internet to web browsers failing to access a website is known to those skilled in the art.
To normalize the link address, whereby any valid URL which can successfully load the referenced website also retrieves the full URL address associated with the selected link. Normalized URLs are used in the link sharing method described below, to promote URL consistency, standardization and integrity. As an example, if a favorite link was saved for Google.com using an address of ‘gOoGLe.cOM’, it will still successfully load Google's home page and, in the process, retrieve the normalized URL ‘http://www.google.com/’ from Google's website.
To force the referenced website to generate a cookie—if needed, or to access a cookie from local storage, if any, which may have been generated by a previous visit to the referenced website, and which enables the custom browser to identify an imported link's associated cookie file, if any.

The consumer then enters a title for the link, and assigns the link to one of the taxonomy's standard topics from a pre-populated list, and then to a subtopic from a second list which the custom browser populates with valid taxonomy subtopics for the topic assigned. The consumer then specifies a number of link-specific parameters which enables the marketplace to share the link with other consumer members, including but not limited to:
Comments: free-form text field through which the consumer member may enter an opinion or review of the website
Link content type: selected by the consumer from a list of pre-defined choices, for example, ‘INFORMATIONAL’, ‘ENTERTAINMENT’, ‘SHOPPING’, or ‘SOCIAL’ which characterizes the typical intent or use by visitors to the website
Geographical scope: selected by the consumer from a list of pre-defined choices, for example, ‘LOCAL’, ‘REGIONAL’, ‘NATIONAL’, or ‘GLOBAL’, which indicates the relevance of the link to other consumer members based on their own respective residential zip codes. For example, if the link is for the website of a small retail business which conducts its trade solely through a single physical storefront, then the consumer would specify a scope of ‘LOCAL’ or ‘REGIONAL’—the business would be of interest only to other consumer members living within a reasonable driving distance to the store. As another example, if that same small business website was ecommerce-enabled, then the consumer member would specify a scope of ‘NATIONAL’ or ‘GLOBAL’—other consumer members can ‘visit’ and conduct business with the store over the Internet, regardless of their own physical location.
Keywords: a free-form text field into which the consumer member may enter one or more words or phrases which they, or other interested consumer members, can subsequently use in a search query to retrieve the link
Level: where appropriate, selected by the consumer from a list of pre-defined choices, for example, ‘BEGINNER’, ‘INTERMEDIATE’, or ‘ADVANCED’, which indicates a degree of sophistication or complexity of the link's treatment of its subject matter
Link sharing: selected by the consumer from the choices ‘TRUE’ or ‘FALSE’, which indicates either their willingness to publish the link into the marketplace and share it with other consumer members, or their desire to keep the link private and not share it

The consumer member then selects the “Links: Save Link” action, and the new link is added to the member's custom browser favorites list where it will subsequently appear in a hierarchical list under the category and subject assigned. A copy of the link data, along with the consumer member's serial number and personality archetype, is sent to the Consumer Management Engine residing on the marketplace servers where it will be posted to the consumer member's favorite links data, and if they agree to share the link, to the content databases.

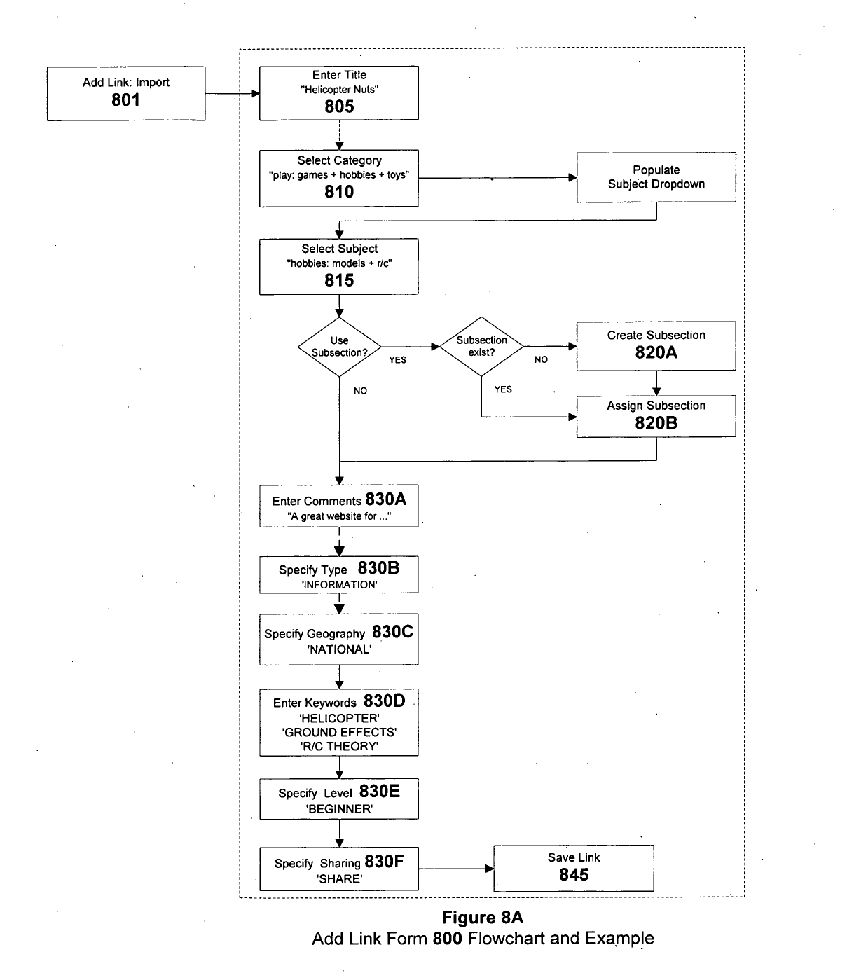

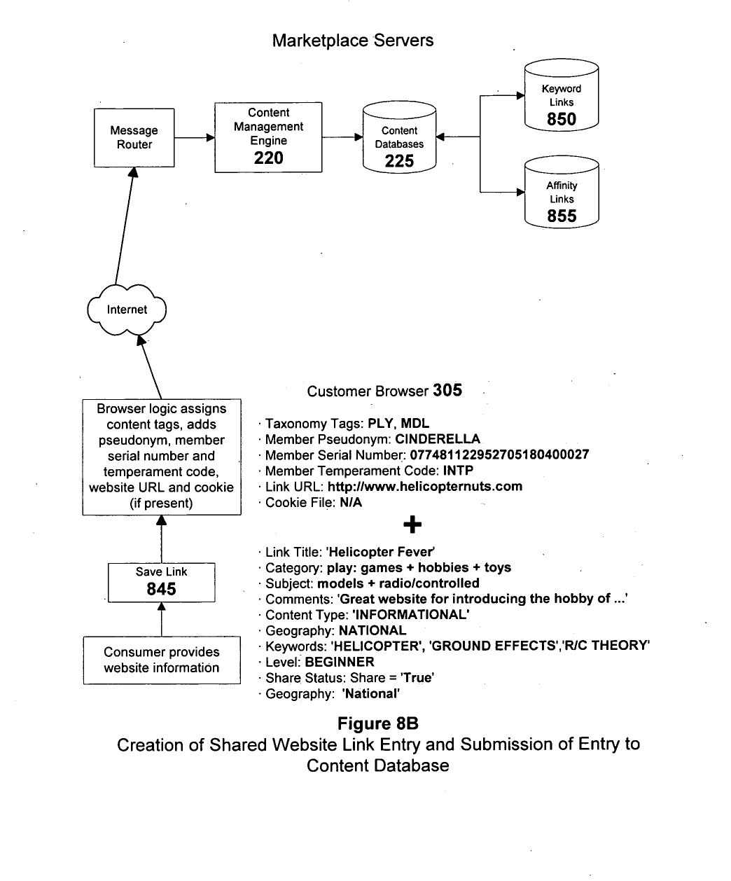

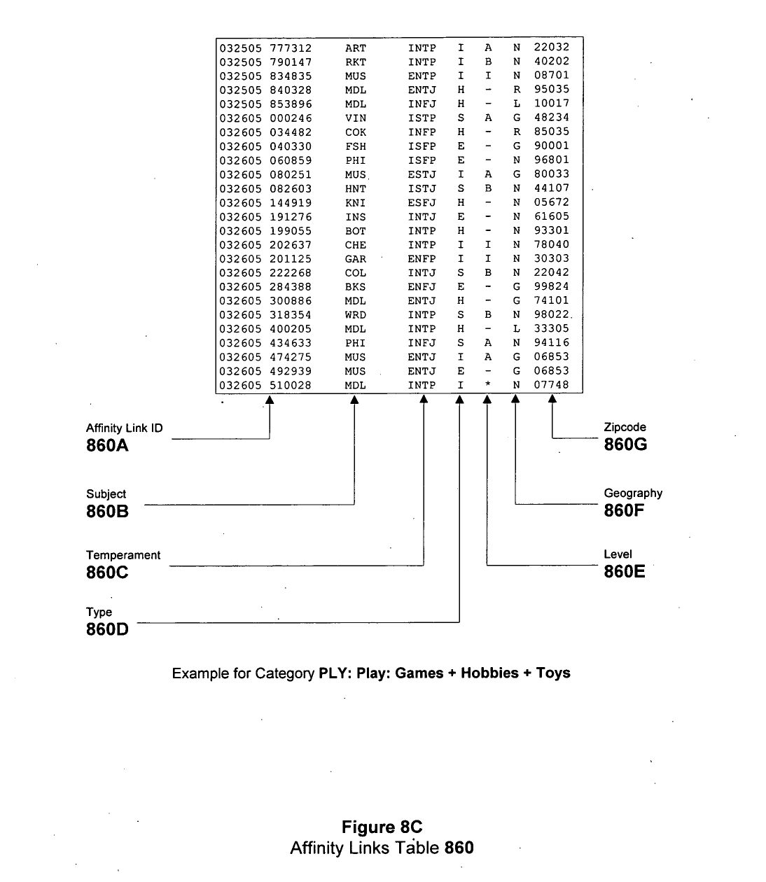

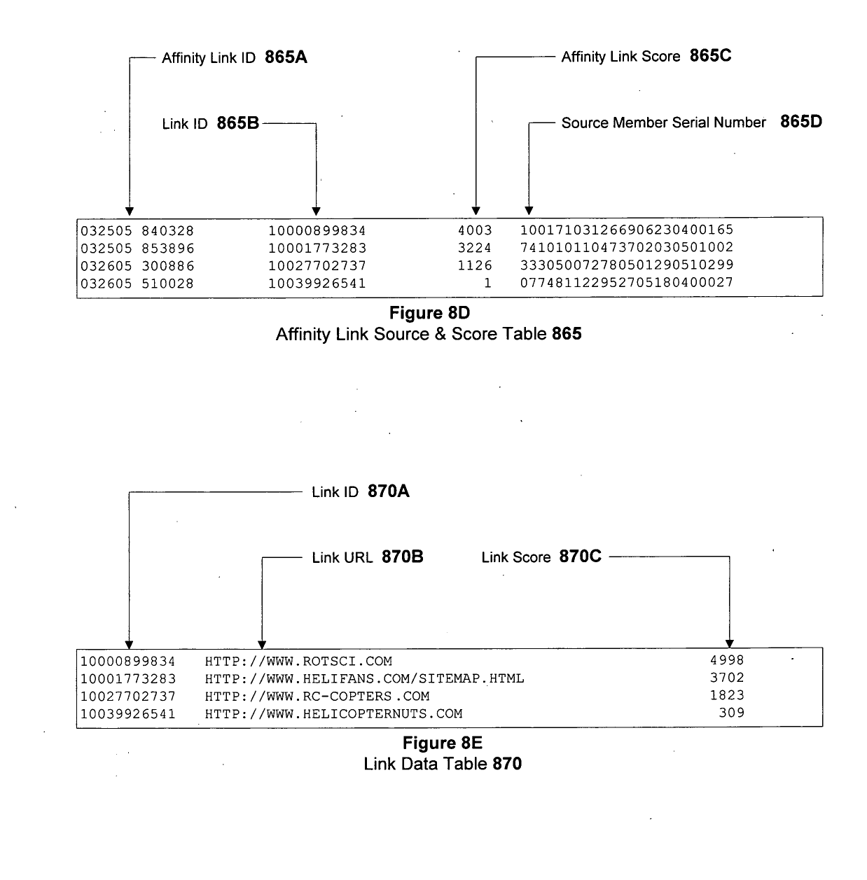

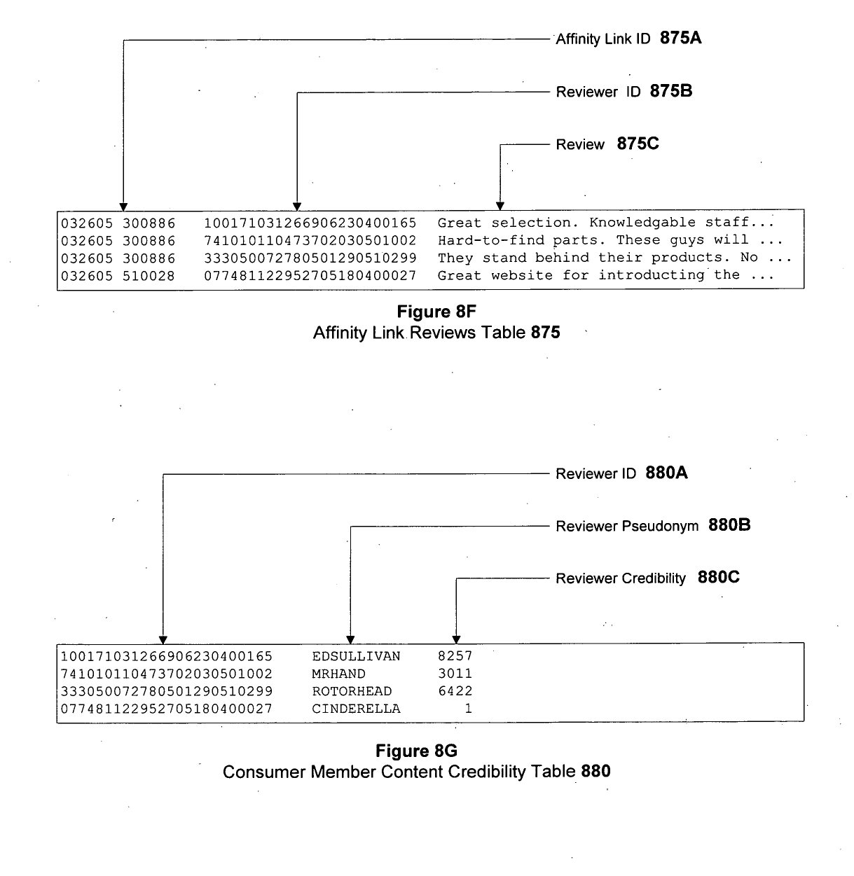

A flowchart and example of the link sharing process is illustrated in FIG. 8A, FIG. 8B and FIG. 8C as follows:
Through a niche magazine for radio-controlled models, a consumer member using the pseudonym ‘Cinderella’, had previously discovered ‘www.helicopternuts.com’, a website which caters to her passion for R/C helicopters, and had saved the link to it using her pre-existing browser's favorites function. As illustrated in FIG. 8A, using her custom browser's “Links: Add Link: Import” function 801, she has selected the above cited website to import. Her custom browser attempts to load the website, and if successful, displays the add link form 800 for her to complete. She enters a descriptive title for the link in the title field 805 and files the link under the category ‘play: games+hobbies+toys’ and subject ‘hobbies: models+r/c’ using the category 810 and subject 815 dropdowns lists respectively. She then enters her comments 830A, the link content type 830B, the geographical scope 830C, link keywords 830D, level 830E, and link sharing choice 830F, and then selects the “Links: Save Link’ action, 845.

Duplicate websites link addresses are detected, using methods known to those skilled in the art, and their subsequent addition is prevented whenever the consumer attempts to add them a second time using the same category and subject tags. Using the example above, if ‘Cindarella’ tried to save ‘www.helicopternuts.com’ under the category 810 ‘play: games+hobbies+toys’ and subject 815 ‘hobbies: models+r/c’ a second time, the custom browser would reject it. Any website link may, however, be saved under more than one distinct category and subject pair.

The link keywords 830D are written to the consumer node, each such keyword or key phrase saved as a separate datastore entry and containing a copy of the link name and URL. Using the example illustrated in FIG. 8B, when ‘Cindarella’ completes the link import process, three separate entries will be saved to her local node, one for each of the keywords 830D she entered for the link.

As further illustrated in FIG. 8A, if the consumer wishes to create a deeper hierarchy in which to save their favorite links, they could create a sub-section 820A using a title of their choice and then assign 820B the link to it. The sub-section is then created under the selected category and subject, where the link will then be filed. If the consumer has already created a sub-section appropriate for this link, they may assign the link directly to the sub-section 820B from a drop-down list containing sub-sections they have previously created for this category and subject.

If the consumer member agrees to share the link with other consumer members, several additional processes are triggered. FIG. 8B illustrates the shared website link data which is assembled by the custom browser 305 and submitted to the content management engine 220 when the consumer selects the save link action 845. The website link information supplied by the consumer, specific member information retrieved from the consumer's node, and the website URL and cookie file—if any, and obtained from the custom browser itself, are all encapsulated into a MSG: LinkPost message and sent to the marketplace servers where it is routed to the content management engine 220 for processing. Any sub-section organization 820 authored by individual consumers remains local to their node 105 and is not sent to the marketplace servers since each consumer's specific sub-organization hierarchy and nomenclature are unique to them and cannot be normalized into the service's standard content taxonomy.

If the content management engine 220 determines that the submitted link is unique, namely, that it is the first such submission for the specific combination of website URL, and affinity attributes—taxonomy topic and subtopic pair, member temperament, link type, and link level—it processes the submission as a new entry, as described below. Conversely, if the content management engine detects a prior entry having the same website URL and affinity attributes, it processes the submission as a vote, as described in paragraph [177]. All shared links, both new links and vote links, are posted to the keyword links 850 and affinity links 855 databases. Identification of matching prior entries is performed using database methods and techniques known to those skilled in the art.

FIG. 8C illustrates the structure of an affinity links table 860 in the affinity links databases to which new entries are posted, and some example affinity link records. Each affinity link record contains an affinity link ID which servers as the index to a website link favored by an affinity group, whom the marketplace defines as one or more consumer members who share one or more specific attributes. A separate affinity link table 860 exists for each of the marketplace's content taxonomy topics—in the example shown, the ‘PLY: Play: Games+Hobbies+Toys’ (“affinity_links_PLY”) topic. For each new link submitted, the content management engine creates a record in its associated topic affinity links table, each such record including the following fields:

| | |
|---|---|
| Affinity Link ID 860A | Generated by the content management engine. In the |
| | example shown, the affinity link ID is comprised of the link's |
| | creation date (i.e. Mar. 25, 2005) which enables subsequent record |
| | sorting by the age of affinity links, and a sequence number - a |
| | running count of the number of links submitted on a given |
| | day which is reset to zero at the beginning of each day, and |
| | which guarantees the uniqueness of each affinity link ID. |
| Link Subject 860B | the subtopic taxonomy tag extracted from the MSG: |
| | LinkPost message as specified by the submitting consumer |
| Member Temperament 860C | extracted from the MSG: LinkPost message, as retrieved |
| | from the consumer node by the custom browser |
| Link Type 860D | extracted from the MSG: LinkPost message as specified by |
| | the submitting consumer (in the example shown, ‘I’ = Information, |
| | ‘H’ = Shopping, ‘S’ = Social such as a blog or |
| | chat-oriented website, ‘E’ = Entertainment) |
| Link Level 860E | extracted from the MSG: LinkPost message as specified by |
| | the submitting consumer (in the example shown, ‘B’ = Beginner, |
| | ‘I’ = Intermediate, ‘A’ = Advanced, ‘*’ = All |
| | levels, ‘—’ = Not Applicable) |
| Geography 860F | extracted from the MSG: LinkPost message as specified by |
| | the submitting consumer (in the example, ‘L’ = Local, ‘R’ = Regional, |
| | ‘N’ = National, ‘G’ = Global) |
| Zip code 860G | extracted from the member serial number of the submitting |
| | consumer contained in the MSG: LinkPost message |

It will be apparent to those skilled in the art, that for any valid set of values for affinity fields 860B through 860F, a simple database query will create a result set containing only those records from the table 860 whose affinity link IDs 860A have matching values for those fields. In the Structured Query Language (SQL) example below, a result set is created which contains only those affinity link IDs for the subject ‘models+radio controlled’ which have been submitted by consumers having a temperament of ‘architect’, are information oriented, have geography-independent relevance, and provide an advanced treatment of the subject matter:

SELECT affinity_link_id
FROM affinity_links_PLY
WHERE link_subject = “MDL”
AND link_temperament = “INTP”
AND link_type = “I”
AND link_level = “A”

One skilled in the art will also appreciate that queries on table 860 can define affinity groups which vary in focus and which create different result sets accordingly. As an example, the query:

SELECT affinity_link_id
FROM affinity_links_PLY
WHERE link_subject = “*”
AND link_temperament = “I***”
AND link_type = “*”
AND link_level = “B”

where ‘*’ is a wildcard or ‘don't care’ value, will create a result set containing the affinity link IDs of links to all websites with informational, entertainment, shopping or social oriented content, at a beginner level of subject treatment, for all subjects under the ‘Play: Games+Hobbies+Toys’ category, having geography-independent relevance, which have been submitted by members having an introverted temperament. The ability to vary the focus of queries against the affinity links tables 860, and its corresponding impact on the focus of the affinity groups thus defined and the result sets created thereby, enables the method of variable focus content sharing among consumer members, described in detail in paragraph [180].

The affinity dimensions 860B through 860F shown—subject, temperament, link type, link level and geography, respectively—are for illustrative purposes only. Different or additional demographic and/or psychographic dimensions may be incorporated into the affinity link schema using the same methods described above.

The content management engine, using other data elements contained in the MSG: LinkPost message described above creates related link submission records in the affinity links databases 855 as illustrated in FIG. 8D through 8G.

FIG. 8D illustrates the affinity link source and score table 865 and example entries. For each entry in the affinity links table 860, a unique record is created in table 865 which includes the following fields:

| | |
|---|---|
| Affinity Link ID 865A | The table's primary key which associates each |
| | record with a unique and corresponding record |
| | in the affinity links tables 860 |
| Link ID 865B | The index to a corresponding record in the link |
| | data table 870 described below |
| Affinity Link Score 865C | The score for the website link as determined by |
| | its popularity among members of a specific |
| | affinity group |
| Source Member Serial | The member serial number of the first |
| Number 865D | consumer to submit the link to the defined |
| | affinity group |

It will be apparent to those skilled in the art that the affinity link IDs 860A contained in the result set created by a SQL query as illustrated above can be used in a subsequent SQL query against table 865 to create a result set of corresponding affinity link source and score records, each of which includes a link ID 865B, an affinity link score 865C, and the serial number 865D of the consumer member who first submitted the link.

FIG. 8E illustrates the link data table 870 which holds the actual URL of each submitted link, and example entries. Fields include:

| | |
|---|---|
| Link ID 870A | Generated by the content management engine for each |
| | unique link |
| Link URL 870 B | The Link URL as specified in the MSG: Linkpost |
| | message, or as described below, a substitute URL |
| | or ‘DEADLINK’ value |
| Link Score 870C | The score for the website link as determined by |
| | its collective popularity among all consumer |
| | members. The link score is calculated from the scores |
| | of all affinity link IDs which reference the link |
| | ID 870A |

It will be apparent to those skilled in the art that the link IDs 865B contained in the result set created by a SQL query against table 865 can be used in a subsequent SQL query of table 870 to create a result set of corresponding link URLs and link score records.

It is noted that more than one affinity link record in the affinity links table 860 may have the same link ID 870A. As an example, using the radio-controlled helicopter link example illustrated in FIG. 8B, the link might be submitted by one consumer as described in the example, and by another consumer using a different set of affinity attributes—for example, by using a link level of ‘Intermediate’, or even by submitting the link using a different subject such as ‘MAT: Toys: Adult’. Each submitted link would have a different affinity link ID 860A (and therefore corresponding affinity link IDs in table 865), but both links would have identical link IDs 865B and 870A in tables 865 and 870 respectively. Mapping multiple affinity link IDs 865A to the same website link ID 870A enables two types of scores to be maintained for each website—scores which reflect its popularity among each specific affinity group, and scores which reflect its overall popularity among all consumer members of the marketplace. The strategy of mapping multiple affinity link IDs to one link ID additionally simplifies link maintenance. If the link's URL changes, the content management engine must only update it once in the link ID table—all affinity link IDs which reference the link ID 870B are effectively updated as well. If the website to which the link URL 870B points should shut down, updating the link URL 870B to ‘DEADLINK’ enables the content management engine to exclude the associated affinity link ID 860A from the result set of any query.

FIG. 8F illustrates the affinity link reviews table 875 and example entries. For each affinity link ID 860A in table 860, this table contains one or more records, each containing the comments submitted by consumers in their respective MSG: LinkPost messages. Each entry contains the following fields:

| | |
|---|---|
| Affinity Link | The table's primary key, set by the |
| ID 875A | content management engine to same value as the |
| | affinity link ID 860A in table 860 |
| Reviewer | The serial number of any consumer member |
| ID 875B | who submits a review for the link specified by the |
| | affinity link ID 875A, as contained in the MSG: |
| | LinkPost message of the link submitter |
| Review 875C | The comments submitted by the consumer |
| | member specified by reviewer ID 875B as contained |
| | in the MSG: LinkPost message of the link submitter |

It will be apparent to those skilled in the art that the affinity link IDs 860A contained in the result set created by a SQL query against table 860 can be used in a subsequent SQL query of table 875 to create a result set of one or more affinity link review records, each containing the member serial number of the consumer submitting the link 875B, and their respective comments 875C.

FIG. 8G illustrates the consumer member content credibility table 880 and example entries. For each consumer member submitting links to the marketplace, a credibility score is maintained which reflects the popularity of all links they submit, and thus of their credibility to accurately review their submitted links. Each entry contains the following fields:

| | |
|---|---|
| Reviewer ID 880A | The table's primary key, set by the |
| | content management engine to the consumer |
| | member serial number contained in the MSG: |
| | LinkPost message of the link submitter |
| Reviewer | Set by the content management |
| Pseudonym 880B | engine to the consumer member pseudonym |
| | contained in the MSG: LinkPost message of the |
| | link submitter |
| Reviewer | Calculated by the content management engine |
| Credibility 880C | as the total of the affinity link scores 865C |
| | of all links for which the reviewer specified by |
| | reviewer ID 880A, was the first consumer to |
| | submit |

It will be apparent to those skilled in the art that that for each reviewer ID 875B contained in the result set created by a SQL query against table 875 can be used in a subsequent SQL query of table 880 to create a result set which contains exactly one record which specifies the reviewer's pseudonym 880B, and their credibility score 88C.

After posting a submitted link to the affinity links tables 860, the content management engine posts the associated keywords 830D data from the MSG: LinkPost message to the keyword links database 850, as illustrated in FIG. 8B. Each keyword or phrase submitted within the message by the consumer is used as a primary key to records in the keyword tables (not shown) within the keywords database. For each keyword or phrase submitted, the content management engine searches the keyword tables to determine whether it already exists in the table.

If no previous key is found which matches the keyword or phrase, the content management engine creates a new record using the keyword or phrase as the record's primary key, then adds the affinity link ID 860A assigned by the content management engine when the link was posted to the affinity links table 860 as previously described, to the record.

If a matching primary key already exists, as created by a previous keyword posting, the new affinity link ID 860A is added to the keyword record's existing list of affinity link IDs 860A. As the content keyword database becomes populated over time, it grows into an increasingly rich dictionary of keywords words and phrases through which appropriately structured queries can return result sets of affinity link IDs 860A to relevant web links.

Each link thus submitted by consumer members is also posted to the favorite links data 520C as part of their profile data 520 within the consumer databases 215 as originally illustrated in FIG. 5C, thus registering the new link under the submitting member's serial number. A copy of the cookie associated with the link, if present in the MSG: LinkPost message is also posted to the member's record. Every link imported or subsequently added to a consumer member favorites list on their node will thus have a corresponding entry in the member favorites table 520C. Each consumer member's favorite links data, in conjunction with other profile data stored about them on the marketplace servers, is used to:
enable preference-based (affinity group) content targeting
validate user-declared data about interests and gather additional data points about consumer member preferences
facilitate precision-targeting of ad campaigns to consumer members by advertisers
backup consumer member data in the event of a failure or replacement of their node 105, or to repair their node data should it become corrupted

As consumers discover other websites over time which they wish to bookmark, they may use the use their custom browsers “Links: Add Link” function to add them to their favorites, and share them with other consumer members as they choose. For each link added, the customer browser and content management engine saves the link to the consumer node, posts the link to the consumers favorite links data 520C, and, if shared, posts the link to the content databases using the methods described above.

It will be apparent to those skilled in the art that appropriate queries against the content databases, using either affinity values, or keywords or phrases will generate result sets containing lists of links to relevant websites, as determined by the consumer members who submitted them. The inventions link posting methods thus provide a mechanism to populate a searchable database whose content has been evaluated, categorized, and effectively indexed by human editors.

Combined with additional queries against the related tables 865, 870, 875 and 880, a query against the affinity links database 855 or keyword links database 850 provides the data for each link in the result set needed to display a list of search results ordered by score which includes:
The link's category and subject search focus
The temperament value(s) of the search focus
The type value(s) of the search focus
The level value(s) of the search focus
The URL of the link's website (from table 870)
The date the link was first submitted (from the affinity link serial number)
For local and regional websites, the zip code of the link submitter (860G in table 860)
The score of the link as determined by members of specific affinity groups (865C from table 865)
The score of the link as determined by all consumer members of the marketplace (870C)
The pseudonym (as associated with the source member serial number 865D in table 865) and zip code (as extracted from the source member serial number 865D in table 865) of the first link submitter
All comments included by other consumers for the link (875C from table 875), and their respective zip codes (extracted from their reviewer ID 875B in table 875), pseudonyms (reviewer pseudonym 880B from table 880) and reviewer credibility scores 880C from table 880

Affinity link scores 865C are a gauge of the popularity of a website link within an affinity group, and are used to rank and order search results when consumer members search the content databases. The foundation of the invention's method of calculating link scores is the tracking by the custom browser, and subsequent analyses by the consumer management engine, of specific consumer actions. Each such action is assigned a weighted vote which is considered in calculating link scores:
When a consumer imports a link from their pre-existing browser, they are implicitly expressing a judgment of the link's personal value to them, and by inference, to the affinity group(s) of which they are members
When a consumer adds a link to a website they have discovered in the course of web surfing, they are implicitly expressing a judgment of the link's personal value to them, and by inference, to the affinity group(s) of which they are members
When a consumer elects to add a visited link found through a query against the content database to their personal favorites, they are implicitly expressing a judgment of the value of the affinity link's entry and therefore the credibility of its associated reviews, to them, and by inference, to the affinity group(s) of which they are members
Each time a consumer visits one of their favorite links, they are implicitly confirming the links personal value to them, and by inference, to the affinity group(s) of which they are members

It will be apparent to those skilled in the art that a variety of link scoring methods are possible. In the preferred embodiment, the content management engine counts each link-import and each link-add action by any consumer member as one vote. The custom browser, using a MSG: LinkVisit message, reports each subsequent visit to that link by any consumer member, to the content management engine which then counts the visit as some predefined fraction of one vote. The custom browser might additionally track and report the length of time each consumer member spends at each of the links when they visit, enabling the consumer management engine to adjust the value of the fractional vote accordingly. Regardless of the actual link scoring algorithm or weights used, the invention's method of segregating all submitted links into relatively small groups sorted by well-defined affinity values, and then using the link adoption and link visiting actions of the affinity groups' members to drive the scoring process, offers several advantages over general search engine page ranking methods:
Websites cataloged under each affinity group have a precisely articulated content context—topic and subtopic, a precisely articulated user context—personality style (temperament), intent (type), sophistication (level), geographical focus (geography) and any other such affinity defining attributes as might be used—and a precisely articulated context for like-minded consumers, namely other members having similar attributes. The content search and ranking method of the invention thus enables searches within far smaller pools of candidate links and generates result sets which are lower in quantity but higher in user-specific relevance, and hence quality. In contrast to general Internet search engines, as described previously, the method far better exploits the power and potential of collaborative filtering.
Newly submitted or less popular links compete against a far smaller pool of link candidates in the ranking process, and are thus more likely to appear earlier in the list of search results where typical users are more apt to discover them, in contrast to general Internet search engine results as described previously.
Websites are ranked using the collective value perceived by human editors, and specifically, consumer members who by virtue of their shared demographic and psychographic characteristics, are best qualified to pass judgment on the subjective value of each website to its primary users—other consumer members similar to themselves, in direct contrast to machine calculated ranking used by general Internet search engine results as described previously.
The method's scoring and ranking process occurs within a closed community defined by its associated affinity group's members, and therefore cannot be corrupted by search engine optimization techniques or rank checking tools to which it is inaccessible. The only properties considered in the method's scoring are the adoption of each link—and each consumer can only adopt the same link once, and link usage—which the architecture of the consumer tools makes difficult to abuse.

Moreover, by using link adoption data and adopted link usage data, the method of link ranking, as described above, is driven by scores inferring user-perceived value after, rather than before, the user has visited and assessed a website. Google and similar search engines consider the volume of traffic a website receives in their ranking algorithms, but makes no distinction as to whether a website visit was found useful or not by the visitors creating the traffic. A new website, operated by a company with deep pockets and supported by a strong marketing budget, can receive considerable traffic as users respond to ads which tout it. As an example, even if the website disappoints many users who fail to return, a sustained marketing campaign will ensure enough new traffic volume over a long enough period to insure that the website will emerge from Google's new link incubation period with a favorable ranking. Since typical users, as described in the “Description of the Prior Art”, most frequently click on the website links appearing earliest in Internet search engine results, the rankings of the new and well publicized website will be artificially propped up by the search engines ranking method which enables it to garner more user clicks than it deserves. As previously stated, popular Internet search engines may drive website popularity as much as they independently reflect it.

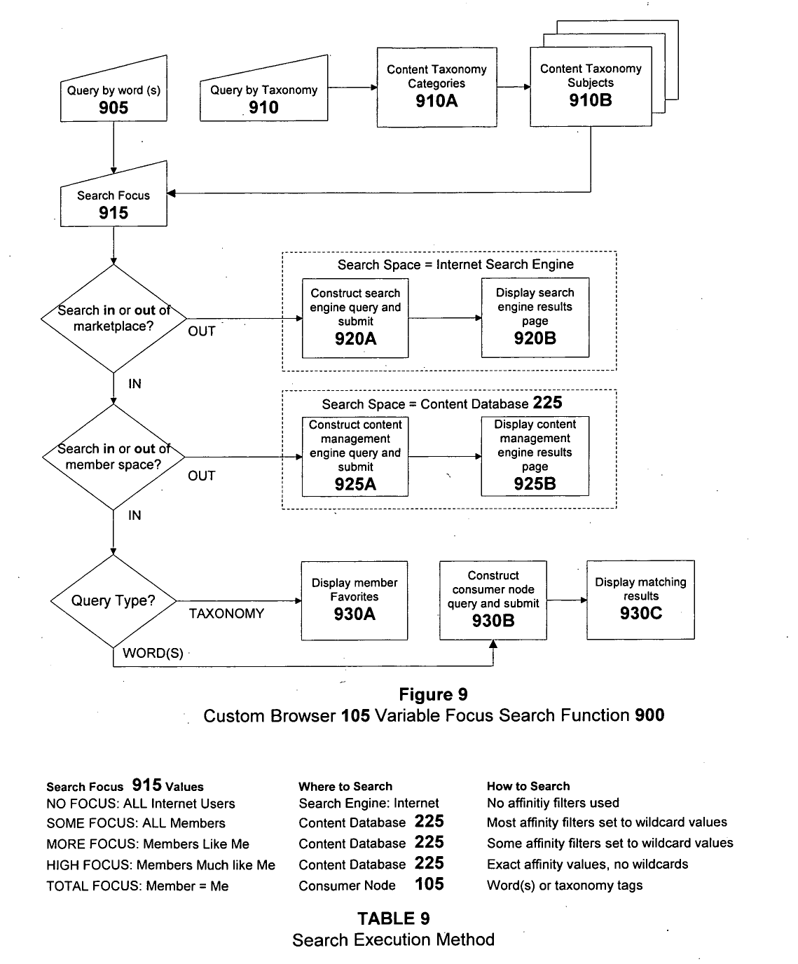

FIG. 9 illustrates a flowchart of the custom browser's variable focus search method 900 which exploits the affinity-based search described above. The search function allows the consumer member to search for content by entering a query word or phrase 905, or to search by taxonomy 910 by selecting a category 910A and subject 910B from dropdown lists which incorporate the marketplace's content taxonomy. Either search method further allows consumer members to ‘dial-in’ a search focus value 915 which tells the search function where and how to conduct its search to provide the most relevant and useful results when processing the query. As detailed in TABLE 9, the search function method works as follows:
If the consumer member dials in ‘NO FOCUS’, their query is directed out of the marketplace's content databases and into the Internet using their default Internet search engine which they may specify at any time using an ‘Options’ feature (not shown). For query-by-word(s) 905 searches, the custom browser incorporates the query text into the HTTP query text string 920A appropriate for the search engine used, submits the query to the search engine on the consumer member's behalf, then displays the search engine results 920B in the custom browser's client area. As an example, if the consumer member enters “cars+convertibles” and their default search engine is Google, the custom browser creates and submits the string:
   http://www.google.com/search?hl=en&q=cars+%2B+convertibles%22.
For query-by-taxonomy searches 910A, the custom browser incorporates the category and subject literals into the HTTP query text string 920A appropriate for the search engine used, submits the query to the search engine on the consumer member's behalf, then displays the search engine results 920B in the browser's client area. As an example, if the same consumer member selected “Food+Drink” from the category list and “Organic” from the subject list, the custom browser creates the string:
   http://www.google.com/search?hl=en&lr=&q=%22food+%2 B+drink+%2 B+organic%22
Optionally, the search function allows the user to specify a local search (not shown) which includes their zip code in the strings illustrated above, and enables search engines, so equipped, to deliver results specific to their geographic area.
Programmatically creating search engine query strings as described above is a common practice and is known to those skilled in the art.
If the consumer member dials in ‘SOME FOCUS’, their query is directed to the content management engine on the marketplace servers. If the query type is by word(s) 905, then the content management engine searches the content keywords database for matching words or phrases and their associated affinity link IDs to generate the search result set. If the query type is by taxonomy 910, the content management engine generates the results set by searching the affinity links database 855 directly for all link IDs with taxonomy tags matching the query. As indicated in TABLE 9, the ‘SOME FOCUS’ setting search space includes all links submitted by all consumer members, and thus most affinity values in the database query are set to the wildcard value. Links are displayed in the order of their link scores 870C.
As the consumer member dials in ‘MORE FOCUS’ or ‘HIGH FOCUS’, the wildcards used in the database query against the affinity links table are progressively replaced with specific values and smaller ranges of values using methods known to those skilled in the art. Query results for ‘SOME FOCUS’, ‘MORE FOCUS’ and ‘HIGH FOCUS’ are displayed in the custom browser listed by highest score first, in a fashion and format similar to Internet search engine results. For each link included in the search results, associated data from tables 860, 865, 870, 875 and 880 is used to enable browser navigation to the website, to provide information about the consumer member who first submitted the link (i.e., pseudonym, zip code and content review credibility score), and to provide access to additional comments 875C submitted by other consumer members. Duplicate affinity link IDs and link IDs appearing in search result sets are filtered out as necessary through the use of appropriate query verbs known to those skilled in the art.
If the consumer member dials in ‘TOTAL FOCUS’, the search space is limited to the favorites data residing on their own consumer node. Query-by-word(s) 905 searches are directed to their local copy of link keywords, created when the consumer originally imported or added links as previously described. The favorite links saved under the matching words or phrases are used to generate the result set which is displayed in the custom browser, in a format similar to Internet search engine results. Query-by-taxonomy 910 searches simply display each member's favorite links as described earlier.

The invention's link sharing methods thus enables consumer members to share website links with other consumer members, and offers significant benefits over existing Internet search engines and social bookmarking models. Unlike popular search engines, the invention enables its members to directly share and discover links to websites residing in the deep web—the 99 percent of the publicly accessible Internet which is beyond the indexing reach of Google, Overture, Inktomi, LookSmart, et al. Rather than calculating web page value through the use of machine algorithms, the invention effectively outsources the ranking of web pages to its human members, and more importantly, to those members who are best qualified to do so within each specific topic domain. And finally, the invention, by virtue of including and supplementing, rather than replacing, the content discovery function of Internet search engines, delivers their more extensive surface web reach when members prefer quantity of results, and more constrained but deep-web reaching results when they prefer quality and relevance.

The invention's link sharing method offers significant advantages over models used by social bookmarking websites such as del.icio.us, which as described previously, catalogs user-submitted taxonomy tags and their associated links which other users may browse. Unlike such models, which force users to sequentially scan tags for those that pique their interest, the invention pre-clusters relevant website links by affinity groups whose collective wisdom and shared values rank their order of relevance. As time passes and the volume of submitted links grow, the invention insures that the most relevant links continue to be promoted to the highest ranking. It is not difficult to imagine, by contrast, that social bookmarking models such as used by del.icio.us, over time will accumulate an onerous list of non-standardized taxonomy tags that impose a significant search cost on its users.

The invention's link sharing method offers significant advantages over models used by social bookmarking websites such as LookSmart's furl.net, which as described previously, uses each member's website link ratings to identify their neighbors—other members who rate websites similarly. Unlike furl.net, the invention automatically establishes separate affinity groups for each topic and subtopic content taxonomy combination, and potentially hundreds of affinity groups within each topic and subtopic combination based on various permutations of shared affinity group member attributes. Each consumer member of the marketplace can thus belong to hundreds of different affinity groups, each of which reflects different attributes. As an example, furl.net will cast two different users as close neighbors if they share a keen interest in 1970 domestic muscle cars and both rate websites which provide advanced theoretical analyses of intake manifold design highly. True to real life, however, advanced automotive theory may be the only common interest they share. As long as either user in interested in finding additional sources of automotive theory, the neighbors which furl.net has given them can be helpful—for any other topic of search, their neighbors may be of no help whatsoever. By contrast, the invention allows each user to implicitly declare who their affinity groups will be for each specific topic and subtopic, by temperament, by geography, by level of sophistication, and by any other member attribute captured or included by the link sharing process.

Other embodiments are possible. As an example, rather than predefine the degrees of search focus as described, the custom browser could display a menu of affinity attributes for each search and allow the consumer to select which attributes, and the degree of similarity to each such attribute, should be used as the basis for focus. As an example, a consumer may enter a taxonomy-based search using the category and subcategory “BLF: Attitudes, Opinions & Beliefs” and “POL: Politics” respectively. From the attribute menu displayed, they may select a level of “Advanced”, a link type value of “Social”, and a “Political Leaning” data point value of “Liberal”. If such attributes were incorporated into the affinity links tables, members could thus search for website links to blogs whose members are simpatico with their own beliefs and sophistication. The preferred embodiment has the virtue of simplicity—one variable, a degree of focus, rather than the alternative embodiment's checklist, requires user input. It is noted that the preferred embodiment may be offered as a default focus selection method and does not preclude the inclusion of the alternative method as an option for consumers who may prefer it.

Data gathered during the signup and installation process (zip code, date of birth, gender, household income band, personal temperament, interests and affinities inferred from imported website links, and consumer node hardware and software configuration) provides a foundation for the inventions precision targeting capability also referred to as intimate anonymity. The profile manager 320 on the consumer node 105, as listed in FIG. 3, provides a mechanism for dynamically building on this foundation to create a comprehensive and precisely articulated collection of structured demographic and psychographic data points about consumers, including their purchasing histories, brand loyalties, preferences, propensities and other information having high predictive value to advertisers and content providers.

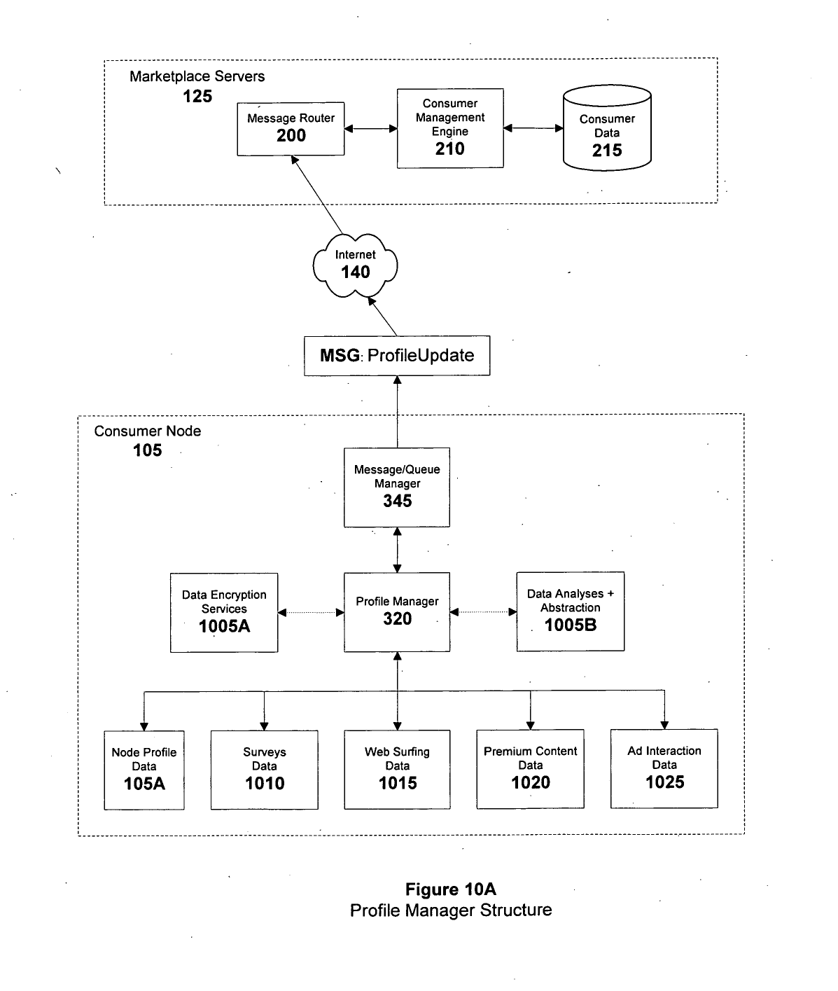

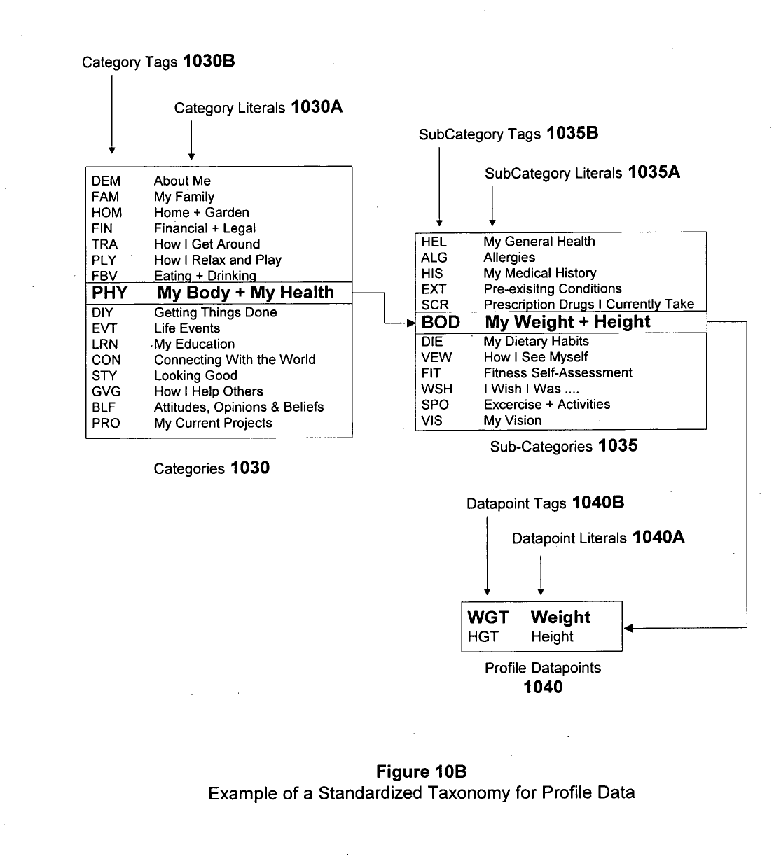

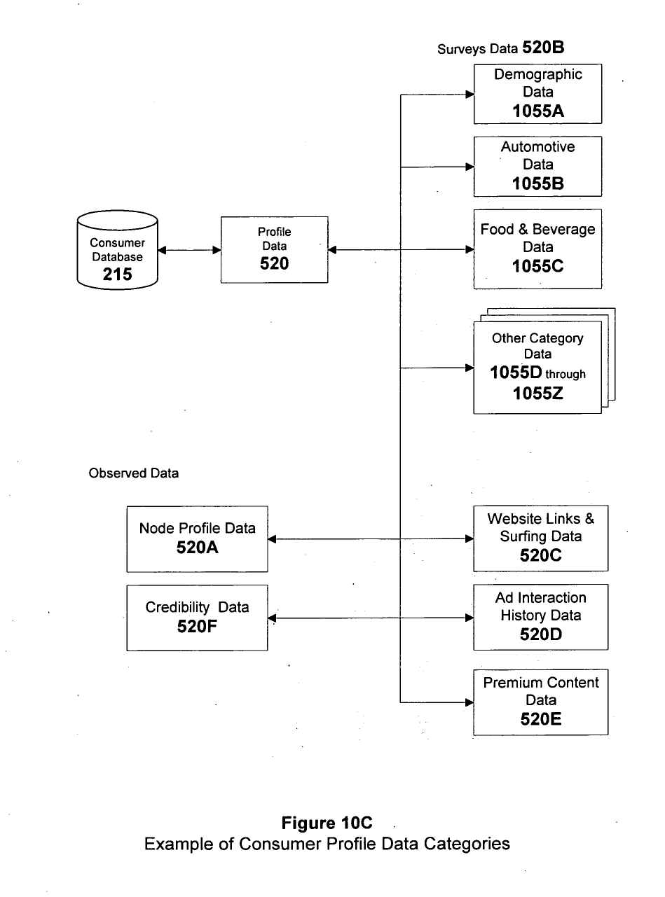

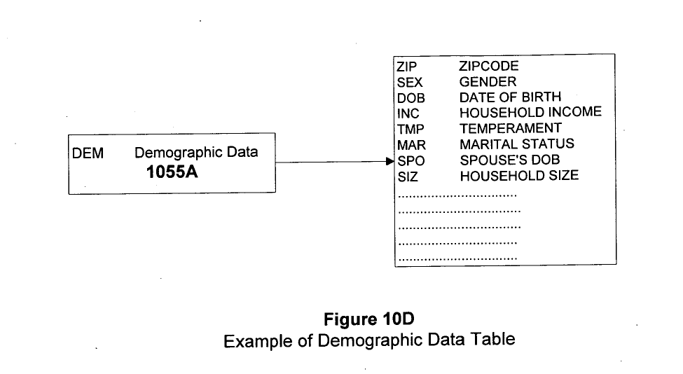

As illustrated in FIG. 10A, the profile manager 320 on the consumer node 105 collects, encrypts 1005A and saves detailed consumer data from multiple sources, analyzes and abstracts 1005B the consumer data into summary form, and then sends it in MSG: ProfileUpdate messages to the marketplace servers 125. As described earlier, all profile data, including associated profile taxonomy tags (described later in this section) which provides data context is encrypted using the local ID which is known only to the registered consumer member. Any spyware inadvertently downloaded by the consumer to their node is thus prevented from accessing profile data or from even discerning what profile data is stored. Profile data is stored on the consumer databases 215, and on the consumer node 105, using a precisely articulated lexicon and a hierarchical taxonomy for profile data, similar in concept to the taxonomy for content described earlier in this section.

The Profile Manager 320 collects data from multiple sources:
Node Profile Data 105A
Profile surveys 1010
Member web link affinities and web surfing patterns 1015
Member premium content data 1020
Member ad interaction data 1025

Node profile data is originally captured during consumer node installation and includes the electronic device configuration data and node defining elements as previously described in paragraph 0. Node profile data enables the marketplace, its members, and third-party content providers to learn each consumer node's resources and content rendering capabilities, and to target content optimized for the node's profile accordingly.

Profile surveys 1010 collect user-declared data—that is—consumers are asked directly to provide information to the marketplace by completing surveys. Member web surfing patterns 1015, content transaction and usage 1020, and ad interactions 1025 are observed and inferred data which is used to supplement and validate user-declared data.

Profile surveys are brief—consisting of 4-5 forced-choice questions each (answers are selected from a list of pre-defined and normalized responses), and are arranged in a hierarchy of progressively greater detail or drill-down. At the top of the hierarchy are category-level surveys, (also referred to herein as “diagnostics”), designed to establish a baseline of each consumer member's status and history within each category. Logic and scripts embedded within each survey evaluate consumer responses and enable the profile manager 320 to download the appropriate drill-down surveys to each consumer node.

As an example, a category might be ‘How I get around’, the diagnostic survey for which can rapidly differentiate a city-dwelling, public transportation-dependent consumer member from a suburban, car-dependent member. Based on the category diagnostic, the city-dwelling member might receive drill-down surveys pertaining to their use and preferences in public transportation and rental cars. The suburban member, in contrast, might receive one or more drill-down surveys pertaining to their current vehicle, dealership satisfaction, purchasing history and intent, and vehicle financing preferences. The embedded logic within each ‘smart’ survey ensures that each consumer will only receive additional drill-down surveys which are relevant to them based on previously supplied responses.

Surveys can be presented to consumers on a scheduled or event-driven basis using any of a number of possible formats and techniques apparent to one skilled in the art. Many methods of embedding logic and scripts within forms to create smart surveys are possible and are also known to those skilled in the art.

Additional logic or scripts embedded in surveys can combine individual consumer responses to derive new data points which consumers themselves may not be able to provide, but which may have great value to advertisers as targeting criteria. As an example, pharmaceutical companies with cholesterol-management drugs would find great value in being able to selectively target members who may be ‘at-risk’ candidates for heart attack, a primary indicator of such candidates being an elevated cholesterol level. Many consumers do not know their cholesterol count, and without using physicians as a ‘marketing proxy’, pharmaceutical companies have no way to directly reach at-risk candidates. A good secondary at-risk predictor is a consumer's Body-Mass Index, or BMI, which logic embedded in a health and fitness survey can easily calculate from body weight and height—values which the average consumer can easily provide. Given the proper tools, pharmaceutical advertisers can thus filter the general consumer membership by their BMI and by other collected profile data points which identify additional contributing risk factors such as their age, dietary preferences and habits, smoking and alcoholic beverage consumption, and physical activities, and can thus identify specific well-defined audiences within the general membership to whom they can precisely target with relevant ad campaigns, as described later in this section.

Consumer participation in the survey process is at their discretion. They may complete surveys whenever they choose, in any order they choose, and may answer only those questions within any survey as they choose. Consumers are thus not required or obligated to invest significant amounts of time completing their profiles in one sitting. Additional surveys may be authored and targeted to specific segments of the general consumer membership over time by the marketplace operators, or they may be authored by advertisers seeking unique product- or needs-specific consumer data, and who can then use the survey results to subsequently identify and target ad campaign audiences. Profile surveys, regardless of authorship, may only ask questions which do not require or allow consumer members to enter any information through which they may be identified, or through which their anonymity may be otherwise compromised.

The marketplace offers significant incentives to each consumer member for their participation in the profiling process. In addition to providing a progressively more individualized web experience, the marketplace provides other incentives and rewards for each survey which they complete. Rewards and their use in the marketplace are described later in this section.

Other embodiments are possible. As an example, a single comprehensive survey can be presented to consumer members as part of the signup process which would insure that all consumer nodes have a fully populated consumer profile prior to becoming operational in the marketplace. The preferred embodiment offers the advantage of relieving consumers of the burden of completing a lengthy survey in one sitting. Another benefit of the preferred embodiment is the ability to infer additional information about each consumer member's values and priorities—the surveys they choose to complete, and the order in which they choose to complete them, may imply the importance of the survey topic to them. Moreover, the preferred embodiment enables the selective presentation of only those survey topics and questions which are relevant to each consumer member. Finally, the system of incentives, described later in this section, whereby consumer members are rewarded directly, indirectly, and continuously in exchange for their active participation in the authoring and stewardship of their profiles, may be more effective when each additional incentive is only a brief survey away.

Member web surfing patterns provide another source of profile data. The custom browser, through its management of the link import and link add processes, and as the mechanism through which consumer members revisit their favorite links, captures the content preference and web surfing pattern data of every consumer member. As described earlier in this section, each link has associated tags which consumer members assign using the marketplace's content taxonomy, and thus each member's website visits can be tracked and counted by URL, and by category and subject, as they are visited. The profile manager on the consumer node summarizes this data and sends it to the marketplace servers on a periodic basis. In addition to its use in calculating link scores, the marketplace servers use web surfing patterns to update each consumer member's web surfing profile data.

The profile manager 320 on the consumer node observes and captures a detailed log of the times, frequencies, and durations of each consumer member's usage of the Internet. Since only consumer favorites have the taxonomy tags needed to establish context pattern data, visits to websites which are not among a consumer member's favorite may either be ignored, or may preferably be timed and analyzed to generate additional statistical data about consumer surfing habits. The marketplace assumes that any website which the consumer finds valuable enough to frequently visit will be added by them to their favorites. As known to a person skilled in the art, knowledge of website surfing patterns enables a variety of analyses having significant predictive value of consumer interests for both advertisers and content providers, and that such analyses are conducted accordingly by such websites as aol.com, yahoo.com and msn.com, to name a few.

Using database techniques known to those skilled in the art, the consumer management engine 210, in addition to the profile data described previously, can further sort and segregate consumer members based on:
Websites they visit using their favorites link addresses
Topics of websites they visit using the taxonomy tags of those same links
Extent of interest in a topic as implied by the number of link entries saved under each taxonomy topic and subtopic pair appearing in each consumer's favorites data
Extent of interest in a topic as implied by the visit duration data accumulated for all links associated with the topic.

As an example, the appropriate ‘SELECT’ database operation by the consumer management engine on the consumer databases 215 will generate a list of all consumer member nodes whose members live in any ZIP CODE matching ‘077XX’ (where ‘XX’ are ‘wildcard’ placeholders and may each have any value from ‘0’ to ‘9’), have a GENDER of ‘male’, have HOUSEHOLD INCOMES greater than ‘$75,000’, have a DATE-OF-BIRTH ranging from ‘Jan. 1, 1948’ and ‘Jan. 31, 1958’ have a demonstrated interest in TRA:PRF, that is, ‘Transportation+Automobiles: High-Performance Cars+Exotics’—as evidenced by multiple favorites saved under that topic and subtopic, and whose ARCHETYPE indicates ‘Extroversion’. Porsche, or one of Porsche's ad agencies, for example, given the proper tools can thus create a result set containing a list of consumer member serial numbers which correspond to ideal prospective customers: male baby boomers who live in northern New Jersey, and who have the means, the interest, and a propensity to buy sports cars. With such a well-defined target audience, Porsche can request their ad agency to create a localized and relevant ad campaign which resonates uniquely with the demographic and psychographic profile of those audience members.

The additional sources of consumer profile data, premium content transaction and usage data and ad interaction data are described in paragraphs [325] and [283] respectively.

FIG. 10B illustrates an example of a taxonomy for consumer profile data. Each category 1030 has an associated category literal 1030A and category tag 1030B, and an associated list of one or more subcategories 1035, each of which has a subcategory literal 1035A and a subcategory tag 1035B. Each subcategory 1035, in turn, has an associated list of one or more data points 1040, each of which also has a literal and tag value, 1040A and 1040B respectively.

Each category 1030 has an associated diagnostic profile survey which the profile manager on the consumer node uses to baseline consumer members as described earlier. As illustrated, the profile taxonomy's breadth and depth are extensible—additional categories can be added, and additional drill-down levels may be selectively incorporated into the hierarchy as needed.

Referencing specific consumer data points 1040 within their profiles is relatively simple using the appropriate sequence of profile taxonomy tags. In the example shown, a consumer member's body weight, previously captured in a ‘health+fitness’ survey, can be referenced by the hierarchical tag combination ‘PHY:BOD:WGT’, using category tags 1030B, subcategory tags 1035B and profile data point tag 1040B respectively. A standardized dictionary of profile tags and hierarchies, when published by the marketplace, provides a common and publicly available lexicon which advertisers, agencies, worthy causes, and third-party content providers can use to reference and access consumer profile data, as described later in this section.

As illustrated in FIG. 10C, the consumer database 215 on the marketplace servers provides a repository for aggregated consumer profile data 520, including data which consumers directly provide in response to surveys 520B—declared data, and data which the tools on the consumer node 105 collect, derive, and abstract through observation of the consumer member's performance and interaction with the marketplace—observed data. FIG. 10C illustrates the components of the profile data 520 organized by category and includes demographic data 1055A and other categories 1055B through 1055Z that capture the consumer's needs, interests, purchasing histories, brand loyalties, preferences, and propensities organized by product and service categories.

Observed data is other information which the consumer node captures, analyzes, abstracts and periodically submits to the consumer management engine for posting to each consumer's profile records. Observed data includes the node profile data 520A of each consumer member, their favorite website links and web surfing habits 520C, premium content which they download and subsequently use 520E, their patterns and histories of interaction with ad campaigns 520D which they receive, and data 520F which infers their credibility as good faith participants in the marketplace.

FIG. 10D illustrates an example of some of the data fields that might appear in a consumer member's demographic data profile 1055A, each field corresponding to a collected data point having its own unique profile taxonomy tag and literal. The consumer profile taxonomy is incorporated into the consumer node 105, the marketplace servers 125, the advertiser 110, ad agency 115, and worthy cause 120 nodes, and is otherwise made available to all third-party content providers 130A and 130B through its publication on the marketplace's website.

Two of the profile categories listed in FIG. 10B—‘CON: Connecting with the World’ and ‘GVG: How I Help Others’, enable specific methods of the invention. The Connecting with the World category captures consumer member preferences in news, sports, entertainment, financial and other information—and their preferences in television and radio stations and programs, newspapers, magazines, websites and other such sources of each. Profile data in this category enables advertiser, agency and worthy cause members to improve their consumer targeting in those traditional advertising venues, as further described in paragraph [249].

The How I Help Others category captures each consumer member's affinities for various environmental, social, educational, animal rights, and other noble causes, and enables worthy cause organizations to target and solicit consumer members for donations from the rewards they earn as good faith participants in the marketplace. As described in paragraph [335], donation data is made available to advertisers and agencies which they may use to infer and segregate good faith consumer participants from mercenary consumer participants among the marketplace's general consumer membership, and to base their targeting accordingly.

The intimate anonymity (hereinafter also referred to as ‘IA’) of consumer members visiting third-party content provider websites is enabled through a method which requires the flow of control and content data among the participating parties as follows:
The third-party website requests specific profile data points from a visiting consumer member's node
The consumer node sends a message to the marketplace servers requesting authentication of the third-party website
The marketplace servers looks up the third-party content provider's account on the advertiser databases and sends an authentication status message back to the consumer node accordingly
If the third-party website is authenticated, the consumer node sends the requested profile data points to the third-party website, subject to the consumer member's permission to share one or more of the data points requested
The consumer node sends a fulfillment message to the marketplace servers which uses the included fulfillment data to track the third-party content provider's activity and to debit their account accordingly

When an Internet user accesses a web page from a website, they are actually directing their web browser to download a web page file from the website's server. The downloaded file contains information which the web browser uses to render and display the web page—namely, page formatting instructions and references to embedded content, such as images or other media. The format of the downloaded file can vary depending on the technology used by the web server to describe the web page, but all commonly used technologies allow for the inclusion of data and instructions that can be conditionally ignored by web browsers. Such content might include version or authoring information used for internal website management, instructions to search engine spiders about how to index the web page, or content that some browsers can exploit to improve page rendering, but which others cannot use, and therefore ignore.

General web page description languages and protocols thus provide a way for third-party websites to embed and transmit structured profile data requests (also known hereinafter as IA-requests) to the nodes of visiting consumer members, which the custom browser can detect and process, and in conjunction with the profile manager, fulfill through simple HTTP messages sent back to the requesting website using methods known to those skilled in the art. When non-members access the same web page using their traditional browsers, the embedded requests are simply ignored.

To use the intimate anonymity service of the marketplace, third-party content providers visit the marketplace website, take the intimate anonymity tour (optional and not shown), sign up for the service, and create an IA account (processes not shown). The sign-up process requires each prospective account holder to provide registration information which includes specific website data, and to specify a valid payment instrument, such as a credit card, marketplace account, or other such electronic funds payment instrument. The third-party content provider then specifies a dollar amount with which to pre-fund their account. The marketplace servers process the charge to the specified payment instrument, and if successful, their account is opened (such processes not shown and using methods known to those skilled in the art). Until such time as their account balance is depleted by the application of micropayment fees assessed for each use, the third-party may use the intimate anonymity service which draws down their balance. The marketplace automatically sends email alerts to each third-party content provider as their account balances fall below a predefined threshold so that they may re-fund their account in time to prevent an interruption of the IA service.

By visiting the marketplace's website, third-party content providers can view the marketplace's standardized dictionary of consumer profile tags and hierarchies, which they may then use to access consumer profile data as described below.

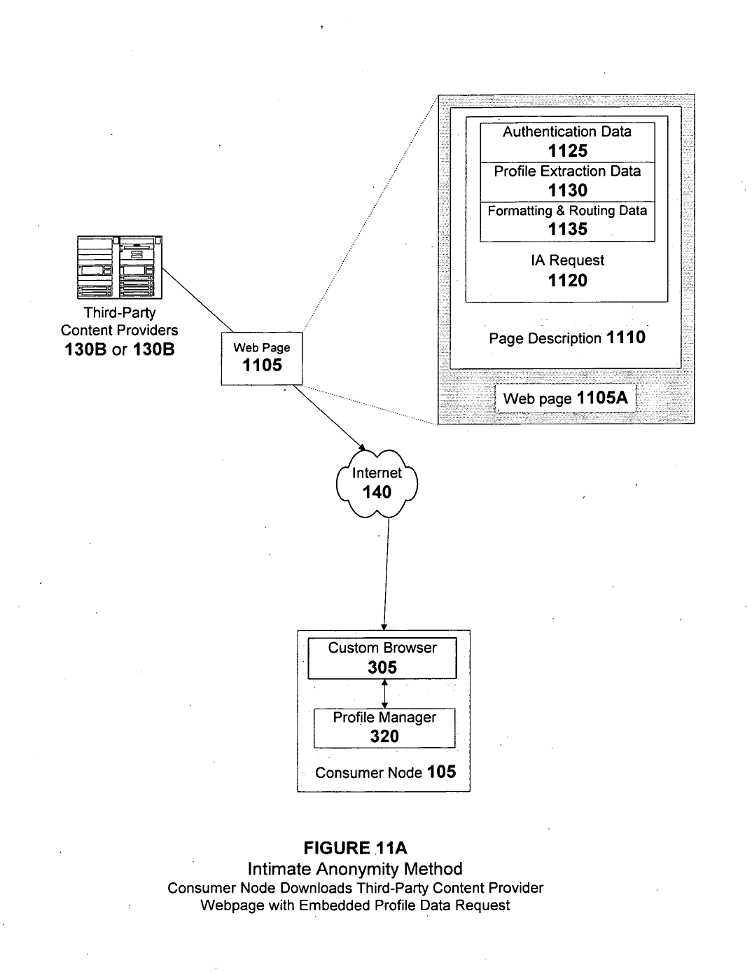

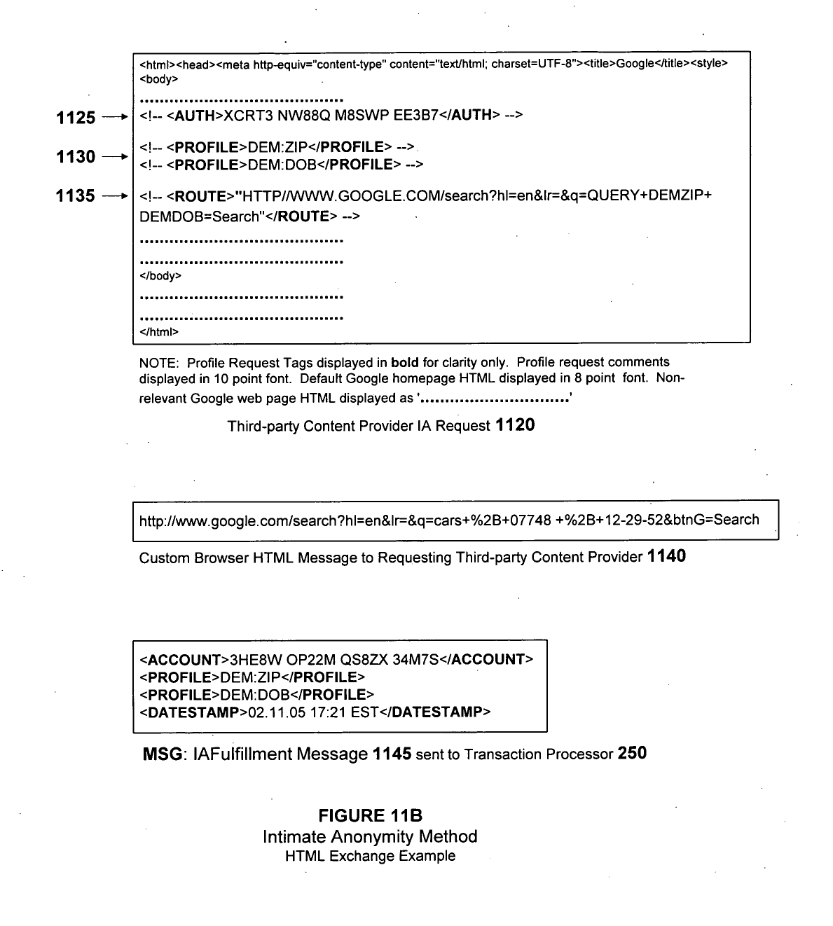

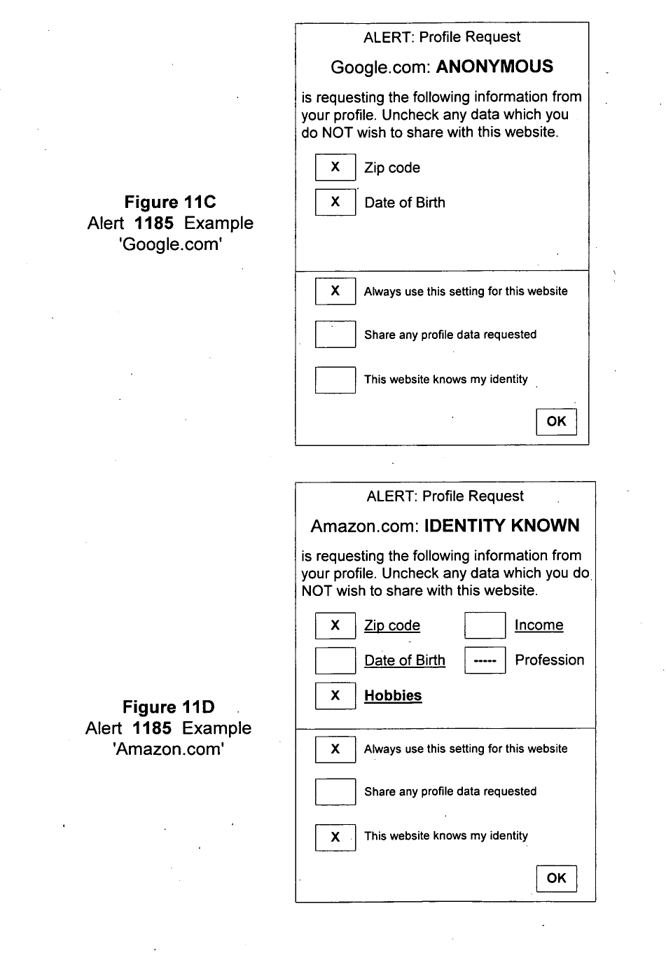

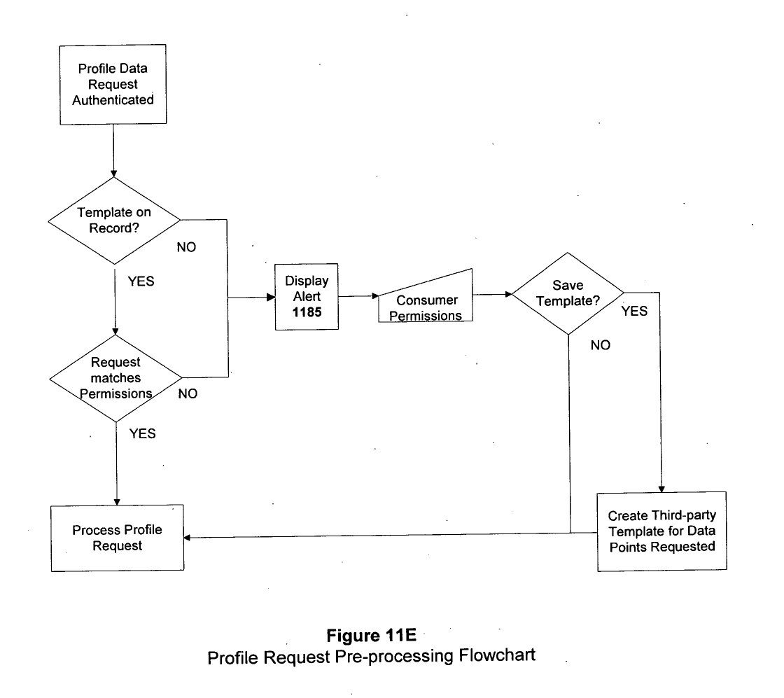

FIG. 11A through FIG. 11E illustrate the intimate anonymity method. FIG. 11A is a block diagram of an IA-enabled web page 1105 being downloaded over the Internet 140 from a third-party content provider by a visiting consumer member to their node 105. The websites usual web page description file 1110 contains an embedded IA request 1120 as shown in the exploded view 1105A of the web page file. The custom browser 305 on the consumer node 105 detects the request and passes it to the profile manager 320 for processing. Each IA request 1120 contains elements as follows:
Authentication data 1125, which is used to verify that the third-party content provider 130A or 130B is registered with the marketplace servers, is authorized to access profile data, and that it has an account in good standing with the marketplace. Authentication data may be as simple as a unique serial number assigned to each third-party content provider by the marketplace servers when they signup for the IA service.
Profile Extraction Data 1130, which specifies the profile data points 1040 (as shown in FIG. 10B) requested from the consumer profile stored on the consumer node 105
Message Formatting & Routing Data 1135, a string template which specifies the website address of the third-party content provider 130A or 130B where the requested profile data is to be sent, and the structure in which the requested data should be formatted

The HTML example in FIG. 11B shows an IA Request 1120 embedded within the body of the standard HTML file for Google.com's home page (HTML lines not relevant to this example are denoted with a series of periods, i.e. ‘ . . . ’). The IA request is formatted as a series of HTML comments, as denoted by the “<!-” and “-->” delimiter pairs, and is thus ignored by the web browsers of non-members. The custom browser, detecting the three XML data structures ‘AUTH’ (authentication data), ‘PROFILE’ (profile extraction data), and ‘ROUTE’ (message formatting and routing data), recognizes the comment set as a complete and valid IA request and processes it accordingly:
The custom browser uses the authentication data 1125 to create a MSG: Authentication Request message (not shown) containing the third-party content provider serial number and the URL of the requesting website, in the example shown ‘XCRT3 NW88Q M8SWP EE3B7’ and HTTP://WWW.GOOGLE.COM respectively, where the consumer has entered a search query for “cars”. The consumer node 105 sends the message to the marketplace servers where it is routed to the advertiser management engine for processing. The advertiser management engine compares the serial number and the URL submitted to those on record in the advertiser database, verifies that the requesting party's serial number is associated with the URL submitted, and that the third-party account is in good standing with the marketplace. A MSG: AuthenticationStatus message bearing the content-providers authentication status (not shown) is then sent back to the consumer node.
If authenticated, the profile extraction data 1130 is processed by the profile manager, which checks an IA-history file (not shown) on the consumer node for a profile access permission template (hereinafter referred to as “permission template”) which the consumer member may have previously saved for the requesting content provider, in the example shown, ‘XCRT3 NW88Q M8SWP EE3B7’. If a template for this content provider is found, and the data points currently requested match those for which permission has already been granted by the consumer member, the profile manager retrieves the requested profile data from the consumer's profile data. In the example shown, the request specifies ‘DEMZIP’ and ‘DEMDOB’, the consumer member's zip code and date-of-birth respectively from their demographic profile.
If no previous history of permissions for the content provider exists, or if the content provider is requesting new data points for which permissions have not been previously granted, the custom browser displays an alert, further described in paragraph [220], which describes the nature of the request and enables the consumer to indicate which, if any of the requested data points they are willing to share with the third party. If the third-party content provider is type 130B, which already has one or more identifying pieces of information about the consumer, the consumer has the opportunity to decide which additional information from their profiles they may be willing to share with them, and which information they would prefer not to disclose given that their identity is already known to the content provider. All requests from non-authenticated content-providers are simply ignored by the consumer node.
The profile manager, using the formatting and routing template 1135 specified in the IA request, creates a response string and sends it to the specified web address. In the example shown, the ‘QUERY’, ‘DEMZIP’ and ‘DEMDOB’ placeholders in Google's template 1135 are replaced by the consumer's search query (‘cars’), their zip code and their date of birth respectively and the HTTP-formatted response string 1140 is then sent back to Google. The third-party content provider uses the data-bearing response string 1140 to customize the content of the web page which is then downloaded to the consumer's custom browser.
If one or more of the requested consumer data points are available on the consumer node and the third-party's request is fulfilled, in whole or in part, the profile manager creates a MSG: IAFulfiliment message 1145 describing the fulfillment details. The fulfillment message is sent to the transaction processor on the marketplace servers which applies an appropriate charge to the third-party content provider's account and update's their IA-usage records on the advertiser database (processes not shown and which use methods known to those skilled in the art).

As previously noted, the web browsers of non-members will ignore IA-requests formatted as comments, and will proceed instead to process the balance of the website's page description file as usual. The early placement of the IA-request at the beginning of the web page file enables the custom browser it to intercept normal page rendering if the third-party content provider is sending an IA-enabled page, and if so, to conditionally execute the statements specific to fulfilling the IA-request.

As will be apparent to those skilled in the art, multiple IA-requests may be embedded within the same web page description file, and in fact, may appear within hierarchically nested scripts which enable fairly sophisticated profile data acquisition from within each web page's downloaded HTML file. Using such methods, third party-content providers can create a sequence of IA requests which sequentially use the values returned by each request to conditionally determine the specific data points requested in the next embedded request. As will also be apparent to those skilled in the art, the compound scripts described may control two-way request-fulfillment exchanges between the logic in the web page file and the profile manager on the consumer node, or may control three-way exchanges which additionally include logic residing on the third-party's web server. In such a three-way exchange, IA-requests embedded within web page scripts can send profile data points back to the third-party website which then direct the next set of profile data points to request.

As an example, a web page from Amazon.com contains an IA-request for the data point corresponding to a consumer member's favorite hobby. If the consumer agrees to provide access to Amazon.com, as described earlier, Amazon's web page receives the data point, and the web page's script sends it back to Amazon.com's server using an HTTP process. Based on detailed knowledge of the books and other products in inventory which are relevant to the hobby specified, Amazon's web servers can determine the best data points to request next, in order to assemble and download the most relevant and individualized display of goods for the current consumer. It is noted that such scripts may also include standard HTML statements and variables that enable the web page to solicit data points directly from the consumer which are unique to Amazon and thus not part of a consumer's profile. Thus websites like Amazon.com can provide truly personalized web experiences to each visiting consumer without burdening them with the onerous task of telling them about themselves each time they visit.

FIG. 11C and FIG. 1D illustrate examples of profile data request alerts 1185. Continuing the example of the profile data request described in FIG. 11A, FIG. 11C illustrates the alert 1185 which the custom browser might display to the consumer visiting Google.com for the first time since becoming a member of the marketplace and using the custom browser. The alert indicates that Google is requesting the consumer's zip code and date of birth, and the consumer agrees to share both data points. By checking the ‘Always use this setting for this website’ option the consumer indicates that they agree to share these two specific data points with Google any time they visit the website and Google requests them. By leaving the ‘Share any profile data requested’ option unchecked, the consumer instructs the custom browser to re-issue the alert if Google requests additional or different data points on subsequent visits, so that they may decide to share any such data points requested as they deem appropriate to their relationship with Google. The consumer also leaves the ‘This website knows my identity’ option unchecked—as defined earlier, websites having no knowledge of a user's identity are third-party content providers type 130A, of which Google is an example. When the consumer selects the ‘OK’ action, Google's profile data request is processed by the custom browser, and the request is stored on the consumer node as a profile request template specifically associated with Google. Unless Google changes their profile data request on subsequent consumer visits, the consumer will not see the alert 1185 issued for Google again.

FIG. 11D illustrates the alert which the custom browser might display to the consumer visiting Amazon.com. In this example, the consumer has already visited Amazon since becoming a marketplace member and using the custom browser. The consumer has an account on record with Amazon that includes their name, address, credit card number, and other identifying information. As defined earlier, websites having knowledge of a user's identity are third-party content provider type 130B, of which Amazon is an example for this specific consumer. During a previous visit, Amazon requested the consumer's ‘hobbies’ data points, which the consumer agreed to share, after which they checked the ‘Always use this setting for this website’ option, then checked the ‘This website knows my identity’ setting and selected the ‘OK’ action which the custom browser then stored on the consumer node as a profile request template for Amazon. On the next visit to Amazon, by comparing the profile data request encoded in Amazon's home page HTML with the profile request template stored for them on the consumer node, the custom browser detects that amazon.com is additionally requesting the consumer's zip code, date of birth, income and profession, and displays the alert 1185 shown. The alert reminds the consumer that their identity is known to Amazon, that they have already agreed to share ‘Hobbies’ data points with Amazon (as indicated in the illustration by ‘Hobbies’ appearing in bold face), and enables the consumer to selectively share only those additional data points requested which they feel comfortable doing. The alert indicates that the ‘Profession’ data point requested does not yet exist in the consumer's profile (as indicated in the illustration by ‘Profession’ NOT being underlined and by its associated checkbox being disabled), as they have not yet completed a ‘Work+Career’ survey. When the consumer selects the ‘OK’ action, a new profile data request template will be saved on the consumer node for Amazon, and their request will be processed as per the sharing permissions granted by the consumer for each data point in the request.

For those websites associated with third-party content providers of type 130A, for which the consumer believes their relationship will always remain anonymous, they may at their discretion, check the ‘Share any data requested’ option, and for each subsequent visit to websites so designated, the alert 1185 will not be displayed. It is noted that an iconic or other such indicator may be displayed by the custom browser to alert consumers each time data is being requested and shared, and at their discretion, the alert 1185 can be displayed such that the consumer may review the details of the request and modify the sharing permissions they have previously granted to the requesting third-party content provider.

It is also noted that an incentive system, which shares IA billing fees with the consumer or otherwise rewards them on the basis of shared data points, may motivate them to participate in the profile maintenance and sharing process. Further, each request for a profile data point which a consumer has not yet entered, triggers a dialog with the consumer offering them the choice to enter the data point, or complete the profile survey in which the data point is collected, at that time, which would then be saved to the profiles on their node and on the marketplace servers. Every third-party content provider requesting a missing data point would thus motivate consumers to enter additional profile data and provide a timely opportunity in which to do so. It is noted that, unlike the existing practice on the web whereby users must re-enter the same data for each website which requests it, as described in the Description of the Prior Art, every website which uses the invention benefits from the automated access to any data point entered by the consumer responding to any previous website who requested the same data point.

FIG. 11E is a flowchart illustrating the profile request template process described above. Whenever a third-party content provider requests profile data during a consumer's visit to their website, the custom browser checks for templates stored on the consumer node under the third-party content provider's serial number. If none are found, the alert 1185 is displayed and the consumer grants permission to access one or more of the data points requested as described above. A record of the request, including the third-party's website URL, the requested data points, and the consumer's granted permissions are then saved to the consumer node as a template where it is used to enable future accesses by the third-party. On subsequent identical requests by the same third-party content provider, the request is processed automatically by the custom browser. Only if the custom browser detects changes in a third-party profile data request does it re-display the alert 1185 for the consumer to respond to.

It will be apparent to those skilled in the art that any third-party content provider may request profile data from any web page within their website which is visited by consumer members. Some may elect to uniformly request the same data points from all visiting consumers on their home page, while others may selectively embed their requests on other pages within their websites, appropriate to the pages' content and based on other profile data points requested and received from the current visitor.

It will also be apparent to those skilled in the art that the placement of the profile request comments at the beginning of each page's page description file enables the custom browser to act as an HTML “pre-processor”, and as such, conditionally decide whether or not to render a downloaded webpage. As an example, the addition of the ‘<MORE>’ and ‘</MORE>’ comment tags to the IA lexicon could be used to inform the custom browser that the third-party content provider, based on previously provided IA data, is simply requesting additional profile data points and that no page rendering should take place. The custom browser responds to such requests by displaying an alert 1185, as appropriate, then processing the IA request as described above, after which the third-party content provider sends an individualized webpage for the custom browser to render. Continuing the example of Google's request described above, prior to generating search results for the query ‘CARS’, they could request the data points corresponding to the visiting consumers vehicle purchase intent, purchasing history, and vehicle preferences by embedding the appropriate profile taxonomy tags within a ‘MORE’ request. If the visiting consumer previously completed the profile surveys which captured these data points, and if they agree to share them with Google, Google can use the additional consumer information to provide search results relevant to both the query—‘CARS’, and to the needs, preferences and intent of the individual consumer conducting the search.

Other embodiments are possible. As an example, using the same method described above for embedding requests in web page files, the third-party content provider 130A or 130B could request the custom browser to construct a cookie on its behalf which contains the requested data points. As the consumer navigates across successive web pages in the third-party content provider's website, similar requests embedded in each of the pages could direct the custom browser to append the cookie with additional consumer profile data relevant to the context of the web pages visited. With each new web page visited within the content provider's website, a fuller ‘picture’ of the visiting consumer would be captured within the cookie which the billed third-party content provider alone can access and exploit to customize webpage content and any embedded advertising, and to target offers and merchandise, which becomes progressively more relevant to the consumer member. When the consumer visits a different website, the customer browser erases the cookie.

It is noted that while all third-party content providers and their consumer member visitors can both benefit from intimate anonymity, the benefits become dramatic when the content provider is a search engine. As illustrated in the example above, Google can provide automated and localized search results based on the automatically accessed consumer member's zip code data point. Using a date-of-birth data point, as an example, Google could similarly provide a ‘Google for Kids’ or ‘Google for Seniors’ service with no additional intervention or action on the consumer member's part each time they use Google. Other accessible consumer data points such as personality temperament, described previously, or the consumer member's education and occupation, are just a few examples of intimate anonymity data that would enable search engines to provide results that would not only respond to the user's query, but to their style, preferences, intent and level of comprehension as well. A high concentration of relevant websites could thus be listed on the first three pages of search results, where typical users are likely to find them.

Websites, less popular with mainstream audiences, but highly popular with niche audiences would benefit from appearing early in search results based on page ranking criteria that identified the consumer's niche interests. Using the invention's method of intimate anonymity, search engines can easily and profitably upgrade their page ranking methodology from a weak collaborative filtering model to stronger one based on extensive knowledge of each user. Further, search engines, whose primary source of revenue is from selling query-related advertising on their results pages would additionally benefit from the ability to charge advertisers significant premiums for delivering highly targeted and well-known audiences—premiums which would easily underwrite the cost of fees associated with the intimate anonymity service.

Thus the method of intimate anonymity enables third-party content provider websites to access the demographic and psychographic data of anonymous consumer members visiting the websites, for the purposes of tailoring and personalizing website content and behavior, including embedded advertising content, to the demographic and psychographic preferences of the visiting consumer. Consumer anonymity, at each consumer's discretion, is absolute, and the degree of intimacy, based on the number of visitor data points requested and granted, is at the joint discretion of the two parties to the transaction.

Turning for the moment to advertiser ad agency and worthy cause members (hereinafter collectively referred to as ‘advertisers’), an advertiser may be a company, a business or an organization of any size with the need to precisely target an audience of consumers or citizens for the purposes of establishing or growing a brand, or selling a product, a service, an idea or a candidate. Examples include:
A multinational automobile manufacturer seeks to nationally market their new hybrid sports utility vehicle to environmentally conscientious consumers who need a new vehicle, who have the means to purchase or lease it, and who match the demographic and psychographic profiles identified by the company's market research as high-probability candidates for purchase.
A regional automobile dealership seeks to locally market a hybrid sports utility vehicle, and wants to follow up on the several hundred local consumers who have responded positively to the vehicle manufacturer's targeted campaign as described above.
A consumer products company wants to send incentive coupons to consumers who regularly purchase a competing brand, with the goal of motivating those consumers to try their products, and then switch brands.
A local real estate broker wants to reach the several dozen local homeowners whose finances, family size, current home characteristics and future home ‘wish lists’ make them ideal prospects for a home that just came on the market and for which the broker has secured the listing.
In an upcoming gubernatorial election, a political organization wants to target citizens living in high property tax municipalities, who are aligned with the opposing political party, with an ad campaign which communicates their candidate's property tax reform strategy.
A local chapter of the Parent Teachers Association needs to raise funds to purchase additional equipment for the computer lab, and wants to solicit contributions from the residents living in the five towns served by the regional school.
   It is noted that the examples above include entities across a broad spectrum of size—from national level to community-based—a broad spectrum of marketing objectives—from selling cars, homes and consumer goods to selling a candidate and raising funds—and includes an example of a national big business organization whose marketing efforts are coordinated and synergized with its local small business representatives in the marketplace. The methods described below enable each of the above to use the marketplace to achieve their marketing objectives.

Advertiser membership in the marketplace requires a visit to the marketplace website using a conventional web browser. Advertisers 110, ad agencies 115 and worthy causes 120 each visit a signup page specific to their membership type, where they must supply basic company and contact information, and specify a payment instrument such as a credit card, marketplace account or other such electronic funds transfer instrument.

The prospective advertiser member 110 additionally specifies their industry, and the product and/or service categories they provide to the consumer marketplace using pre-populated lists of valid industries, products and/or services, based on the published North American Industry Classification System (NAICS) codes. Upon completion of the signup process, the advertiser management engine creates an account in the advertiser database using a member serial number which includes the NAICS code corresponding to the advertiser's selection from the lists provided. Any future examination of an advertiser member 110 serial number thus provides a high level indication of their industry, and the products and/or services they offer to the public. As an example, Nabisco's serial number would include ‘311821’—the NAICS code for ‘Cookie and Cracker Manufacturer’. As another example, the member serial number for a local car dealership would include ‘441110’—the NAICS code for ‘New Car Dealers’. Agency member serial numbers would include the preset NAICS code ‘541810’, for ‘Advertising Agencies’. Advertiser and ad agency serial numbers, in a manner similar to consumer serial numbers, each includes a codified signup date and sequence number to ensure that each serial number is unique.

It is noted that NAICS codes are hierarchical and incorporate progressive levels of specificity within their coding structure. As an example, a NAICS code of ‘311’ specifies ‘Food Manufacturing’, ‘3118’ more specifically denotes ‘Bakeries and Tortilla Manufacturing’, ‘31182’ denotes ‘Cookie, Cracker and Pasta Manufacturing’, and at the most specific level of classification, ‘311821’ denotes ‘Cookie and Cracker Manufacturing’, as used in the example for ‘Nabisco’ above. The level of specificity of a NAICS code increases as the number of digits it uses increases—low specificity for a general category code uses two digits, its highest level uses six digits. For the purposes of using NAICS codes to create advertiser serial numbers, the marketplace pads each NAICS code corresponding to advertisers' selection of industry, products and services with sufficient placeholder characters to ensure a uniform six-digit code. As described in paragraph [287], the hierarchical structure of NAICS codes enables the method whereby advertisers can access competitive intelligence on the advertising activities of their direct and indirect competitors within the marketplace.

Any worthy cause organization may signup for membership in the marketplace, including large global organizations (for example ‘Greenpeace or the World Wildlife Fund), small community-based fund-raisers (for example, local PTA chapters or first-aid squads), or affinity-based websites such as blogs or those belonging to shareware or freeware organizations. Worthy cause organizations must include a payment instrument mechanism such as a credit or debit card number, or bank account number, through which the marketplace may credit funds donated by consumer members electing to do so. Further, it is the responsibility of each worthy cause organization to provide contact information in their ads, or a link within their ads to a website which provides contact information, and any other information which enables potential consumer donors to adequately assess their legitimacy and credentials prior to donating.

Upon successful completion of the signup process, advertisers, agencies and worthy cause members are directed to download and install their toolsets 400 of FIG. 4 to their respective nodes 110, 115 and 120.

In addition to enabling intimate anonymity between a third-party content provider and a single visiting consumer member, the embodiment of the invention enables intimate anonymity between advertisers and audiences of one or more consumer members sharing one or more demographic and psychographic traits.

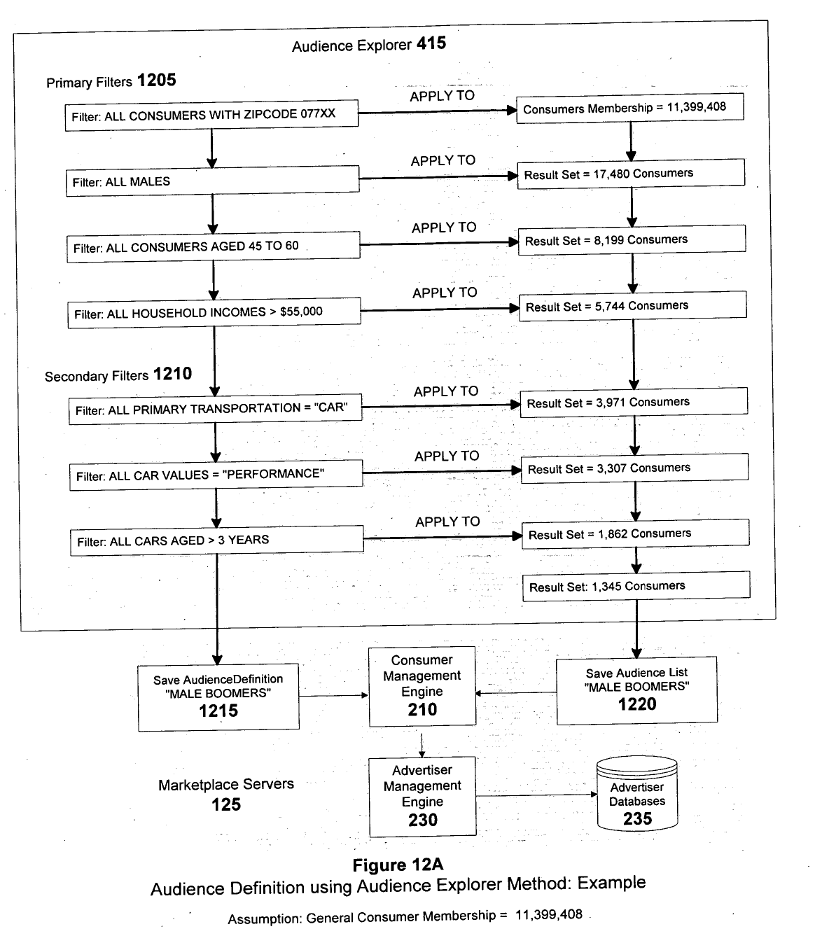

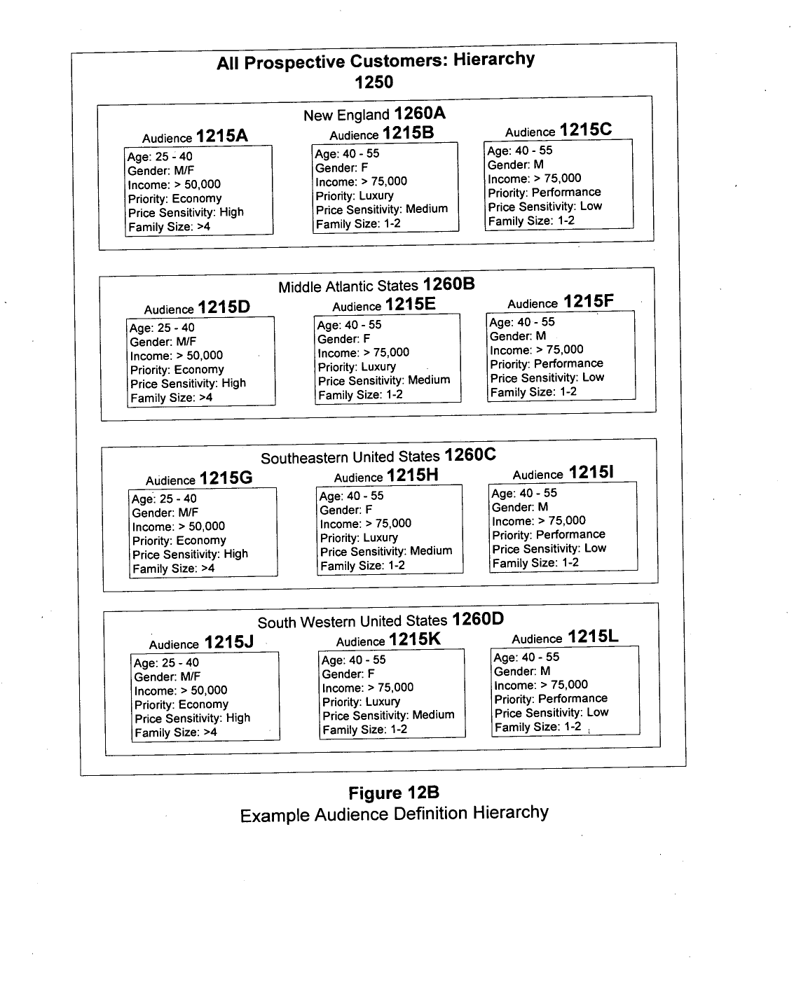

FIG. 12A illustrates the method by which advertisers can filter the marketplace's undifferentiated aggregated consumer membership into small well-defined audiences for the purposes of conducting precision-targeted ad campaigns, in accordance with an embodiment of the present invention. The audience explorer tool 415 of FIG. 4 provides a set of predefined filter categories and filters, and predefined filter values, which correspond to the taxonomy for consumer profile data described in FIG. 10B, and which additionally include a precisely articulated taxonomy for other observed and derived data including credibility data. Filter categories correspond to the category literals 1030A and subcategory literals 1035A associated with each of the profile data categories 1030 and subcategories 1035 respectively. Individual filters correspond to the profile data point literals 1040A associated with each category and subcategory pair. The predefined filter values correspond to specific values or specific ranges of values, as determined by the marketplace, which enable users of the audience explorer to best define their target audiences.

Starting with the entire marketplace population of consumer members, an advertiser selects a filter category, a filter within the filter category, then specifies a value or a range of values for the filter, and submits them to the consumer management engine 210 on the marketplace servers 125 where they are translated into the appropriate database query and applied to the consumer database 215. The consumer management engine 210 searches the consumer database 215, and creates a temporary result set comprised of a list of all consumer member serial numbers 505 whose corresponding profile data matches the filter values, then returns the number of matches found to the audience explorer tool 415 for the advertiser's consideration. Advertisers may decide to apply additional filters to the result set to more narrowly focus the audience based on other profile data point values which the consumer members in the result set have in common. With each filter applied to a result set, a newer, smaller and increasingly well-defined consumer member result set is generated.

When the advertiser is satisfied that the defined audience represents a group of consumers they wish to target, they may name the audience and request the consumer management engine 210 to save the audience definition 1215, and the result set 1220 consisting of the audience's individual member serial numbers. The consumer management engine 210 then encapsulates the audience definition and audience result set within a MSG: SaveAudience message and routes it to the advertiser management engine where it is posted to the advertiser's audience library records in the advertiser database for their subsequent use in targeted ad campaigns.

It is noted that an audience definition 1215 is a collection of named filters and filter values that may be applied by its authoring advertiser at any time to the general consumer membership to generate a current snapshot of the corresponding audience list 1220. As the consumer membership grows and the advertiser reapplies the audience definition, the corresponding audience list is likely to include more matching consumers and thus be larger as well.

In the example shown, an initial marketplace population of 11,399,408 undifferentiated consumer members is progressively filtered by an automobile dealer into a well-defined audience of 1,345 male baby-boomers living in their marketing area in central New Jersey who have the financial means, the need and the inclination to potentially purchase their luxury sports car.

As further shown in FIG. 12A, filters fall into two categories: primary filters 1205 and secondary filters 1210. There are four primary filters, namely zip code, gender, date of birth (or age), and household income. The primary filters correspond to the four demographic attributes encoded into each consumer member's serial number 505 and their application can therefore be processed quickly and efficiently. The consumer targeting process, as implemented in the audience explorer tool 415, requires advertisers to apply all four primary filters prior to the application of any secondary filters. This method, which can filter on consumer member serial numbers alone, enables the efficient and near real-time reduction of the marketplace's general consumer membership search space into significantly smaller ones, and thus improves the performance of all subsequent secondary filter processing. As shown in the example of FIG. 12A, by the time all four primary filters have been specified and applied, the result set has dramatically shrunk from the marketplace's general consumer membership of 11,399,408 consumers down to 5,744 fairly differentiated consumers.

A special category of secondary filters is provided by the marketplace to advertisers which enable them to filter audience members by their inferred credibility, that is, the inferred accuracy of each consumer's profile data and the good-faith intent of their participation in the marketplace. Advertisers may apply credibility filters at any time after completing the application of the four primary filters to further refine their result sets to include the most desirable audience members. Credibility data 520E, and its derivation by the marketplace's credibility engine 530 as originally illustrated in FIG. 5C, is described in detail in paragraph [335].

The audience explorer 415 method enables advertisers to choose the granularity or focus of their consumer audiences, and hence of their campaigns, over a continuous range, from a mass marketing focus using few filters with broadly specified value ranges, to a precisely targeted and narrow focus using many filters with tightly specified value ranges.

The marketplace assesses a targeting fee (not shown) to the advertiser for each filter which they apply. Fees are based on the number of consumer member matches listed in a result set after the application of each filter. The audience explorer, which receives the result set count from the consumer management engine as each filter is applied, displays the count and the calculated fee for each filter, as well as the sum of all filter fees assessed for the current audience definition. As an additional incentive, audience explorer fees are preferably shared with consumer members in proportion to their active and good faith participation in completing profiling surveys and in the stewardship of their personal data.

Although not shown, the audience explorer adds one additional and special purpose consumer member to every audience defined and saved by advertisers. This special purpose member, hereinafter referred to as an “audience proxy”, is a fictitious and nonexistent consumer which has been assigned the same filtered profile values as the other members of the advertiser's defined audience. The audience proxy is assigned a member serial number based on the values of the four primary filters specified by the audience definition, and a signup date and sequence number as described earlier for general consumer signup. The audience proxy member, in addition to being added to the advertiser's audience list, is also registered in the consumer databases where they become part of the marketplace's general consumer membership. The method described in paragraph [286] illustrates how audience proxies enable advertisers to observe the ad campaigns sent to their defined audiences by all other advertisers in the marketplace, including their direct and indirect competitors.

Other embodiments are possible. As an example, advertisers may complete an audience definition form in which they specify all filters and values before submitting them to the marketplace for processing—a method currently used in traditional database marketing practice. The consumer management engine would, in turn, process all filters at once and return a count of all consumer members that match the aggregate filtering criteria and a total filtering fee. The illustrated method offers several advantages:
It enables interactive filter selection and filter-value ‘tweaking’ which the advertiser, while observing each applied filter's effect, can use to better sculpt the definition of their audiences
By displaying the result set count and associated fee for each filter as it is applied, it enables advertisers to define audiences and campaigns better aligned to their marketing objectives and advertising budgets
The marketplace service can easily add new filters and new filter categories which would correspond to the profile taxonomy tags associated with new survey data points or newly observed or derived data points.

After each advertiser's audience definition is saved, the advertiser management engine sends the audience list 1220 in a MSG: MediaProfileRequest message to the consumer management engine (process not shown). Using database methods known to those skilled in the art, the consumer management engine extracts Connecting with the World survey data points from each consumer member whose serial number is listed within the message, and creates a media buying optimization report for the advertiser. As previously described in paragraph [208], the consumer member profile category Connecting with the World collects data points on consumer member's preferences and usage—and by inference, on similar consumers who are not members of the marketplace—in other venues through which advertising is delivered. The optimization report thus enables advertisers to better identify those venues through which they may reach their target audiences.

An advertiser may create and save as many audience definitions 1215 and result set lists 1220 as they wish. Audience definitions 1215 may specify completely distinct and non-overlapping target consumer groups, or they may specify a hierarchy of target consumer groups, whereby some audiences 1220 are subsets of other audiences 1220. By accommodating hierarchical audience organizations, the audience explorer 415 enables advertisers to selectively conduct ad campaigns to their entire prospective customer base, or to any subset thereof.

Using techniques known to those skilled in the art, the audience explorer tool further enables advertisers to merge and purge audiences—merging two or more audience lists containing overlapping members, and then purging duplicate entries which may appear in more than one audience list. Thus the audience explorer, through the application of zip code filters, enables a corporate-level advertiser to conduct top-down, national level campaigns, then to segment and share the audience response data to their local franchisees, retailers, and dealerships for localized follow-up campaigns. Conversely, the audience explorer enables local franchises, retailers, and dealerships to conduct bottom-up campaigns to local consumers, then share the audience response data with their regional or national corporate marketing groups where they may be consolidated (merged and purged) for marketing campaigns conducted on a broader geographic scope.

As an example, FIG. 12B illustrates an audience hierarchy 1250 as filtered by an automobile manufacturer in accordance with an embodiment of the present invention. The example shows 12 distinct domestic audience definitions with six data point filters each, which are organized into four geographical territory-segregated audiences 1260A through 1260D. The manufacturer can target all 12 audiences in a single ad campaign designed around a national purchase rebate program, which would be relevant to each audience. In another campaign which focuses on their vehicle's all wheel drive feature, the manufacturer can use the 3 audiences defined by 1215A, 1215B and 1215C in the New England territory 1260A, where the snowy weather increases its relevance. In yet another campaign which highlights vehicle luxury, the manufacturer can use the audiences defined by 1215B, 1215E, 1215H and 1215K whose profiles indicate that vehicle luxury is a key consideration in their new vehicle purchases. The automobile manufacturer, by including consumer member zip codes in their audience filtering, can selectively share their audience definitions and result set lists with their dealerships for locally and regionally specific follow-up ad campaigns.

Although not shown in FIG. 12A or FIG. 12B, the audience explorer 415 method enables advertisers to target their prospective customer audiences indirectly as well as directly, by targeting other consumer members who may influence their purchases. Advertisers can filter the general consumer membership to segregate and save their desired audience definitions, then use the household targeting feature (not shown) of the audience explorer 415 to generate lists of other members belonging to the segregated consumers' household, sorted by relationship, into one or more affiliated audiences, using database methods known to those skilled in the art, to query the household members table 660 of FIG. 6B. The family member audiences so identified, may then be targeted by advertisers with campaigns to engage their participation in influencing the primary audience members.

As an example, pharmaceutical companies have historically determined that in most families, the female spouses are the primary ‘gatekeepers’ for family health, especially for their male spouses, who pharmaceutical companies have discovered are highly reluctant to discuss health issues, and who are notoriously difficult to engage. Companies selling male pattern baldness or erectile dysfunction drugs, for example, can segregate their ideal male audience candidates using the appropriate health and personal grooming filters to segregate male member candidates, and then target their wives who are also members of the marketplace with ad campaigns which resonate with their specific needs and desires for a more virile mate. The wives, in turn, acting as marketing proxies for the pharmaceutical companies, and having the most intimate knowledge of their husbands' styles and egos, can thus engaged on the pharmaceutical companies' behalf as one of the most effective selling tools imaginable.

As another example, Disneyworld can identify consumer members whose profile data indicates a family composition which make them ideal candidates for their theme park vacations. Disneyworld can then target individualized ad campaigns to the male head of household members featuring the park's golf facilities, to the female head of household members featuring the park's beauty spas, to the teenage family members featuring the park's rides, and to the children family members featuring the park's Disney characters and events. When a family collectively marketed to in this fashion discusses vacation plans, each family member potentially acts as a decision influencer, on Disneyworld's behalf, to other family members.

It is noted that the list of consumer member serial numbers appearing in any defined audience represents a snapshot of all consumer members whose profile data matches the advertiser's audience definition at the time the definition was applied. After such time, as additional consumers join the marketplace, the defined audience list is potentially incomplete as some newly joining consumer members may also match the advertiser's audience definition. An additional benefit of using the preferred embodiment's serial number scheme, whereby consumer signup date and sequence number is encapsulated within the serial number 505, will be apparent to those skilled in the art. As any advertiser discovers an audience definition whose members perform particularly well in their ad campaigns, they can easily and quickly reapply the audience definition to the general consumer membership to include all new matching consumer members. A ‘new snapshot’ feature (not shown) in the audience explorer, can search the general consumer membership and extract out the new audience members by applying the audience definition filters only to those consumer members whose serial numbers include a signup date and sequence number assigned after the last snapshot was taken. Advertisers are thus required to pay filtering fees only on newly added audience members.

Once advertisers have used the audience explorer tool 415 to create a library of one or more well-defined audiences, they use the campaign builder 420, campaign manager 425, and campaign tracker 430 tools to define, launch and measure their ad campaigns respectively. The campaign builder 420 enables advertisers to select a defined target audience from their library of well-defined audiences, match it to an ad which the advertisers create specifically for the target audience's profile, set ad campaign parameters appropriate to the selected audience and their campaign objectives, and then to save the campaign definition for future use. The campaign manager 425 enables advertisers to select an ad campaign they have previously defined, set scheduling parameters for the ad campaign's start date and duration, and then submit the ad campaign to the marketplace servers 125 for execution. The campaign tracker 430 enables advertisers to monitor the performance of their ad campaigns in the marketplace by observing near real-time consumer member campaign responses, the methods for which are described in paragraph [271].

Campaign ad content may be in any digital format which can be rendered for viewing in existing web browsers, or downloaded for subsequent viewing using device-resident software or firmware player applications, including but not limited to:
Text (HTML)
Images (including but not limited to JPG, GIF, animated GIF, BMP)
Macromedia Shockwave and Director movies (SWF, DIR)
Video (AVI, MPEG,)
Adobe Acrobat (PDF)
Composite web page (HTML including formats listed above)

It is noted that advertisers may re-purpose ads which they had originally created for other venues such as newspapers, magazines, radio, television or the Internet, and that the invention's methods of campaign delivery and ad display, described in paragraph [281], enables advertisers to exploit their previous ad creation investments and thus improve their return on those investments.

Ads may be static or dynamic, consumer-passive or consumer-interactive, and be of any quality and length which the target audience's consumer nodes 105 are capable of downloading and displaying. As an example, advertisers can create two versions of the same 30 second video ad for two distinct target audiences who differ only in the resolution of their display devices, but otherwise share all other data point values. One version of the ad might be a low resolution format and the other might be rendered in a high-definition HDTV format, each format being optimized to the target audience's display capabilities as filtered using their node configuration profile data.

Advertisers use the campaign builder to create an ad campaign definition or template, by selecting a target audience from their library of previously defined audiences, then selecting a specific ad from their ad content library, and finally specifying the ad campaign parameters. The campaign builder supports two types of campaigns—probe campaigns, used to gauge the interest of individual members of each advertiser's defined audiences, as described below,—and ongoing relationship campaigns, through which advertisers may continuously engage audience members that previous probe campaigns have determined are interested, as described in paragraph [290].

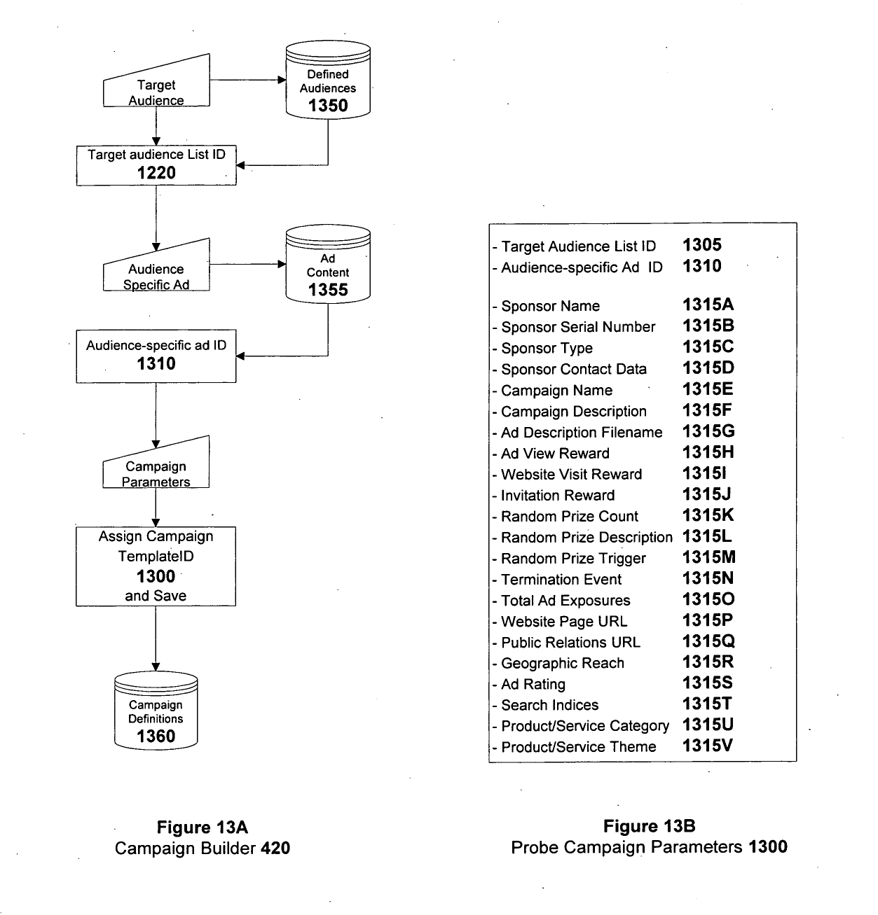

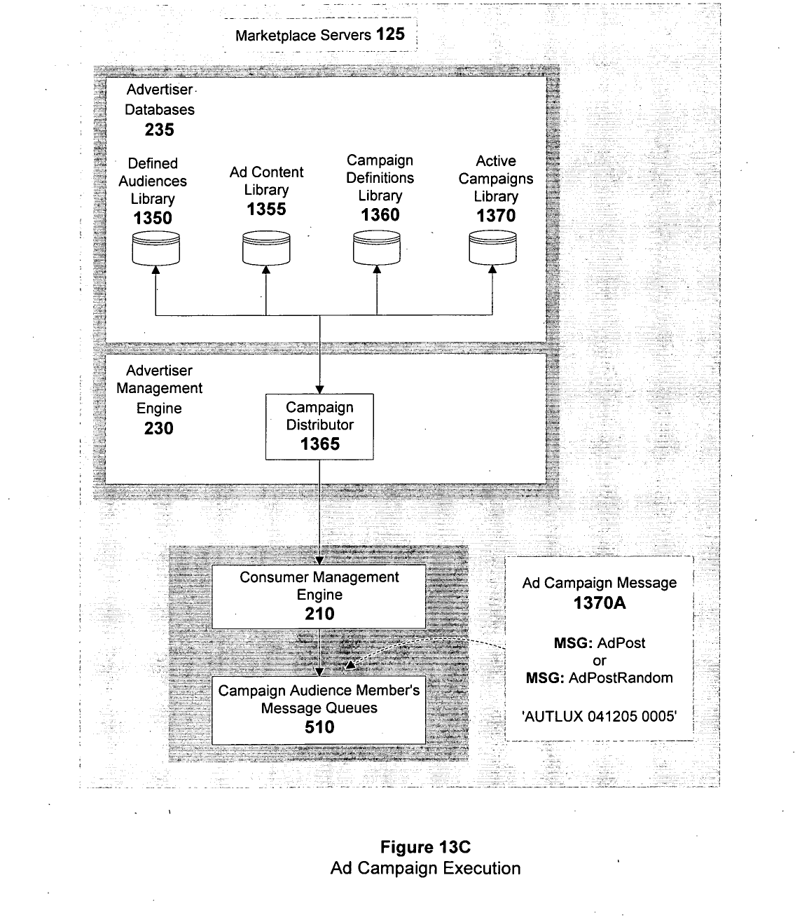

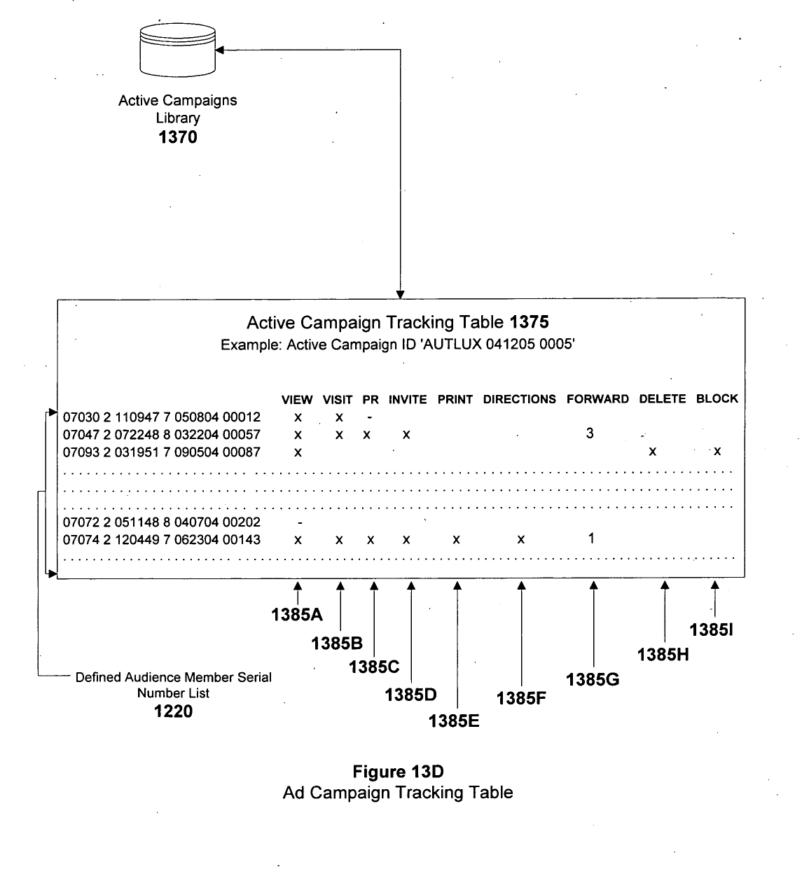

As illustrated in FIG. 13A, the advertiser selects a target audience 1220 from a list populated with audience definition names downloaded from their defined-audiences library 1350 and displayed on the campaign builder 420. The advertiser then selects an audience-specific ad 1310 from a list populated with their current inventory of ad media description files downloaded from their ad content library 1355 and displayed on the campaign builder 420. The ad content library 1355 is each advertiser's repository of ad media files (not shown) and associated media description files (not shown), and is populated and managed by advertiser 110 and worthy causes 120 members, or by ad agency members 115 acting on their behalf, using methods known to those skilled in the art. The advertiser then completes a probe campaign worksheet, through which they specify the parameters of the ad campaign. When saved, the campaign builder 420 directs the advertiser management engine to save the campaign elements 1220 and 1310 and the campaign worksheet parameters to the advertiser's campaign definitions library as a completed probe campaign definition template 1300.

FIG. 13B illustrates the details of the probe campaign definition template 1300, which includes the following parameters:
Target Audience List ID 1305: the ID of the file containing the advertiser's selected target audience as defined above which is used to distribute the campaign to the defined audience members
Audience-Specific Ad ID 1310: the ID of the ad description file and ad content file as described above
Sponsor Name 1315A: the name of the advertiser as they wish to be represented to members of the audience viewing the ad. The sponsor name is automatically set by the campaign builder 420 to the name provided by the advertiser when signing up for membership in the marketplace
Sponsor Serial Number 1315B: automatically set by the campaign builder 420 to the serial number generated by the advertiser management engine 230 when the advertiser signed up for membership in the marketplace
Sponsor Type 1315C: automatically set by the campaign builder 420 using the type generated by the advertiser management engine 230 when the advertiser signed up for membership in the marketplace. Sponsor type may have a value of ‘Nonprofit’, indicating that the advertiser is a worthy cause member 120, or ‘Profit’, indicating that the advertiser is a commercial, for-profit enterprise.
Sponsor Contact Data 1315D: the physical address (street, city, state, and zip code), telephone number, fax number, or e-mail address, or any combination thereof, if any, as specified by the advertiser, by which audience members can physically visit the advertiser's place of business, contact them for additional information, conduct purchase transactions, or any combination thereof. Sponsor Contact Information is automatically set by the campaign builder 420 to the values provided by the advertiser when signing up for membership in the marketplace.
Campaign Name 1315E: a descriptive name entered by the advertiser and by which they will reference the campaign definition in the future
Campaign Description 1315F: entered by the advertiser, a brief summary of the campaign objectives, or any other such information as the advertiser wishes to associate with the campaign
Ad Description Filename 1315G: the name of the ad description file, which in turn contains the name of the actual ad media file (i.e. the text, image, animation, audio or video file), and media file-specific data such as the media file's screen size in pixels, total play time if the media is animated, and the name of an associated audio file, if desired, for those media formats which do not support integrated audio tracks.
Ad View Reward 1315H: the amount rewarded to each consumer member for viewing the ad, as determined by the advertiser or the marketplace.

Website Visit Reward 1315I: the amount rewarded to each consumer member for visiting the advertiser's website, as determined by the advertiser or the marketplace.
Relationship Invitation Reward 1315J: the amount rewarded each consumer member for inviting the advertiser into an ongoing relationship, as determined by the advertiser or the marketplace.
Random Prize Count 1315K: the number of audience members, or a percentage of the members in an audience list, specified by the advertiser and selected at random by the marketplace, who will receive a bonus reward for interacting with the ad in some predefined way, as described below
Random Prize Description 1315L: a description of the random prize which may be monetary, a gift certificate, prepaid gameslips for use in the marketplace's game room, or other such incentive, as determined by the advertiser or the marketplace.
Random Prize Trigger 1315M: a specific ad interaction which the audience member must perform which awards the random prize, if the member has been randomly selected as described above. The trigger may be viewing the ad, visiting the advertiser's website, visiting the advertiser's specified public relation's link, inviting the advertiser into an ongoing relationship, or other such interaction as may be set by the advertiser or the marketplace
Campaign Termination Event 1315N: a specific audience member ad interaction behavior, as selected by the advertiser from a list of valid events, the occurrence of which terminates the campaign to that audience member, as described in paragraph
Total Ad Exposures 1315O: the total number of times the advertiser wishes the ad to be displayed to each audience member over the duration of the campaign unless otherwise terminated as described by the preceding parameter
Website Page URL 1315P: the Internet address of the home page of the advertiser's website, or the web address of any page within the advertiser's website which the advertiser believes is most relevant to the profile of the target audience, and which will be automatically loaded into the custom browser for viewing by audience members who choose to visit the advertiser's website. If an advertiser does not have a website, this parameter is set to “N/A” and will be so indicated to audience members when they view the advertiser's ad.
Public Relations URL 1315Q: the Internet address of any web page containing third-party information about the advertiser's products and/or services and which will be automatically loaded into the custom browser for viewing by audience members who choose to visit the specified public relation's website. The web page may be maintained internally by the advertiser on their own website (i.e. customer testimonials) or externally by the third-party itself on their own website (i.e. Ford Motor Company using a Public Relations URL to J.D. Powers & Associates website where the vehicle in Ford's marketplace ad receives a positive review). If an advertiser does not wish to use a Public Relations URL, this parameter is set to “N/A” and will be so indicated to audience members when they view the advertiser's ad.
Geographic Reach 1315R: a value selected by the advertiser from a list indicating the geographic area over which the ad campaign has relevance, for example:
   ‘Local’ indicating for a community-based advertiser (i.e. restaurant, car dealership, etc.)
   ‘Regional’ for an advertiser which normally draws its business traffic from a county- or state wide area (i.e. regional franchises, museums, theme parks, etc.)
   ‘National’ for an advertiser who conducts business across the country (i.e. nation-wide franchises, consumer goods manufacturers, web-based businesses serving the entire country, mail-order companies, etc.)
   ‘Global’ for an advertiser who conducts business globally either through a multi-location presence or via the web
Ad Rating 1315S: a value selected by the advertiser from a list indicating the suitability of the ad and the product or service being advertised, for audiences of various ages, and may be ‘Mature’ (i.e. alcoholic beverages, tobacco products, firearms and ammunition, or adult content) or ‘General’ (all other products and services)
Search Indices 1315T: used by the Living Pages 345 (as shown in FIG. 3), a list of words or phrases entered by the advertiser through which audience members who extend an invitation for an ongoing relationship can subsequently search for their ad. As an example, Outback enters their entire menu into the search indices list and enables a consumer to subsequently locate their Living Pages entry by searching for ‘steak’ or any other item on their menu. As another example, Best Buy enters their product categories and the brands which they carry into the search indices list and enables a consumer to subsequently locate their Living Pages entry by typing in ‘Sony’ or ‘camcorder’. The Living Pages tool and associated methods are described in paragraph [291].
Product Service Category 1315U: used by the Living Pages 345 (as shown in FIG. 3), a pair of values, selected by the advertiser from a set of dropdown lists, through which audience members who have extended an invitation for an ongoing relationship can subsequently locate their Living Pages entry. As an example, Outback selects ‘Restaurant’ and ‘Family’ for the value pair, and enables a consumer to find their Living Pages entry listed under those values accordingly. As another example, Best Buy selects ‘Consumer Electronics’ and ‘General’ and enables a consumer to find their Living Pages entry listed under those values accordingly. The Living Pages tool and associated methods are described in paragraph [291].
Product/Service Theme 1315V: (optional) used by the Living Pages 345 (as shown in FIG. 3), a word or phrase selected by the advertiser from a dropdown list of predefined themes through which audience members who have extended an invitation for an ongoing relationship can subsequently locate their Living Pages entry by theme. As an example, the local florist, a local band, a local formalwear rental business, a local caterer, and a local stationer, all advertiser members, select ‘Weddings’ from the list of themes and enable a consumer to find their Living Pages entries displayed together under ‘Weddings’. The Living Pages tool and associated methods are described in paragraph [291].

The use of each of the probe campaign parameters listed above are explained in further detail in the description of the consumer's ad manager starting in paragraph [282].

Upon completion of an ad campaign definition, advertisers may save it as a campaign template to their respective ad campaign definitions library 1360 in the advertiser databases residing on the marketplace servers.

Advertisers use the campaign manager 425 to launch their ad campaigns. The campaign manager enables advertisers to select a pre-defined campaign template from their respective campaign definitions libraries, and then specify the campaign's activation and expiration dates and times. Campaign durations are typically days or weeks in length. The campaign manager displays the total campaign cost, which is calculated as the per-consumer cost (a bandwidth fee based on the size of the ad media file, plus the sum of the consumer rewards for each consumer) multiplied by the number of consumers in the target audience. The advertiser approves the charges after which the campaign manager sends a MSG: CampaignLaunch message to the advertiser management engine which:
Sends the campaign charge data to transaction processor 250 as listed in FIG. 2 which updates the advertiser's account information and applies the charge to their credit card, processes an electronic funds transfer, or invoices their account
Creates and assigns an active campaign ID and creates a campaign tracking table in the advertiser's active campaign library, as described below
Executes the campaign as described below

The advertiser management engine creates the active campaign ID using codes assigned to each of the product/service category values 1315U specified in the campaign parameter template. The code pair is concatenated with the campaign activation date, and a sequence number—a counter which is incremented each time a new campaign is activated, which is reset to zero at the beginning of each day and which guarantees the uniqueness of each active campaign ID. As an example, a northern New Jersey BMW dealership uses the campaign manager to activate an ad campaign on Apr. 12, 2005 for their 500 Series vehicles, using the product/service values ‘Automobiles’ and ‘Luxury Sports Cars’. Four competing luxury sports car dealer campaigns have already been activated on that day. The advertiser management engine assigns BMW's campaign an ID of ‘AUTLUX 041205 0005’.

As illustrated in FIG. 13C, the campaign distributor 1365 accesses and executes the active campaign file from the advertiser's active campaigns library 1370. Using techniques known to those skilled in the art, the campaign distributor writes a copy of the active campaign ID in a MSG: AdPost message or a MSG: AdPostRandom into the member message queues 510 of each consumer whose member serial number appears in the campaign's associated audience list ID 1220. The campaign distributor selects, at random, a number of consumer member serial numbers from within the audience list, based on the value specified by the random prize count 1315, and writes a MSG: Ad PostRandom message into their member message queues. All other audience members receive a MSG: Ad Post message.

When consumer members log on to the marketplace, and periodically while their nodes are online, their message/queue managers 350, as listed in FIG. 3, sends the MSG: QueueQuery message (not shown) to the consumer management engine requesting any messages that the marketplace may have sent. The nodes of all consumer members whose serial numbers are included in BMW's active campaign audience list 1220 will discover and then download BMW's MSG: AdPost or MSG: AdPostRandom message along with any other messages that may be in their queues 510 respectively. When their message/queue manager 350 is ready to download BMW's ad campaign, each members node sends a MSG: DownloadAd message with BMW's active campaign ID, in the example ‘AUTLUX 041205 0005’, to the advertiser management engine, which in turn, downloads specific elements of BMW's campaign parameter file and associated ad media description and media content files to their node.

For each consumer in the campaign audience who receives a MSG: AdPostRandom message, the advertiser management engine generates a random prize serial number which it includes in the campaign parameters downloaded to the consumer node. Each such consumer receiving the random prize serial number will be immediately awarded the random prize 1315L if they interact with the ad as specified by the random prize trigger 1315M.

As shown in FIG. 13D, the advertiser management engine creates an active campaign tracking table 1375 in the advertiser's active campaigns library 1370. A copy of the audience list 1220 associated with the active campaign is used to create the tracking table which, for each consumer member in the audience, contains a record which holds their interactions 1385A through 1385I with the ad. As each audience member's node submits messages to the advertiser management engine containing their interaction with the ad campaign (as described below), their corresponding record in the campaign tracking table is updated. Advertisers, using the campaign tracker 430 listed in FIG. 4 can access summary information on any active campaign at any time to observe near-real time data on audience campaign interaction and thus assess each campaign's relative effectiveness in engaging their respective target audiences. The campaign tracker provides a user interface through which advertisers indirectly create queries against the data in the active campaign tracking table using methods known to those skilled in the art.

Although not shown, advertisers may use the audience explorer 415 and the campaign tools 420, 425 and 430 to test market different ads. As an example, an advertiser may load one of their well-defined audiences from their library, and then ask the audience explorer to segment the audience into one or more test audiences, whereby consumer members included in the original audience are randomly assigned to one of several test audiences. The advertiser may then send each test audience a variation of the same campaign, and based on the responses of each test audience, as displayed by the campaign tracker, identify the most effective variation of the campaign, which they can subsequently send to all audiences. Thus the invention enables advertisers to essentially use consumer members as virtual focus groups who can assist the advertiser in sculpting their campaign strategies.

The audience explorer 415 and campaign builder 420, in combination, enable advertisers to replace ‘one-size-fits-all’ ads which are broadcast to undifferentiated mass audiences with a collection of finely tuned ads each designed to optimally resonate with their respective well-defined audiences. The campaign tracker 430 enables advertisers to measure the extent to which they have succeeded in defining their audiences, crafting their messages, and matching messages with audiences, and thus provides them with the metrics required to recalibrate their ad campaign strategy as necessary to achieve a superior return on investment of their advertising dollars.

The methods of the invention by which advertisers can precisely define and selectively engage audiences with highly tailored ad campaigns, further enables them to incorporate differential pricing models into their marketing strategies. Using audience profile data to define audiences by household income, median income by zip code, product need, and purchasing priorities and histories, advertisers can make educated guesses about the price sensitivity of each target audience and advertise different prices for their goods to each audience accordingly.

The account manager 410, using methods known to those skilled in the art, tracks advertiser's campaign transactions with the marketplace including but not limited to:
Audience Explorer-related fees assessed for the self-service filtering of the general consumer membership into well-defined audiences
Campaign execution fees assessed for bandwidth usage and audience member incentives
Survey sponsorship fees
Pay-for-performance rebates issued at campaign expiration

To enable the immediate awarding of consumer member incentives in accordance with the embodiment of the invention, as described later in this section, all fees assessed are charged to the payment instruments of advertisers, agencies and worthy causes as they are incurred.

The ad viewer 440 in the toolset 400 listed in FIG. 4 enables advertisers to view the ads of all campaigns executed in the marketplace whose targeted audiences include their audience proxies, as originally described in paragraph [247]. The advertiser's ad viewer, a reduced functionality version of the consumer's ad manager 325, is described in greater detail in paragraph [282].

The agency manager 435 provides a means for advertisers and worthy causes to easily collaborate with the ad agencies they may engage to conduct marketplace-based ad campaigns on their behalf. Via the inbox 405 in the tools 400, the agency manager enables the password-secured exchange of audience definition, campaign building, campaign execution and campaign tracking data. Using methods known to those skilled in the art, predefined email templates are programmatically populated with data elements representing audience definitions, campaign parameters and cost data, and active campaign tracking data, as necessary to enable coordination and collaboration of marketplace-based campaign activities between advertiser and worthy cause members, and their ad agencies.

At the conclusion of each ad campaign, as determined by the expiration date specified by the advertiser through the campaign builder 420, the unrewarded balance of the prepaid campaign fees are returned to the advertiser's account. Advertisers' may apply any outstanding account balance towards subsequent campaign costs, or they may request their balances be credited to the payment instrument originally used to fund their accounts.

Returning to the consumer, any MSG: Ad Post messages retrieved by the consumer node are routed to the ad manager 325 which in turn sends a series of MSG: Download messages back to the consumer management engine requesting each ad campaign, including the ad content file, to be downloaded for local storage in the consumer node's ad inventory directory (not shown). As each campaign is successfully downloaded, its corresponding message in the consumer's message queue 510 on the marketplace servers is deleted, and thus any interruption in the download process can be resumed when the connection between the consumer node and the marketplace servers is restored.

A benefit of the invention's fat client architecture is that it enables the downloading of high quality ad media files of significant size with no consumer experienced delays. Media downloads to the consumer node are executed by the ad manager as a background task. Thus consumers may surf the web or use their nodes for non-marketplace related purposes while their ads are downloaded, and then experience ad playback at disk-retrieval or flash memory-read speeds which are fast enough to deliver DVD-quality video performance.

The ad manager on the consumer node examines each campaign data file and using the campaign activation and expiration dates contained within, enters each campaign into the node's ad display schedule as appropriate. When each ad campaign's respective activation data and time occurs, the ad manager inserts the campaign's local ID into its ad queue (not shown). The presence of one or more ads in the ad manager's queue trigger's a process in the message/queue manager which displays a notification to the consumer that they have received a targeted ad. Since the message/queue manager is always running in the background, the consumer receives the alert regardless of their activity at the time. If they are currently accessing the web through their custom browser, the alert may be issued through a blinking icon appearing on the browser. If they are currently using another local application, the alert may be issued through a blinking icon appearing on the operating system taskbar or other such screen location as appropriate to the node's configuration.

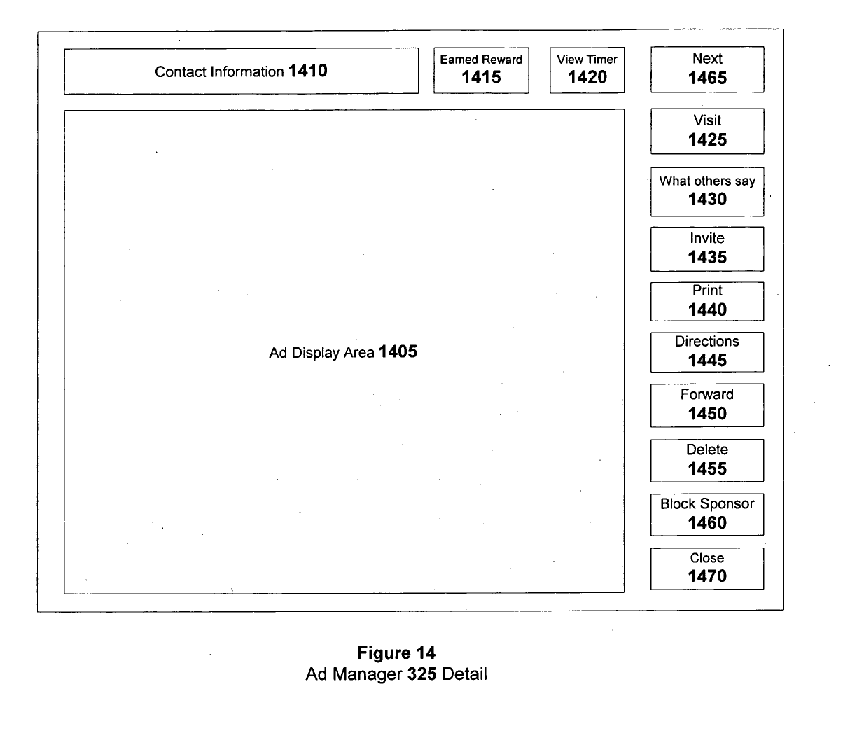

If the consumer elects to view the ad, the ad manager's viewer is loaded and the ad is displayed as illustrated in FIG. 14. The ad manager 325 occupies the entire viewable area of the consumer node's display device and consists of an ad viewing area and other informational elements and function buttons as described herein. Information contained in the campaign data file and the ad content file format collectively determines the actual appearance of the ad manager as follows:
Contact information 1410 displays the Sponsor Name 1315A and Sponsor Contact Data 1315D as entered by the advertiser in the campaign parameters file.
Earned Reward 1415 displays a running total of the rewards earned by the consumer as they view and interact with the ad, as described below. If the Sponsor Type is ‘NonProfit’, then no rewards are offered and the earned reward 1415 is not displayed.
The View Timer 1420 initially displays the total Ad Play Time as specified in the campaign data file, and then displays a countdown or other visual indicator of the progress of the ad as it plays. The consumer earns a fraction of the Ad View Reward 1315H, prorated to the ratio of the time viewed to the total Ad Play Time. As an example, if the Ad View Reward is 20 cents, and the ad content file contains a 30 second video, then the consumer will earn 10 cents for viewing 15 seconds of the ad and will earn 20 cents for viewing the entire ad. Consumers may replay the ad as many times as they wish but the Ad View Reward can only be earned once for each ad displayed. By initially displaying the total ad play time, the ad manager informs the user of the time commitment required to view the entire ad, thus empowering them to opt out if they choose to do so.

The Ad Display Area 1405 is where the ad media itself is displayed. If the ad is dynamic, specifically if it is an animation or a video, or if it contains an associated audio file, then the ad loads in the paused state at frame zero or at the beginning of the audio track respectively. Specific consumer actions, depending on the nature of the programmable electronic device serving as the consumer node 105, control the playing of the ad. As an example, a consumer using a typical personal computer equipped with a mouse plays the ad by moving the mouse pointer over the ad display area 1405, while moving the mouse pointer off of the display area will cause the ad play to pause. As another example, a consumer using a cell phone plays the ad by pressing one or more keys on the cell phone and pauses the ad by pressing them a second time. As ads are played or paused, the view timer 1420 and earned reward 1415 are adjusted accordingly.
The ‘Visit’ action 1425, when selected, loads and overlays the custom browser, and displays the website page whose address is specified in the campaign data file as Website Page URL 1315P. If the advertiser does not have a website or has otherwise omitted this parameter, the visit button is not active. If the consumer selects this action, a timer (not shown) is activated which captures the elapsed time and page address for each page visited within the specified website, and the total elapsed time of the visit to the website, which are recorded on the consumer node for subsequent summarization and submission to the marketplace servers. The consumer earns the Website Visit Reward 1315I, as specified in the campaign data file, and the earned reward indicator is adjusted accordingly. Consumers may select the Visit button any number of times during the display of the current ad, but the Website Visit Reward is earned only for the first such visit. When a consumer is finished visiting the website and closes their custom browser, the ad manager 325 reappears.
The ‘What Others Say’ action 1430, when selected, loads and overlays the custom browser and displays the website page whose address is specified in the campaign data file as the Public Relations URL 1315Q. If the advertiser omitted this parameter, the button 1430 is not active. If the consumer selects this action, a timer (not shown) is activated which captures the elapsed time and page address for each page visited within the specified website, and the total elapsed time of the visit to the website, which are recorded on the consumer node for subsequent summarization and submission to the marketplace servers No rewards are issued for visiting public relations websites, and thus, when members elect to do so, the marketplace considers the behavior as an indicator of a genuine interest in the advertiser's products or services, which may infer good-faith participation in the marketplace. When a consumer is finished visiting the public relations website and closes their custom browser, the ad manager 325 reappears.
The ‘Invite’ action 1435, when selected, copies the ad media file and selected parameters from the campaign data file into the consumer node's Living Pages storage directory (not shown) which implicitly extends an open invitation for an ongoing relationship to the advertiser, as described later in this section. The consumer earns the Relationship Invitation Reward 1315J, as specified in the campaign data file and the earned reward 1415 is adjusted accordingly. Once the consumer selects this button, it is deactivated and does not function again for the duration of the current ad display.
If the Sponsor Type 1315C is ‘Nonprofit’, as specified in the campaign data file, then the ad is from a worthy cause member 120 and the ‘Invite’ button 1435 is replaced by an ‘Adopt’ button, (not shown). When selected by the member, the Sponsor Serial Number 1315B and Sponsor Name 1315A are copied into the consumer node's ‘Adopted Worthy Causes’ storage directory (not shown). Consumers may subsequently donate any or all of their rewards on a one-time or regularly scheduled basis to any worthy cause organizations whom they have previously adopted. As described later in this section, donations to worthy causes are monitored and analyzed 1005b by the Profile Manager 320 on each consumer node, and are used as an indicator of member credibility.
The ‘Print’ 1440 and ‘Directions’ 1445 actions, when selected by the consumer, enables them to print the Sponsor Name 1315A and Sponsor Contact Data 1315D, and to view a map of directions to the advertiser's physical storefront, if specified, respectively. If the advertiser has omitted a physical address, then the directions button is deactivated. If active, the ad manager 325 creates an HTTP query string using the address data supplied and submits the query string to an Internet-based map website such as MapQuest.com, Yahoo.com Maps, or MultiMap.com using methods known to those skilled in the art. No rewards are issued for printing an ad or requesting directions and when consumers elect to do so, the marketplace infers genuine interest in the products or services advertised, and as an indicator of their good-faith participation and credibility in the marketplace.
The ‘Forward’ 1450 action, when selected by the consumer, embeds the Sponsor Name 1315A, Sponsor Contact Data 1315D, the Website Page URL 1315P—if any, Public Relations URL 1315Q—if any, campaign serial number, and the consumer's unique referral code into an email template. The consumer may enclose a personal message, specify a subject line, and then enter an Internet email address of a family member, friend, or colleague. When the consumer confirms the forward action, the populated email template is sent via a MSG: Forward message to the consumer management engine on the marketplace servers for processing, and the recipients email address is saved on the consumer node in an address directory (not shown).
The consumer management engine creates a temporary forwarding record in the consumer member's account 515 which includes the recipients email address, the date and time of the forward, and a pending status flag. It then embeds several hyperlinks into the email template—the URL of the marketplace website homepage and an email address which processes marketplace-specific anti-spamming requests, and inserts a copy of the ad media file, after which it sends the email to the recipient.
The recipient may view the ad, and then click on the website address hyperlink in the forwarded email to visit the marketplace. If they view the marketplace tour's web pages, the sending consumer's referral code is saved to their web browsing device as a cookie. If they subsequently join the service, the consumer sign-up page retrieves the cookie, if any, and pre-populates the referral code field as described earlier in the consumer sign-up process, and the prospective member completes their sign-up process, also described earlier.
The recipient of the forwarded email may click instead on the anti-spam hyperlink which sends a return email to the consumer management engine's anti-spamming process, requesting that they do not receive any further forwarded emails from the sending member. The consumer management engine, in turn, sends a MSG: ForwardBlock message to the sending member's node which had previously stored the recipients email address. Using methods known to those skilled in the art, the sending members ad manager sets a ‘NoContact’ flag on the recipient's address in the member's address directory, will no longer accept the recipients address in any subsequent forward actions by the consumer, and informs them of the recipient's wish not to receive additional forwards should the consumer attempt to do so.
The forwarding method of the invention thus enables existing consumer members to act as viral agents on behalf of the marketplace, while limiting their ability to spam. Since email addresses must be manually entered into the forwarding function, and since the function can be blocked by recipients, abusing the intent of the service requires an unreasonable effort on the consumer member's part. Further, the consumer management engine can track the ratio of forwards blocked to total forwards sent for each consumer member and if a predetermined threshold is exceeded, a warning can be automatically sent to the consumer member's message queue where it will be routed to the inbox 310 on their consumer node, said warning informing the member that their forwarding function will be disabled, or they will otherwise be penalized if they continue to abuse the spirit of the marketplace's anti-spam policies.
The ‘Delete’ action 1455, when selected by the consumer, erases the ad campaign from their ad queue and their ad inventory directory, and generates an automatic terminate event which ensures that they will not see the balance, if any, of the total ad exposures specified in the campaign parameters 1315.
The ‘Block’ action 1460, when selected by the consumer, saves the Sponsor Serial Number specified in the campaign parameters 1315 to a blocked-sponsors file on their consumer node. A MSG: SponsorBlock message is then sent to the advertiser management engine which automatically removes the consumer's serial number from the ad campaign's target audience list. Any future ad campaigns received by the consumer from an advertiser whose Sponsor Serial Number has a blocked-sponsor entry in the file automatically triggers a terminate event, and the campaign will not be executed on that consumer's node. Using the audience explorer 415, the advertiser may recapture and retarget the blocking consumer's serial number in a new audience definition, but the sponsor's entry on the consumer node's blocked sponsors file will continue to trigger the terminate event and send a MSG: SponsorBlock message which removes their consumer serial number from the audience list each time they do so.
The ‘Next’ action 1465 is active if there are one or more ads in the ad queue. When selected by the consumer, their ad interactions for the currently displayed ad are sent in a MSG: AdResponse message to the advertiser management engine 230 (via the message queue manager on the consumer node), which updates the campaign's tracking table 1375, and the next ad in the queue is displayed. A copy of the ad interaction data is also saved to the ad interaction data file 1025 of FIG. 10A for subsequent analyses as described in paragraph [271].
The ‘Close’ action 1470, when selected, terminates execution of the ad manager 325 tool.

It is noted that items 1425 through 1470 may be Graphical User Interface elements commonly known as ‘command buttons’ and appear on the consumer's screen as images, or said items may be actual and physical keys appearing on the input devices of the consumer node 105 which are programmatically assigned the functions as described above.

The advertiser's version of the ad manager, the ad viewer 440 (not shown), is a reduced functionality version of the consumer's ad manager 325—it displays ads and all sponsor-related, campaign-related, and ad media file-related data, but does not dispense rewards or capture any ad interaction data.

The audience proxy member, described earlier, enables each advertiser to view all ad campaigns that have been distributed to any of their defined audience's proxy member's message queue 510, which includes their own campaigns, and the campaigns of all other advertisers who have used the audience explorer to define their own respective audiences, and whose definitions have filtered in the advertiser's audience proxy. As an example, BMW, in defining a target audience, causes the audience explorer to petition the consumer management engine to create an account and profile entry for the audience's proxy member on the consumer databases 215. If Infiniti subsequently uses their audience explorer and defines a similar enough target audience, BMW's audience proxy member serial number will be included in Infiniti's defined audience list 1220. Any ad campaigns executed by Infiniti to their own target audience so defined will post a MSG: PostAd campaign message from Infiniti into BMW's audience proxy member message queue 510. The ad viewer, to function, requires each advertiser to select one of their defined audiences by name, after which the ad viewer will retrieve all MSG: PostAd messages which have been posted to the specified audience's proxy member's message queue, and which will include their own ad(s) and the ad(s) sent by all other advertisers to the audience proxy. The advertiser toolset will then download the ads specified within each MSG: PostAd message and display each of the ads as described above.

The advertiser and ad campaign serial numbers, both included in every ad campaign parameter file, additionally enables each advertiser to specifically view only those ad campaigns originating from direct and indirect competitors. As previously described, the advertiser serial number contains an embedded NAICS (North American Industry Classification System) code which describes the advertiser's business, products and services. The ad campaign serial number contains encoded product or service category tags which provide more specific category information. The ad viewer 440, through a set of dropdown lists containing predefined industry, product and service categories, enables advertisers to define the range of competing ads received by their proxy audience member which they want to view. As an example, Blockbuster Video may elect to view only those ads sent to their audience proxy from direct competitors such as Hollywood Video and NetFlix, whose advertiser serial numbers will include identical NAICS codes embedded within, and whose ad campaign serial numbers will include identical category codes, similarly embedded within. Alternately, they may broaden the competitor definition to include ads from additional sources of video entertainment such movie theaters and cable television channels. By broadening the definition yet again, they can include all ads sent to their audience proxy by any marketplace advertiser. Each selection of dropdown list values uses the corresponding industry, product/service category codes, and NAICS codes, with wildcards as indicated, to identify matching ad campaigns received by their audience proxy.

Optionally, each advertiser may also request their toolsets, using techniques known to those skilled in the art, to generate a visible or audible alert each time any of their audience proxy members receive an ad from any of their direct or indirect competitors, as specified using the method above. The ad viewer thus provides near real-time competitive business intelligence for each audience they have defined, and enables each advertiser to adjust their marketplace advertising strategy accordingly.

Each consumer's interactions with an ad are captured by their ad manager and are posted to the advertiser's campaign tracking table 1375 of FIG. 13D as follows:
If the consumer views the ad in its entirety, the VIEW flag 1385A is set to ‘TRUE’
If the consumer selects the VISIT action, the visit flag 1385B is set to ‘TRUE’
If the consumer selects the WHAT OTHERS SAY action, the PR flag 1385C is set to ‘TRUE’
If the consumer selects the INVITE action, the INVITE flag 1385D is set to ‘TRUE’
If the consumer selects the PRINT action, the PRINT flag 1385E is set to ‘TRUE’
If the consumer selects the DIRECTIONS action, the DIRECTIONS flag 1385F flag is set to ‘TRUE’
Each time the consumer selects and completes a FORWARD action, the FORWARD counter 1385G is incremented
If the consumer selects the DELETE action, the DELETE flag 1385H is set to ‘TRUE’
If the consumer selects the BLOCK SPONSOR action, the BLOCK flag 13851 is set to ‘TRUE’

A feature (not shown) of the audience explorer tool enables advertisers to segregate their defined audiences into new sub-audiences using ad interaction response values as filters. The audience explorer's merge and purge feature (not shown), further enables advertisers to merge two or more audiences so segregated from different ad campaigns and purge any duplicates member serial numbers. As an example, an advertiser can segregate all audience members who extended invitations into their Living Pages, from multiple campaigns, then merge them into a new audience for purposes of conducting a subsequent Living Pages campaign, described below. The invention thus provides advertisers with the tools to filter and define audiences of anonymous consumer members based on their profile data and on their exposures and their responses to the advertiser's previous ad campaigns. Audiences so defined enable each advertiser to design a staged series of campaigns, each of which benefits from the knowledge of previous audience exposures, and each of which can progressively move the audience members closer to a purchasing decision.

The consumer Living Pages 345 provides each consumer with a personalized ‘Yellow Pages™-type directory, using the ads and associated parameter files in the Living Pages storage system, saved when the consumer extended relationship invitations to advertisers as previously described. After initial consumer signup for marketplace membership, the installer program creates a filing system appropriate to the consumer node configuration, where Living Pages entries will be stored, and initializes the directory with zero entries. As the consumer extends invitations to advertisers, their Living Pages becomes populated with entries for products and services for which they have an explicitly declared interest or need, and from advertisers with whom they have demonstrated an affinity. Unlike the traditional Yellow Pages™, each copy of which is populated with every product and service category, and each category of which is populated with every advertiser, the Living Pages empowers consumers to build an individualized directory containing only products, services and companies of direct relevance and perceived value to them. Over time, each consumer's Living Pages becomes a unique picture of the needs, interests and purchasing intent of its respective creator.

Using their Living Pages, each consumer can search its contents using advertiser name 1315A, any of the search indices 1315T, product/service category values 1315U, or product/service theme 1315V specified by the advertiser when creating the original ad campaign template 1300, as previously described. Consumers can additionally filter the search results by specifying the geographical scope of the entries as specified by the geographic reach 1315R. Using methods known to those skilled in the art, the Living Pages application can build a search results list from the data in the Living Pages directory to isolate those entries which match the criteria specified by the consumer, then compose one or more pages which display the associated media files and sponsor contact data 1315D.

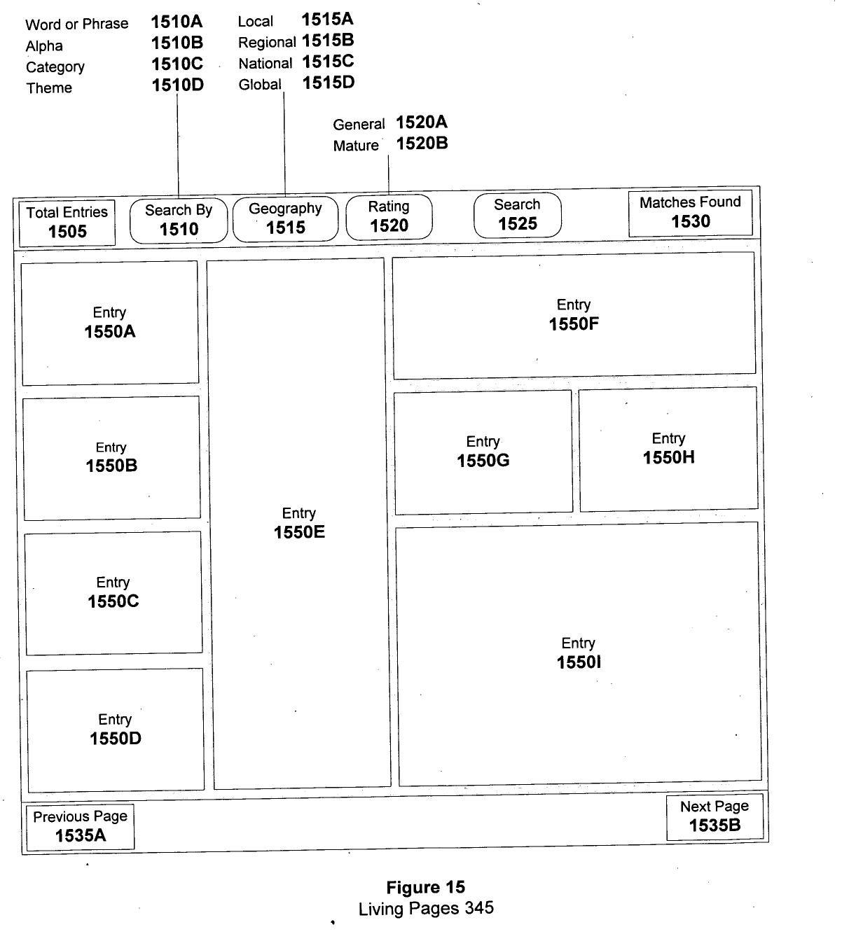

FIG. 15 illustrates the Living Pages application display and example entries. The total entries counter 1505 displays the total number of entries, and therefore the number of relationship invitations extended by the consumer. The search by action 1510 enables consumers to specify a search by word or phrase 1510A, by first letter of advertisers' names 1510B, by product/service category values 1510C, or by theme 1510D. The geography action 1515 enables consumers to limit search results matching local 1515A, regional 1515B, national 1515C or global 1515D geographic reach. The rating action 1520 enables consumers to display entries matching general 1520A or mature only 1520B ratings. The previous and next page actions, 1535A and 1535B respectively, enable the consumer to browse the search results when the number of matching entries requires more than one screen page to display.

Also illustrated in FIG. 15 are examples of Living Page entries 1550A through 15501, as might be displayed in response to a consumer search. As shown, each entry's media file may be one of several standard screen sizes, in a fashion similar to the standards used in newspapers and Yellow Pages™ directories. For example, entries may be 1/16^{th} of a page, or multiples thereof, up to a full page (not shown). Using techniques known to those skilled in the art, the Living Pages application dynamically composes each results page using a ‘best fit’ algorithm to optimally display all matching entries. Each entry's initial media file is a copy of the media file from the probe campaign in which the consumer originally extended the invitation to the advertiser, and may therefore be any of the formats as described in paragraph [258].

Living Pages are dynamic—in addition to playing animated and video ads in response to consumer actions, entry media files can change each time the consumer accesses their Living Pages. When a consumer saves a probe ad to their Living Pages, they are explicitly extending an open and ongoing invitation to the probe ad's advertiser to update their entry in the Living Pages at any time, without further permission. As previously described and as illustrated in FIG. 13D, audience ad interactions are tracked for all active ad campaigns. At the expiration of an ad campaign, advertisers may use the results captured in the probe campaign tracking table 1375 to further segment the campaign's target audience using their ad interactions as filters. Advertisers may segregate those audience members who have extended an invitation for an ongoing relationship and save them to their defined-audiences library, as a new and separate named audience list. Using the campaign builder, they may create and launch subsequent relationship campaigns which are published directly into the Living Pages of the members represented in the new audience. Relationship campaigns replace the advertiser's previous entry with the new one specified in the relationship campaign worksheet, and are distributed to audience members message queues using the techniques described above for probe ad campaign distributions.

Like permission-based email, the Living Pages enables advertisers to maintain ongoing campaigns to consumers who have demonstrated an interest and willingness to participate. Unlike permission-based email, the Living Pages does not know the identity of target audiences and cannot be abused or spammed. The Living Pages also differs from permission-based email in that email marketing relies on a text headline appearing in the email inbox of each recipient to capture their attention. As cited in a prior section, email is so abused by spam that most consumers tend to ignore or block email which has originated from an unknown party. In contrast, the Living Pages displays each advertiser's entry in whatever multimedia format they choose, and can play any associated media file without any consumer-experienced delay. Each Living Pages update assesses the advertiser a per-member fee, a portion of which is shared with each consumer member receiving the update.

Advertisers may update their Living Pages entries with new ads having different content, using different media, and which may be a different size than the entries they replace. As an example, an advertiser's probe ad, which became its first entry in the Living Pages as a result of a consumer invitation, may have been a static image media file whose size was equivalent to the 1/16^{th} page entry shown by example as 1550A in FIG. 15. The advertiser may subsequently replace the entry, using a relationship campaign to target those consumers who extended an invitation, with a 60 second high-quality, full-page (not shown) or ¼^{th} page video file, with CD-quality audio, as might appear in the example slot 1550I of FIG. 15.

The inventions method of targeting ads to consumers offers significant benefits over existing Internet-based adverting models:
Compared to the relatively superficial targeting offered by search engine marketing and ads appearing on third-party websites, the invention enables advertisers to precisely target prospective customers, based on extensive demographic, psychographic, and other highly predictive collected, derived and inferred data. The invention, by virtue of the absolute anonymity provided to consumer members, enables a breadth and depth of profile data which identified consumers would otherwise never provide and thus makes available to advertisers consumer data points having extraordinary targeting value which are unattainable through current practice.
Compared to superficially targeted ads, which by virtue of their potential irrelevance tends to condition users to ignore them, the invention demonstrates to each user that the ads they receive are individually targeted using their stated interests and needs, and by highly relevant demographic and psychographic factors which they themselves control. Further, by enabling consumers to delete and block ads, the invention empowers consumers to control the display of ads directly and immediately, and provides closed-loop feedback to advertisers which will influence the ads they will be sent in the future.
Compared to search engine marketing and other pay-per-click venues, the invention is relatively immune to click-fraud. Whereas unqualified users can repeatedly click on search engine ads and drive up advertiser costs, the invention enables advertisers to display their ads to highly-qualified consumers, to limit the number of times they are displayed to each consumer, and thus control their total cost exposure. Further, as described in paragraph [335], the marketplace observes consumer interaction with the ads they receive and captures data which infers abusive or mercenary behavior, and provides access to such ad interaction data to advertisers in the form of audience filters. The invention thus enables advertisers, a priori, to filter out such consumer members before they have the opportunity to impact the advertiser's pay-per-click costs.
Compared to the ad targeting capabilities inherent in search engine, portal, and special interest website models, the invention offers a significantly better venue for small business advertisers. Audiences can be precisely defined, qualified, and targeted by specific zip codes. As in the examples cited above, a local real estate broker can identify and target as few as several dozen, highly qualified prospects with campaigns, and the local chapter of the PTA can target only those consumer members living in the handful of zip codes services by the local school system.
The invention's precision-targeting method enables advertisers to reallocate their ad expenditures to achieve exceptionally high returns-on-investment. Dollars traditionally spent on the mass marketing medium distributing their messages to undifferentiated consumers can instead be focused on inciting the interest and active participation of highly differentiated and well qualified consumers. The economics of mass marketing, which made sense decades ago when the limited number of venues created a high demand, and the supply of consumer attention was assumed to be limitless, are replaced by a new economic model which reflects the virtually limitless supply of venues and very limited supply of consumer attention.

The inventions method of displaying ads offers significant benefits over existing Internet-based advertising models:
Unlike other Internet-based advertising models, the invention does not force ads to compete with other content, for example, search engine results and website content, for either the consumer screen display area or the consumer's attention. The invention's ad manager method ensures that the screen display area is dedicated to the display of ads, and promotes consumer attention by eliminating any competing content when ads are displayed.
Unlike other Internet-based advertising models which download ads while the user waits, the invention downloads ads as a background process to which consumers are unaware. The limitations imposed by the patience of users waiting for downloads, and their impact on the size, length and quality of ads delivered, are thus eliminated completely by the invention.
The invention's method of randomly embedding awards within ads, which consumers may win for various ad interactions, in essence turns each ad into a drawing. Every probe ad has one or more random awards which one or more selected audience members are guaranteed to win should they interact with an ad as specified by the marketplace or by the advertiser. The precision targeting method of the invention encourages advertisers to target relatively small, well-defined audiences, and thus each consumer member will appreciate that their odds of being one of the winners chosen at random are relatively favorable. Since audience members never know which ad interaction triggers the random award, but that they are eligible to win with every ad they receive, an element of excitement may be associated with their active participation in the advertising process of the marketplace.

The charging of fees to advertisers and agencies for various advertising services, and to third-party content providers for their use of the intimate anonymity service, generates multiple and recurring revenue streams, which underwrites the marketplace's system of direct and indirect incentives to consumer members. Further, the method of pre-charging advertiser, agency and third-party content provider accounts, which they draw down as they use the services, insures that the marketplace holds no receivables, can accumulate no bad or delinquent accounts, and that the marketplace can award incentives to consumers instantaneously, as they earn them. Whenever an advertiser, agency or third-party account becomes depleted, their use of the marketplace services is simply suspended until they recharge their accounts.

The method of awarding incentives to consumers provides them with instantaneous gratification in proportion to their active and good faith participation in the marketplace. Direct incentives are awarded immediately for certain actions or events and are generally used to reward consumers for supplying and sharing profile data, and for their participation in the advertising process:
Each time a consumer is filtered into an advertiser's well-defined audience, a percentage of the audience explorer fees assessed are credited to their account, such credit occurring when the advertiser saves their audience definition.
Each time a consumer node downloads a probe ad campaign, a percentage of the bandwidth fee charged to the advertiser or agency is credited to their account
Each time a consumer member interacts with a probe ad campaign, the award associated with each specific ad interaction is credited to their accounts
Each time a consumer member receives a Living Pages entry update, a percentage of the bandwidth and entry size fees charged to the sending advertiser or agency is credited to their account
Each time consumer grants intimate anonymity permission, a percentage of the fees charged to the third-party content provider is credited to their account
If a consumer is one of the prize winners selected at random from the audience of each probe ad, as previously described, they may win additional cash which is credited to their account.

Indirect incentives are also awarded immediately and are generally used to reward behaviors which benefit the marketplace and its advertiser, agency, worthy cause and other consumer members. Indirect incentives are in the form of prepaid gameslips and may be awarded for each such behavior in bulk (for example, 250 gameslips), as an ongoing annuity (for example, 5 gameslips a day for the life of a referred consumer member's active membership), or as some periodic number of gameslips calculated on the level of activity and participation of the referred member. Examples of indirect incentives include:
For each new consumer member recruited, either through the probe ad's forward mechanism, or by direct word-of-mouth, as demonstrated by the referral number entered at signup, the referring consumer member may receive prepaid gameslips
For each family member recruited, as specified during signup, the referring member may receive an additional bonus of prepaid gameslips
For each survey completed, a consumer member may receive a bonus of prepaid gameslips
For each profile category in which all included surveys are completed, a consumer member may receive an additional bonus of prepaid gameslips.

Consumer members may use their prepaid gameslips in the gameroom 335, as originally listed in FIG. 3. The gameroom is a virtual environment where consumer members participate in games-of-chance for the opportunity to win cash prizes which are underwritten by a percentage of revenues allocated for such purposes by the marketplace.

The awarding of direct incentives, the sale by consumer's of their own original digital content described in paragraph [305], and any winnings they may win in the marketplace-operated games-of-chance, in essence, continuously funds each consumer member's account on an ongoing basis, and enables them to:
Rent or purchase digital content from content-providers using the marketplace as described in paragraph [305]
Make donations to worthy causes they have elected to adopt, as described in paragraph [327]
Transfer some or all of the funds in their member accounts anonymously from the marketplace, and to a credit, debit card, or other such electronic payment instrument, for use outside of the marketplace, as described in paragraph [328].

The storefront manager 340, listed in FIG. 3, provides one or more online stores where consumer member's may purchase or rent digital content such as songs, images, movies, electronic games, premium magazine and newspaper articles, and web applets and standalone applications from third-party digital content providers and from other consumer members, or may offer such digital content as they may have authored and own, or have rights to, for sale or rent to other consumer members.

Using methods known to those skilled in the art, and similar to existing retail websites (as an example, eBay.com), digital content providers may open accounts with the marketplace, and then electronically post their wares to the stores, along with purchase prices or rental rates and terms, samples, and any other such descriptions or information as needed which enables consumers to evaluate their offerings and execute purchase or rental transactions of such wares.

The information collected for each item so posted, includes digital content media type (i.e. text file: “TXT”, Word document: “DOC”, image,: “JPG”, “JPEG”, “BMP” or other image format, song: “MP3” or other audio format, video: “MPEG”, “WMV” or other video format, animation: “SWF”, “DIR” or other animation format, or other commonly used media formats), and content taxonomy tags which correspond to the content taxonomy literals as illustrated in FIG. 7, and selected from dropdown lists populated accordingly and displayed to the content seller.

The proliferation of affordable and easy-to-use content authoring and editing devices and tools among ordinary citizens has resulted in literally millions of amateur digital content providers who currently have no, or very limited access to markets where they may sell or rent their wares. Examples include:
Digital cameras and camera-equipped cell phones, and image enhancing software such as Adobe Photoshop, which enable amateurs to capture and edit pictures of people, places and events which may be of value to other people
Digital camcorders and video editing software such as Adobe Premier and Apple Computer's IMovie HD, which enable amateurs to author and edit videos of people, places and events which may be of value to other people
Home computer-based sound mixing studio software such as Apple Computer's “Garage Band” and Sony's “Sound Forge”, which enables amateur bands to author sound tracks which may be of value to other people
Ordinary word processors such as Microsoft Word which enable amateurs to author stories, books, and poetry, and to capture valuable knowledge in “how-to” and “do-it-yourself” articles which may be of value to other people
Consumer-oriented web publishing tools such as Microsoft FrontPage which enable amateurs to develop and operate topic-specific, subscription-based websites which may of value to other people
Blog authoring and management software such as Six Apart's “Movable Type” and NucleusCMS which enable amateurs to develop and operate topic-specific, subscription-based blogs which may be of value to other people

Access to markets by amateurs has been elusive for several reasons:
Such markets have traditionally been “fed” through established and structured distribution channels which generally require content authors to have an agent, editor, or other such “gatekeeper”, whose primary role is to screen candidate authors for their marketability, and thus to protect the channels and markets from making costly investments in the duplication, distribution, and promotion of content that may not sell well enough to recoup costs and eventually be profitable
Amateur status, by its very nature, implies that the content author has no credible track record of successfully selling their wares at the price levels required by the market to be profitable, and thus, even getting the attention of the gatekeepers, as described above, has proven to be a formidable barrier to amateurs attempting market entry
A micropayment-capable marketplace, whereby unknown and unproven amateurs may offer their wares at prices low enough to be perceived as essentially risk-free to prospective customers, does not yet exist. Further, such a marketplace, which would enable amateurs to gain the exposure and subsequent customer feedback needed to establish the credibility, reputation and following to become “professional” and command higher prices for their wares accordingly, does not exist.

The embodiment of the invention and storefront manager as described herein provides a marketplace which:
Enables consumer members to anonymously sell or rent their amateur digital content to other consumer members for their personal use, such sales and rental rates which may be priced at micropayment-levels (i.e. as low as one cent) and which do not incur transaction processing fees for either party to such transactions.
Enables consumer members to anonymously purchase or rent digital content for their personal use, without incurring transaction processing fees, from third-party companies and organizations that use the marketplace storefronts to market their digital content, such sales and rentals which may be priced at micropayment-levels (i.e. as low as one cent).
Enables third-party digital content providers to sell their wares to consumer members and to incur only a single periodic transaction processing fee to access revenues from sales aggregated from multiple consumer member purchases.
Enables the secure tracking and metering of consumer member usage of digital content which they have downloaded for subsequent use on a rental basis.
Enables third-party digital content providers to rent their wares to consumer members on a metered basis, at micropayment-price levels, and to incur only a single periodic transaction processing fee to access rental revenue aggregated from multiple consumer member rentals, and accumulated over a weekly, monthly or other such period as renders the transaction fee proportionately insignificant to the aggregated rental revenue.

The marketplace-operated stores are enabled as described above by virtue of several critical differences from existing web-based stores as follows:
The marketplace, by virtue of its multiple and recurring revenue streams from other operations as described above, and by its use of its storefronts as an inducement to engage consumer member participation, need not operate the storefronts as a profit center—transactions between buyers and sellers may be free of marketplace-assessed service fees.
The pre-funding of their accounts through good-faith participation in the marketplace enables consumer members to purchase or rent digital content without spending money from their existing personal cash flow—consumers are transacting in the marketplace with rewards they earn within the marketplace.
The pre-funding of their accounts through good-faith participation in the marketplace enables consumer members to purchase or rent digital content without using an identifying payment instrument such as a credit or debit card—consumers are anonymous in the marketplace.
The pre-funding of their accounts through good-faith participation in the marketplace enables consumer members to purchase or rent digital content using funds which are made available directly by the marketplace, without the need for a credit card, debit card, or other commonly used financial instrument, which are the primary sources of transaction processing fees—consumers incur no transaction processing fees for digital content purchases or rentals.
The absence of marketplace-assessed, per-transaction service fees and payment instrument transaction processing fees eliminates all economic barriers to entry into the market for amateur digital content authors—the marketplace's storefronts require no economic investment from amateur sellers and thus impose no economic risk to amateur sellers.
The absence of marketplace-assessed, per-transaction service fees and the marketplace's method of aggregating multiple transaction revenue under each payment instrument transaction processing fee, enables third-party digital content providers to sell or rent their wares at micropayment-level prices essentially free of marketing overhead—the marketplace's storefronts require no economic investment from, and impose no economic risk to, third-party digital content providers or to non-member providers, and further, enables such providers to incur a single transaction processing fee for multiple aggregated transactions.
The embodiment of the invention as described herein, and specifically the methods of the consumer member content manager 330 as listed in FIG. 3 and described in paragraph [316], enables a digital content rental market which provides reliable tracking and metering of content usage, and the automated collection of rental fees from consumer members without requiring any modification of content, or any effort or intervention by its authors—the marketplace's storefronts eliminate technical and financial responsibilities of rental administration for digital content providers.

As an example, an avid Giants fan and amateur photographer takes pictures of Barry Bonds during a game with his digital camera. He uses the storefront manager tools to upload his pictures and the thumbnails he created using image editing software included for free when he purchased his computer, completes a simple form in which he provides information about the pictures and specifies a purchase price of ten cents per picture, or fifty cents for a complete set of six, and then submits his offering to the marketplace. The marketplace, using the supplied information, posts his offering under the appropriate categories and copies his media files to the content management databases. Over the next thirty days, 320 other consumer members have purchased and downloaded the complete set, and another 285 have purchased and downloaded individual pictures. At no cost and no economic risk, the marketplace has enabled the selling consumer member to earn $188.50 from transactions conducted with 605 individual buying consumer members. The marketplace's transaction processor moves the amount of each transaction from the member accounts of the buyers to the seller, with no transaction or service fee imposed on either party.

As another example, a computer programmer specializing in computer animation has written a video game which enables multi-player combat over the Internet. Her friends enjoy using it, but she knows that consumers would never consider purchasing it, even at half the price, over more sophisticated, professionally authored video games. She uses the storefront manager tools to upload her game application, creates her game information profile, and decides to offer the game as a rental at a price of three-cents an hour. Six months later, over 200 other consumer members are playing her game an average of 5 hours each week. At no cost and no economic risk, the marketplace has enabled her to earn over $120.00 from about 4,000 hourly transactions conducted with 200 renting consumer members that month. The marketplace's transaction processor moves the amount of each rental transaction from the member accounts of the renters to the digital content provider, with no transaction or service fees imposed on any party.

As another example, a provider of a top-rated spyware detection and removal utility, currently operating under a freeware model whereby users may download and use their software free of charge, is considering a transition to a fee-based subscription model. To test the viability of the new strategy and to build a fee-paying user base, they use the marketplace's storefront management tools to upload their utility, create an information profile, and offer it for rent at seven cents a day. Six months later, over 30,000 consumer members have elected to download the utility and have subscribed to the provider's update service, on a daily basis. At no cost and no economic risk, the marketplace has enabled the company to generate monthly revenues in excess of $60,000 from 900,000 individual daily rental transactions. The marketplace's transaction processor moves the amount of each rental transaction from the member accounts of the renting consumer members to the third-party digital party provider, with no marketplace service fees imposed on any of the parties. The content provider may access the accrued transaction revenue from their account at any time through a financial instrument—a credit or debit card, or electronic account transfer, as specified at signup—and will pay only one transaction processing fee to the financial instrument administrator for the aggregated amount accessed.

As another example, a major newspaper uses the service to sell their daily crossword puzzle, as a way to test micropayment-based delivery of their digital content assets. They upload their crossword puzzle engine to the marketplace where interested consumer members may download it for free, then purchase daily crossword puzzles as they may choose, at twenty-five cents each for Monday through Saturday's puzzle, and fifty cents for the larger Sunday puzzle. Six months later, over 5,000 consumer members are purchasing at least three daily puzzles per week and over 3,500 consumer members are purchasing the Sunday puzzle. At little cost and minimal economic risk, the marketplace has enabled the publisher to generate monthly revenues in excess of $22,000 from 74,000 individual daily purchase transactions, and more importantly, has enabled the newspaper to evaluate the viability of ala carte sales of their digital assets at micropayment-level pricing.

The content manager on the consumer node performs the download and cataloging and manages the subsequent member access to digital content purchased or rented through the storefront manager. Downloaded content is stored on the mass storage device of the consumer node using an indexing or file directory structure which uses the content media type and category taxonomy information in the content's accompanying profile, and enables the content manager to display each consumer's content library sorted accordingly, from which they may access their acquired digital content.

When a consumer member executes a purchase transaction for digital content, the storefront management engine sends a MSG: AccountQuery message to the consumer management engine requesting verification that the consumer's account has sufficient funds to cover the transaction. If approved, the consumer management engine commits the transaction amount in the consumer's account to prevent it from being spent elsewhere by the consumer member, and returns a MSG: TransactionApproved message to the storefront management engine. The storefront management engine, in turn, sends a MSG: InitiateDownload message to the content management engine, which then processes the download of the purchased item from the content databases. After the storefront management engine receives a MSG: DownloadComplete message from the consumer node, it sends a MSG: TransferFunds message to the transaction processor which transfers the committed funds from the account of the purchasing consumer member to the account of the digital content provider.

If the consumer management engine determines that the consumer has insufficient funds in their account to purchase the specified item, it returns a MSG: TransactionRejected message to the storefront management engine which informs the consumer of the rejection, and the purchase process is subsequently aborted.

When a consumer member executes a rental transaction for digital content which is generally consumed once over a fixed period of time, such as a video, the storefront management engine sends a MSG: AccountQuery message to the consumer management engine requesting verification that the consumer's account has sufficient funds to cover the transaction, then processes the transaction as described for content purchases above. The date and time of the download is captured by the content manager which allows subsequent access to the item downloaded within the time period stipulated in the rental transaction. After the rental period expires, the content manager will no longer display the item for the consumer member to access. Each time the content manager is invoked by the consumer, it performs a “housecleaning” process which deletes expired digital content from the consumer node's mass storage device.

When a consumer member executes a rental transaction for digital content which may be used continuously—as an example, a spyware monitoring utility—or may be used more than once—as an example, a video game—and the rental terms stipulate a pay-per-use or a pay-per-unit-time-used fee schedule, the storefront management engine sends a MSG: AccountQuery message to the consumer management engine requesting verification that the consumer's account has sufficient funds to pay for the first such use or first time unit-used accordingly, then processes the transaction as described for purchases above. If the consumer member's account balance falls below the rental cost, the rented content description is displayed by the content manager but the content itself will not be accessible to the consumer until such time as their account balance has increased sufficiently.

Those items of digital content which the consumer downloads under the terms of a rental are encrypted on their consumer node using their consumer member serial number, and cannot be listened to (songs), viewed (movies) or used (games, applets, and applications) without first being decrypted by the content manager. Consumer member serial numbers and the encryption algorithm used are both unknown to consumers. By virtue of the algorithm being programmatically incorporated into the content manager, it cannot be accessed directly, and can be invoked only through the content manager. Downloaded content so encrypted is thus inaccessible through any method other than the content manager, and specifically, the copy of the content manager running on the consumer node on which the content was encrypted and on which the encryption key—consumer member serial number—is registered.

If a consumer member copies a rented digital content item from their node and attempts to circumvent the rental tracking fees by using it on another electronic device, it will not be usable, by virtue of its encrypted state. If a consumer member copies a rented digital content item and attempts to evade the rental tracking fees by using it on another consumer node, the consumer member serial numbers, and hence decryption keys, will not match, and the content will not be usable.

The method of forcing consumers to access rented content through the content manager on their own nodes thus provides a mechanism by which tracking and metering of its usage is reliably enabled. Content may be rented by consumer members under terms stipulated by the content provider and may include one or more of the following:
For a fixed fee and fixed period of time, stipulated by the content provider, during which the consumer has unlimited use of the content. As an example, a video may be rented for 72 hours for $2.00.
For a daily fee, stipulated by the content provider, during which the content may be continuous used, over a period of time controlled by the consumer member. As an example, a consumer may download and use a spyware utility which executes as an ever-present background task, for ten cents a day, and may elect to rent it indefinitely.
For a fixed rate, stipulated by the content provider, based on a per-minute or per-hour of actual use, such use being controlled by the consumer member. As an example, a consumer member may download a multi-user video game for which they will pay a rate of one cent for each five minutes of play.

Each time a rented item of digital content is accessed by a consumer member, the content manager on their node tracks its use and sends a MSG: Transfer Funds message to the transaction processor on the marketplace servers to debit the consumer's account and credit the content provider's account according to the terms of the rental transaction. For daily fee rentals, the content manager uses the synchronized time downloaded from the marketplace servers during logon as described in paragraph NNN, and updated by the node's system clock ticks, to track the application of daily fees. Each time a consumer accesses digital content rented on a per-minute or per-hour basis, the content manager decrypts the content and activates a background timer process which tracks the usage and triggers periodic MSG: Transfer Funds messages to the transaction processor on the marketplace servers as indicated by the terms of the rental transaction.

Each time a consumer member purchases or rents, and subsequently accesses a digital content item, its acquisition and usage is also tracked and saved to their premium content profile data 1020 as shown in FIG. 10A, and summarized and sent via messages to the consumer management engine on the marketplace servers for posting to the consumers profile data. Such purchase, rental and usage data is used by the consumer management engine for content targeting, and provides a source of credibility data for the credibility engine as described in paragraph [335].

By using a marketplace-supplied storefront template, an XML-based data description library such as Really Simple Syndication (RSS) technology, and techniques known to those skilled in the art, third-party content providers can create, bulk-load, and manage their own storefronts (hereinafter referred to as “kiosks”) within the marketplace, and enjoy the benefits of selling or renting their catalog of digital assets, including micropayment-based content, to its anonymous consumer membership as described above.

Consumers may elect to donate some or all of their earned rewards with non-profit or other organizations engaged in activities in which they may be sympathetic to or otherwise interested in. Using their account manager 315 as originally list in FIG. 3, a consumer may select any such organization they have adopted as described in paragraph NNN, specify an amount up to their account balance, and then request a transfer of the specified amount from their account to the account of the organization selected. The account manager fulfills the request by sending a MSG: TransferGift message to the transaction processor 250 on the marketplace servers which executes the funds transfer as specified. Optionally consumers may schedule such donations to occur on an automated basis to one or more adopted organizations.

The anonymous funds exchange 135 as depicted in FIG. 1 (hereinafter also referred to as “AFE”) is a closed-community service which enables consumer members to access any portion of their account balances, while remaining anonymous to the marketplace, the marketplace operators, and to all marketplace members, while being visible, identifiable and auditable to tax collection agencies. Consumers electing to access and withdraw funds from their marketplace accounts are required to visit the website of the AFE, where they register and create an account. Access to the AFE website is granted exclusively through the account manager tool 315 residing on the consumer node. To further promote consumer member trust that their anonymity is absolute, the AFE is preferably owned and operated by a third-party entity having an auditable arms-length relationship with the operators of the marketplace.

Registration with the AFE requires consumers to provide identifiable information which includes their names, addresses, the account number of a payment instrument, their Social Security Numbers, and any other information required for compliance with the Internal Revenue Service and the tax agencies of their state of residence as indicated by the zip code supplied when they signed up as consumer members. Secure protocols, such as S-HTTP (Secure HTTP) which ensures the confidentiality, authentication, and integrity of entered information and which are known to those skilled in the art, enables the safe communication of registration data and subsequent transfer data from the account manager 315 to the AFE.

Upon successful completion and submission of the registration data described above, the AFE assigns the applicant a unique account number, which they may record in written form, or optionally, request their consumer node to encrypt and store locally on its mass storage device, using the consumer member's user ID as an encryption key. The consumer's account ID on the AFE is not shared with the marketplace servers, and their marketplace assigned consumer member serial number is not shared with the AFE. The marketplace servers thus have knowledge of the consumer member's serial number, extensive profile data and account balance, but have no knowledge of their AFE account number or of any of the identifiable consumer information associated with the consumer's AFE account. The AFE, on the other hand, has knowledge of the consumer member's AFE account number and the consumer member's identifiable AFE information, but has no knowledge of the consumer member's serial number in the marketplace, and no knowledge of their profile data or marketplace account balance.

Transfers of funds between the consumer member account on the marketplace servers and their account on the AFE are executed as follows:
Using their account manager 315 on their consumer node 105, consumer members request a transfer and specify an amount, up to and including their account balances.
The account manager 315 requests the consumer member to enter their AFE account number. If the consumer had previously elected to have their consumer node store it on their behalf, the account manager uses the consumer member's user ID to decrypt and retrieve it, and then enters the AFE account number automatically for them.
When the consumer confirms the ‘Transfer’ request, the account manager 315 sends the AFE account number via a MSG: TransferKeyRequest message in an HTTP process to the AFE, which responds by generating a random and transient key which it saves in a temporary datastore along with the consumer's AFE account number, and then sends a copy of the key back to the consumer node in a MSG: TransferKey message using a similar HTTP process.
The account manager 315 sends a MSG: TransferRequest message which contains their consumer member serial number, the specified transfer amount, and the AFE key, to the transaction processor 250 on the marketplace servers.
The transaction processor 250 verifies the account balance in the account data 510 corresponding to the member serial number specified, deducts the transfer amount from the consumer member's marketplace account, and executes an electronic funds transfer to the AFE, specifically to the account represented by the temporary AFE key specified.
The AFE, using federal and specific state tax tables, deducts any required withholdings from the transfer amount for subsequent remission to the appropriate tax collection agencies as indicated.
Using methods known to those skilled in the art, the AFE electronically issues a credit to the credit card, debit card or other payment instrument of the account holder associated with the temporary AFE key, less any transaction processing fee due to the EFT Service Provider 145 used to execute the electronic credit, and then erases the temporary key from the account holders file.
The AFE updates the account holder's records with the transfer amount to maintain a current balance of all income earned by the account holder through their participation in the marketplace, which enables the AFE to distribute either hard copy or electronic statements of income and tax withheld to each consumer member and to tax agencies as required for compliance.

The method described above thus enables consumer members to access funds earned anonymously in the marketplace for use outside the marketplace without compromising their absolute anonymity. Funds so accessed are available to the consumer member, now acting as an identified credit card, debit card or other payment instrument bearer, to transact business outside of the marketplace.

It is noted that using a similar method, transfers of funds from payment instruments held by identified individuals to their respective anonymous consumer member accounts in the marketplace may be enabled. Consumer members may thus enjoy the benefits of anonymous digital content purchases and rentals, and the convenience of a single prepaid account which can be applied to transactions with multiple digital content providers, to conduct such transactions in excess of the funds they earn through their good-faith participation in the marketplace.

Winnings from the marketplace's games-of-chance may be subject to specific IRS and state-by-state rules regarding tax rates, dollar amount thresholds, and immediate withholding and remitting of gambling taxes. Consumer member account data as maintained on the marketplace servers therefore segregate consumer earnings by source to identify those funds which are subject to such rules. Using methods known to those skilled in the art, transfers of winnings to the AFE are designated as gambling proceeds by the transaction processor 250 and are processed accordingly by the AFE, which uses the applicable withholding and remitting rules and rates accordingly to fulfill reporting and tax collection obligations needed for compliance.

Ongoing consumer member behavior in the marketplace is tracked by the profile manager 320 which resides on their nodes 105. In addition to collecting declared survey data, web surfing data, content purchase, rental and usage data, and ad interaction data, as previously described, the profile manager collects and summarizes data which infers consumer member credibility and their good faith participation in the marketplace. Such credibility data is periodically submitted to the consumer member's credibility records 520F on the marketplace servers. The marketplace exercises no judgment as to what constitutes an individual consumer's credibility, but collects and makes available to advertisers a series of credibility-related data points from which they may exercise their own such judgment. Credibility data points are available as audience filters which advertisers, through the selection and application of such filters using the audience explorer 415, can improve the integrity of their audience definitions.

On a scheduled basis, the credibility engine 530 on the marketplace servers analyzes the credibility data collected from all consumer members to establish values which indicate average or typical consumer member behavior. Using such averages as baseline values, the credibility engine then calculates and assigns credibility data for each consumer member which indicates how their behavior compares with the baseline values so calculated. Credibility data points are specifically chosen which best infer mercenary or fraudulent consumer member behavior. Mercenary behavior refers to those behaviors or patterns of behavior which infer that a consumer member may be primarily interested in earning rewards and may not be fairly participating in the exchange of their attention and consideration for advertiser-offered rewards. Fraudulent behavior refers to behaviors which indicate that a user may have signed up for, and may be using more than one consumer member account in an effort to earn rewards in each of them.

Examples of assigned credibility data points available as audience filters include but are not limited to:
Number of consumer members assigned to a toolset serial number
Average time spent viewing each static (non-animated) ads
Average percentage of dynamic ad playtime viewed
Percentage of advertiser website visited
Average length of website visits
Average number of web pages viewed per visit
Percentage of advertisers invited into relationships
Relationship churn rate (i.e. the rate at which advertisers are invited into a consumer member's Living Pages, then deleted by the consumer to free up resources)
Number of profile surveys completed
Average number of times a consumer member changes their declared data per month
Correlations between declared interests and interests demonstrated by saved favorites
Correlations between declared interests and purchased or rented digital content
Percentage of earned rewards donated to worthy causes.

Credibility-related filters may be applied to an advertiser's audience after all other primary and secondary filters are applied. Each such filter may be in the form of a range of selectable and predefined values, or may in the form of more qualitative values relative to the baseline averages calculated, such as “Average”, “Above Average”, “Below Average”, etc.

Other embodiments are possible and it is noted that not all elements of the embodiment as described herein are necessarily required to exploit the benefits of the invention's method of enabling intimate consumer anonymity. The elements described herein collectively provide a broad-enough range of benefits to each of the member types which enable a variety of embodiments using selected elements described, and further, enable one skilled in the art to make and use the invention in incremental phases.

In another embodiment, the marketplace network 100 may enhance the service to wireless consumers nodes (e.g., a wireless-enabled personal digital assistant or graphics-enabled cellular phone) while the consumer member is mobile. Wireless consumer nodes may be equipped with Global Positioning System (GPS) technology that enables transmitting consumer location on a scheduled or polled basis, thus providing additional filtering for ad targeting. Advertisers can define standing campaigns that send ads to any audience member within a specific distance from any geographic point such as a retail location. This technique enables advertisers to electronically extend traditional billboards, special sale banners, and other forms of conventional promotion to highly-targeted and anonymous audiences within any specified proximity to their places of business. Further, such an embodiment may pay a portion of ad revenue to telecommunications carriers to cover the cost of cellular or wireless service. In conjunction with such a model, consumer members need not have any established account with the telecommunications carrier, which would require the carrier to know the consumer's identity, therefore compromising consumer anonymity.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method comprising:
the storing of profile information about anonymous Internet users;
enabling interested third-parties to derive benefits from the use of the profile information; and
enabling anonymous Internet users to derive value and material and financial benefit from the use of their profile information.

2. The method of claim 1, wherein the stored profile information enables a marketplace to act as an intermediary agent on behalf of anonymous Internet users.

3. The method of claim 2, wherein the enabling of the marketplace to act as an intermediary agent includes enabling the marketplace to provide controlled access to and use of the stored profile information by interested third-parties.

4. The method of claim 1, wherein the stored profile information includes enabling individual anonymous Internet users to act as agents on their own behalf to provide controlled access and use of their stored profile information by interested third-parties.

5. The method of claim 1, wherein the profile information includes data about the configuration of the Internet-accessing device of each anonymous Internet user.

6. The method of claim 1, wherein the profile information includes answers to predetermined questions.

7. The method of claim 6, wherein the answers to predetermined questions specify demographic, psychographic, needs, interests, and other attributes of anonymous Internet users which have value to interested third-parties.

8. The method of claim 6, wherein the predetermined questions include questions which collectively enable a precisely-articulated assessment of the personality, temperament, dispositions, inclinations and style of each anonymous Internet user.

9. The method of claim 1, wherein the profile information includes other anonymous Internet users who are household members of anonymous Internet users.

10. The method of claim 1, wherein the profile information includes observed data on the behavior of anonymous Internet users.

11. The method of claim 10, wherein the observed data includes the Internet surfing patterns and favorite website links of each anonymous Internet user.

12. The method of claim 2, further comprising the marketplace providing rewards to anonymous Internet users in proportion to their answering questions.

13. The method of claim 1, wherein each anonymous Internet user is assigned a unique serial number, the serial number including primary profile data embedded therein.

14. The method of claim 1, wherein enabling interested third-parties to derive benefits from the use of the profile information includes enabling advertisers to selectively filter anonymous Internet users into one or more differentiated target audiences based on profile information for the purposes of conducting advertising and marketing campaigns with the target audiences so identified.

15. The method of claim 13, wherein the enabling of advertisers to selectively filter the anonymous Internet users includes enabling advertisers to filter the anonymous Internet users based on the unique serial numbers.

16. The method of claim 14, wherein the enabling advertisers of selectively filter anonymous Internet users into target audiences includes enabling advertisers to filter the anonymous Internet users into target audiences defined over a continuous range of specificity, from lightly-differentiated, large audiences suitable for mass advertising and marketing campaigns to highly differentiated, small audiences suitable for one-to-one advertising and marketing campaigns.

17. The method of claim 14, wherein the enabling of advertisers to filter the anonymous Internet users into one or more differentiated audiences includes enabling advertisers to additionally define audiences comprised of anonymous Internet users who are the household members, and therefore potential decision influencers, of the members of other target audiences, for the purposes of enabling advertisers to indirectly advertise to target audiences.

18. The method of claim 14, wherein the enabling of advertisers to conduct advertising and marketing campaigns includes enabling advertisers to send advertising media and related campaign information tailored to their targeted audience members.

19. The method of claim 18, wherein the enabling of advertisers to send advertising media and related campaign information includes enabling advertisers to send rich media including high-quality video, high-quality audio, computer-generated animations, and other advertising media of significant size and requiring substantial transmission times, such transmission times being imperceptible to target audiences.

20. The method of claim 4, wherein the enabling of individual anonymous Internet users to act as agents on their own behalf includes enabling anonymous Internet users to invite advertisers into ongoing relationships and to control the duration of relationships so initiated.

21. The method of claim 20, wherein the enabling of advertisers to send advertising media and related campaign information includes enabling advertisers to publish rich and functionally interactive ads into consumers' individualized Yellow Pages™-type directories, at a frequency of their choosing, and such ads including rich, interactive media, which load and play with no discernible delay.

22. The method of claim 14, wherein the enabling of advertisers to conduct advertising and marketing campaigns includes the enabling of advertisers to monitor and track the responses and campaign interactions of each targeted audience.

23. The method of claim 14, wherein the enabling of advertisers to conduct advertising and marketing campaigns includes enabling each advertiser to monitor the advertising and marketing campaigns of direct and indirect competitors conducted with the same targeted audience members.

24. The method of claim 2, further comprising providing rewards to anonymous Internet users in proportion to their good faith participation in advertising and marketing campaigns.

25. The method of claim 24, wherein the providing of rewards includes rewards for viewing advertising media and related campaign information.

26. The method of claim 24, wherein the providing of rewards includes rewards for visiting the websites of advertisers.

27. The method of claim 24, wherein the providing of rewards includes rewards for inviting advertisers into ongoing relationships.

28. The method of claim 14, wherein the enabling of advertisers to selectively filter anonymous Internet users into one or more differentiated target audiences includes the enabling of each advertiser to their filter their target audiences into new target audiences further differentiated by the individual responses and interactions of each target audience member to the advertiser's previous campaigns.

29. The method of claim 10, wherein the observed data on the behavior of each anonymous Internet user includes campaign response and interaction patterns and statistics for all campaigns received by the anonymous Internet user.

30. The method of claim 4, wherein the enabling of anonymous Internet users to act as agents on their own behalf includes the enabling of individual Internet users to respond to any advertiser's campaign by blocking all future campaigns from that advertiser.

31. The method of claim 5, wherein the predetermined questions include questions relating to the habits and preferences of anonymous Internet users in their use of media, such as newspapers, magazines, radio, and the Internet, to access news, information, entertainment, and other topics of general and specific interest.

32. The method of claim 31, wherein the enabling of advertisers to derive benefits from access to the profile information of anonymous Internet users includes enabling advertisers to access the habit and preference data of their audience members related to their use of other media for the purposes of improving the targeting of campaigns conducted to audience members, and by inference, other consumers similar to audience members, in other media.

33. The method of claim 10, wherein the observed data includes derived data which infers a measure of the good-faith participation and credibility of each anonymous Internet user.

34. The method of claim 1, wherein the enabling of interested third-parties to derive benefits from the use of the profile information includes enabling websites to request access to the profile information of each visiting anonymous Internet user as they visit, for the purposes of enabling websites to provide a more personalized experience to each visiting anonymous Internet user.

35. The method of claim 34, wherein the enabling of personalized experiences includes the enabling of websites, including search engine websites, to utilize their own tools and techniques to tailor the content, including advertising content, to the needs, interests and tastes of each visiting anonymous Internet user as indicated by the profile data accessed.

36. The methods of claims 4, wherein the controlled access to the stored profile information of individual anonymous Internet users acting as agents on their own behalf includes the enabling of each anonymous Internet user to selectively grant access to each element of their stored profile information requested by each website they visit.

37. The method of claim 2, further comprising providing rewards to anonymous Internet users in proportion to their granting access to their stored profile information to websites requesting it.

38. The method of claim 1, wherein the enabling of anonymous Internet users to derive value from the use of their profile information includes the enabling of each anonymous Internet user to discover website links favored and ranked by other anonymous Internet users who share similar profile information attributes.

39. The method of claim 1, wherein the enabling of anonymous Internet users to derive material benefit from the use of their profile information includes enabling anonymous Internet users to spend their rewards to anonymously purchase or rent premium digital content.

40. The method of claim 39, wherein the enabling of purchases and rentals include the enabling of extremely low-valued transactions commonly known as micro-payment transactions.

41. The method of claim 1, wherein enabling anonymous Internet users to derive financial benefit from the use of their profile information includes enabling anonymous Internet users to withdraw earned rewards from the marketplace while remaining anonymous to the marketplace and to all interested third-parties.

42. A system comprising:
a user database storing profile information about anonymous Internet users;
a user profile information search engine enabling an advertiser to filter anonymous Internet users into a target audience based on the profile information; and
a distributor enabling an advertiser to send an advertisement to the target audience.
